(19) United States
(12) Patent Application Publication
(10) Pub. No.: US 2005/0280228 A1
(43) Pub. Date: Dec. 22, 2005

(54) Industrial cart

(76) Inventors: Eric X. Fernandes, Franklin, WI (US); Scott D. Bublitz, Hartland, WI (US); Brian P. Wattenbach, Menomonee Falls, WI (US); Andrew J. Weber, Cudahy, WI (US); Jonathan A. Zick, Waukesha, WI (US); Melissa A. Ottens-Rendon, Waukesha, WI (US)

Correspondence Address: MICHAEL BEST & FRIEDRICH, LLP, 100 E WISCONSIN AVENUE, MILWAUKEE, WI, 53202, US

(21) Appl. No.: 11/136,618

(22) Filed: May 23, 2005

Related U.S. Application Data
(60) Provisional application No. 60/573,410, filed on May 21, 2004.
(60) Provisional application No. 60/637,634, filed on Dec. 20, 2004.

(51) Int. Cl. B62B 11/00

(52) U.S. Cl. 280/47.35; 312/140.1

(57) ABSTRACT

An industrial cart and methods of assembling an industrial cart. The industrial cart includes a base assembly having a base support surface for supporting an item, a wheel connected to the base and operable to support the cart for movement over ground, and a table assembly having a table support surface for supporting an item, the table being supported in vertical spaced relation from and being at least partially above the base assembly. At least one of the base assembly and the table assembly is provided by a frame assembly, the frame assembly including a body member providing the support surface, the body member having a length extending along an axis, the body member being formed of a non-metallic material, and a reinforcing member connectable to the body member, the reinforcing member extending along the axis, the reinforcing member being at least partially formed of a metal material.

### RELATED APPLICATIONS

This patent application claims priority to prior-filed, co-pending U.S. Provisional Patent Application Ser. Nos. 60/573,410, filed May 21, 2004, and 60/637,634, filed Dec. 20, 2004, the entire contents of both of which are hereby incorporated by reference.

### FIELD OF THE INVENTION

This invention relates to carts and, more particularly, to carts for industrial purposes.

### SUMMARY OF THE INVENTION

Carts are often used for storing and transporting various items. Carts provide a wheeled apparatus that may be moved by a user to a remote location. The cart enables a user to transport a variety of items that may be necessary to perform a task to a desired location where the task is to be performed. The user may save time and effort by having the necessary supplies for the task available in one centralized and mobile cart.

In some aspects and in some constructions, the present invention may generally provide an industrial cart which may be customized or customizable to include various apparatus, equipment and/or supplies that are useful for a particular task. The apparatus, equipment and/or supplies supported on the cart may be selected depending on the tools and items helpful for performing tasks associated with, for example, a particular construction trade. The cart and its contents may be specialized for various trades, such as, for example, carpenters, metal workers, electricians, plumbers, other similar trades, etc.

In some aspects and in some constructions, the cart may include a frame having a base and wheels connected to the base. The cart may provide a modular frame for supporting a variety of sub-assemblies or features. The sub-assemblies may be added to the modular frame by the manufacturer and/or by the user to customize the cart for various tasks.

In some aspects and in some constructions, the cart may generally include a work surface supporting a power tool. The cart and/or the work surface may include telescoping extensions that expand the working surface. The cart may include a door that is openable to provide an additional work surface.

In some aspects and in some constructions, the cart may generally include storage features accommodating various types of raw materials and/or supplies, such as, for example, elongated pipes, bars, beams, etc. In some aspects and in some constructions, the cart may generally include reel racks for storing reels or spools of electrical wire. The cart may include a holder for retaining electrical conduit:

In some aspects and in some constructions, the cart may generally include an electrical system connectable to and/or including electrical devices, such as, for example, a battery charger for rechargeable batteries, a radio, etc. The electrical system may be connectable to a power source and to multiple electrical devices to provide power to the electrical devices.

Independent features and independent advantages of the present invention will become apparent to those skilled in the art upon review of the following detailed description and drawings.

### BRIEF DESCRIPTION OF THE DRAWINGS

FIG. 1 is perspective view of one construction of a cart, such as an industrial cart.

FIG. 2 is perspective view of another construction of an industrial cart.

FIG. 3 is perspective view of a further construction of an industrial cart.

FIG. 3A is a perspective view of the industrial cart illustrated in FIG. 3.

FIG. 4 is a perspective view of an alternate construction of the cart illustrated in FIG. 3.

FIG. 5 is another perspective view of the cart illustrated in FIG. 4.

FIG. 6 is another perspective view of the cart illustrated in FIG. 4.

FIG. 7 is another perspective view of the cart illustrated in FIG. 4.

FIG. 8 is a perspective view of yet another construction of an industrial cart.

FIGS. 9A-E are views of a further construction of an industrial cart.

FIGS. 10A-D are enlarged views of portions of the industrial cart illustrated in FIGS. 9A-E.

FIGS. 11A-B are partial cross-sectional views of portions of the industrial cart illustrated in FIGS. 9A-E.

FIGS. 12A-B are views of another construction of an industrial cart.

FIGS. 13A-B are views of yet another construction of an industrial cart.

FIG. 14 is a partial cross-sectional view of a portion of the industrial cart illustrated in FIGS. 13A-B.

FIGS. 15A-D are views of a further construction of an industrial cart.

FIGS. 16A-C are views of another construction of an industrial cart.

FIGS. 17A-I are views of alternative constructions of an industrial cart.

FIGS. 18A-B are partial cross-sectional views of a portion of the industrial cart illustrated in FIGS. 17A-I.

FIGS. 19A-B are views of yet another construction of an industrial cart.

FIGS. 20A-B are views of a further construction of an industrial cart.

FIG. 21 is a perspective view of another construction of an industrial cart.

FIG. 22 is a perspective view of another construction of a portion of an industrial cart.

FIGS. 23A-C are perspective views of yet another construction of an industrial cart.

FIGS. 24A-G are views of a further construction of an industrial cart.

FIGS. 25A-E are enlarged views of portions of the industrial cart illustrated in FIGS. 24A-G.

FIG. 26 is a perspective view of another construction of an industrial cart.

FIGS. 27A-B are views of yet another construction of an industrial cart.

FIGS. 28A-B are perspective views of a table-mounted band saw useable with an industrial cart.

FIGS. 29A-J are views of a further construction of an industrial cart.

FIGS. 30A-L are views of the industrial cart shown in FIGS. 29A-29J and illustrating a door portion and operation of the door portion.

FIGS. 31A-I are views of the industrial cart shown in FIGS. 29A-29J and illustrating a drawer portion and operation of the drawer portion.

FIGS. 32A-D are views of portions of the industrial cart shown in FIGS. 29A-29J and illustrating assembly and packaging of the industrial cart.

FIGS. 33A-J are views of an alternate construction of the industrial cart shown in FIGS. 29A-29J and illustrating an “open” cart construction.

FIGS. 34A-E are views of portions of the industrial cart shown in FIGS. 33A-33J and illustrating assembly and packaging of the industrial cart.

FIGS. 35A-C are views of another construction of an industrial cart.

FIGS. 36A-C are views of yet other constructions of an industrial cart.

FIGS. 37A-O are views of a portion of an industrial cart including an assembly for supporting a reel.

FIGS. 38A-L are views of a portion of an industrial cart including a work piece holder or vise assembly.

FIGS. 39A-F are views of a portion of an industrial cart including a storage assembly.

FIGS. 40A-K are views of a portion of an industrial cart including a tank storage assembly.

Before at least one embodiment of the invention is explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting.

Although references are made below to directions, such as left, right, up, down, top, bottom, front, rear, forward, back, etc., in describing the drawings, they are made relative to the drawings (as normally viewed) for convenience. These directions are not intended to be taken literally or limit the present invention in any form.

### DETAILED DESCRIPTION

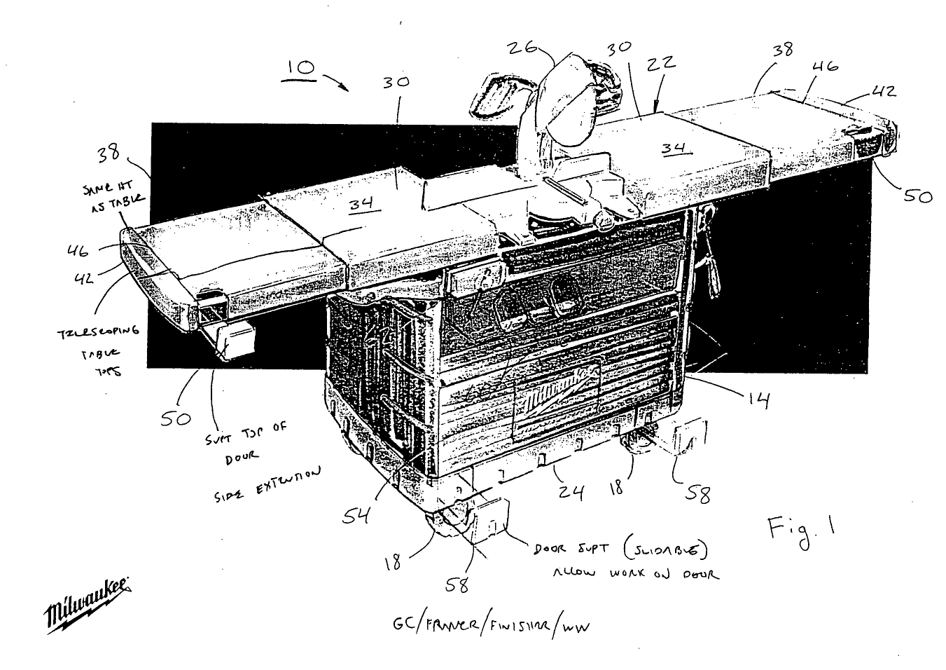

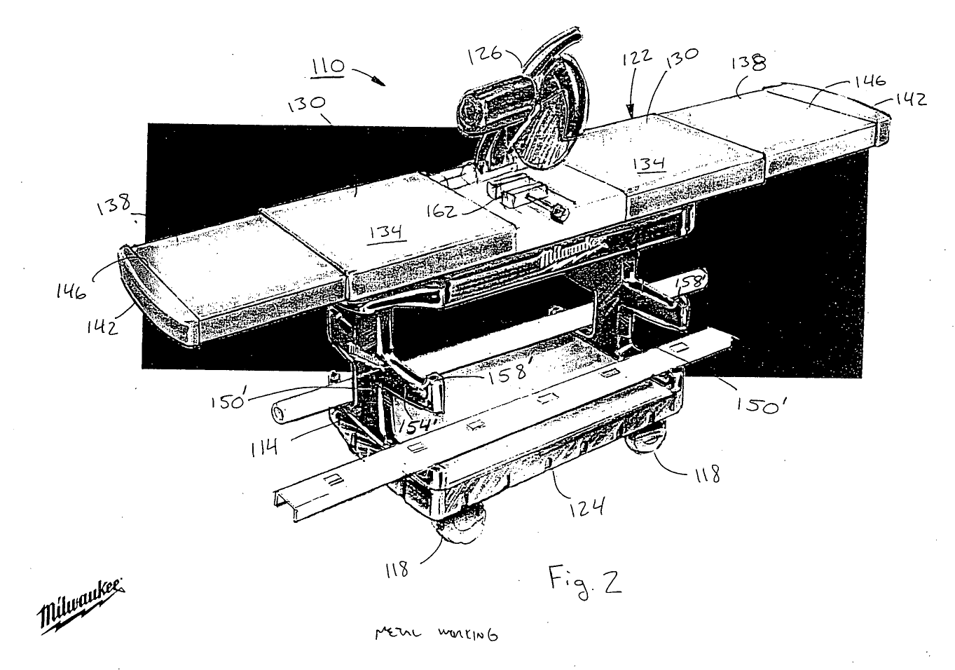

FIG. 1 illustrates one construction of a cart, such as an industrial cart 10. In some aspects and in some constructions, the cart 10 (and the carts 110, 210, 310 and 410, described below) provides a modular structure that may support various sub-assemblies, apparatus, equipment, supplies, etc. The sub-assemblies may be selectively added on or removed from the cart 10 to customize the cart 10 for a particular purpose. The modular frame and sub-assemblies permit a user to have a single cart 10 capable of being configured for a wide variety of tasks.

The cart 10 may be configured by the manufacturer, seller or user for a particular purpose. Alternatively, the manufacturer and/or seller may initially provide a base cart 10 generally configured for a particular purpose, and the seller and/or user may specifically configure the cart 10 for the particular purpose.

In the construction illustrated in FIG. 1, the cart 10 is configured to be used by a general contractor, a framer, a finisher, a woodworker, etc. The cart 10 generally provides a mobile work bench that may be transported to various work sites and that stores and supports tools, equipment and/or supplies in one convenient place.

The cart 10 generally includes a frame 14 and wheels 18 supporting the frame 14 for movement to, from and around a work site. The wheels 18 are connected to a bottom, a lower shelf or a base 24 of the cart 10. The wheels 18 facilitate transport of the cart 10 and may include wheel locks which may selectively prevent rotation of the wheels 18 to prevent unwanted movement of the cart 10 and to provide a stable work area for the user.

The cart 10 also includes a table, a top shelf or a work surface 22 near the top of the cart 10 opposite the wheels 18. A power tool 26 may be mounted on the work surface 22. In the illustrated construction, the power tool 26 includes a miter saw but may alternatively include a jigsaw, band saw, drill, other similar power tool, other equipment, etc.

The work surface 22 includes table top portions 30 positionable on opposite sides of the power tool 26. The table top portions 30 each have a top surface 34 positioned at a uniform height and being co-planar with one another and with a support surface of the power tool 26. In the illustrated construction, the table top portions 30 are slidable relative to one another to uncover a support surface for the power tool 26.

Respective telescoping extension 38 may be extended outwardly from the table top portion 30 to expand the work surface 22. The telescoping extensions 38 each include an edge portion 42 near an end 46 of the telescoping portion 38 opposite the respective table top portions 30. The edge portions 42 include a raised shoulder 46 that is substantially co-planar with the top surface 34 of the respective table top portions 30. The substantially co-planar surfaces of the top surfaces 34 and the raised shoulders 46 of the edge portions 42 provide substantially uniform support for a wooden beam, plank, or other similar work piece along the length of the expanded work surface 22. The raised shoulders 46 also provide a stop that contacts the edge of the respective table top portion 30 and that prevents the telescoping extensions 38 from sliding completely inside the respective table top portion 30 and out of reach of the user.

In alternative constructions, the extensions 38 may be extendable in a different manner to expand the work surface 22. For example, the extensions 38 may be pivotally connected to the ends of the table top portions 30 to pivot downwardly as retractable leaves to selectively extend the work surface 22 when desired.

Each telescoping extension 38 may also include a slidable side extension 50 disposed near an outer end of the telescoping extension 38 opposite the table top portion 30. The side extension 50 is generally slidable along a path in a direction substantially transverse to the direction of the slidable path of the telescoping extension 38. The side extension 50 may provide additional support for a work piece positioned adjacent the work surface 22.

As shown in FIG. 1, the cart 10 includes a door 54 connected to the frame 14 on a side portion of the cart 10. The door 54 may cover a storage area within the cart 10 for storing additional tools, accessories, other similar implements, supplies, etc. The door 54 includes a lock to lock the door 54 in a closed position and to secure the storage area.

In the illustrated construction, the door 54 is pivotally connected to the frame 14 with the hinges near the bottom of the door 54 and the door 54 pivots downwardly to open. In alternative constructions, the door 54 may open in another manner (e.g., pivot upwardly, to one side, etc.) or may be the front wall of a sliding drawer in which the storage area is provided. In any such construction, the door 54 may pivot and/or move (e.g., slide) to a position in which the open door 54 does not extend outside of the periphery of the cart 10 so that the door 54, when open, does not increase the overall dimension (e.g., width, length, etc.) of the cart 10.

The cart 10 includes slidable door supports 58 disposed near the base of the cart 10. The door supports 58 may slide outwardly to provide support for a vertically-oriented work piece, such as, for example, a door (not shown). When a door is supported by the door supports 58, the side extensions 50 may provide support to a vertical surface of the door. The door supports 58 may also support the door 54 in its open position so that the door 54 provides a surface on which equipment, tools, materials, etc. may be supported.

The cart 10 may also include other various additional features such as, for example, a vise 62, a clamp or other device for securing a work piece, a tool, or other device or material to the cart 10 and/or relative to a component (e.g., the work surface 22, the tool 26, etc.) of the cart 10.

In addition, as shown in FIG. 1, the cart 10 supports one or more battery chargers 66 for charging the associated batteries, such as, for example, power tool batteries. In some constructions, each battery charger 66, and each other electrical device used with the cart 10 (e.g., the power tool 26), may be connected directly to a power source by its associated cord (not shown).

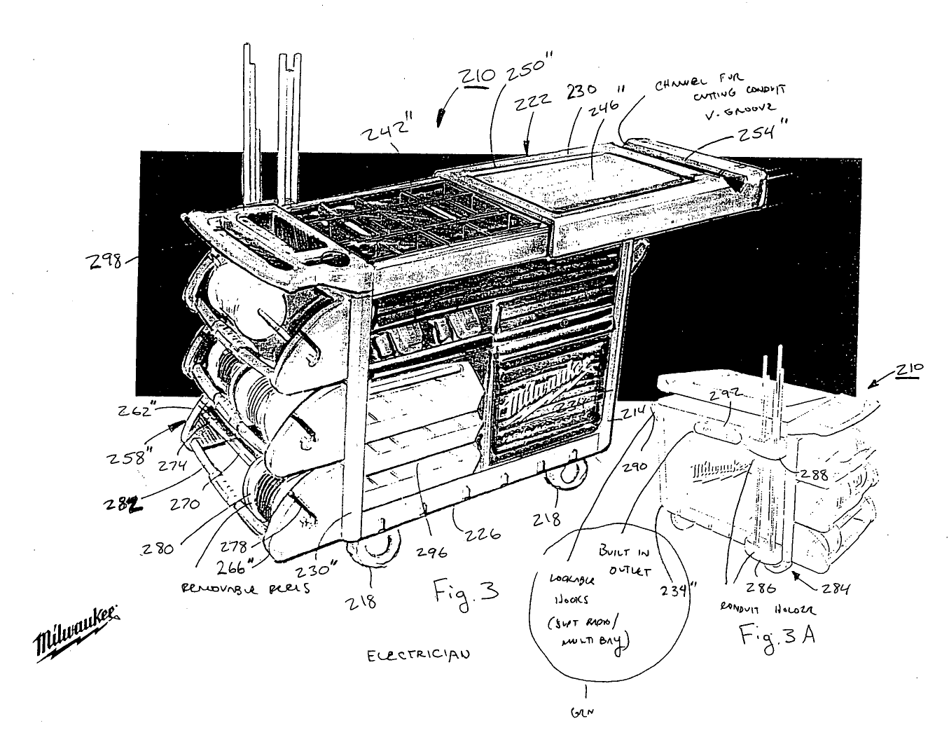

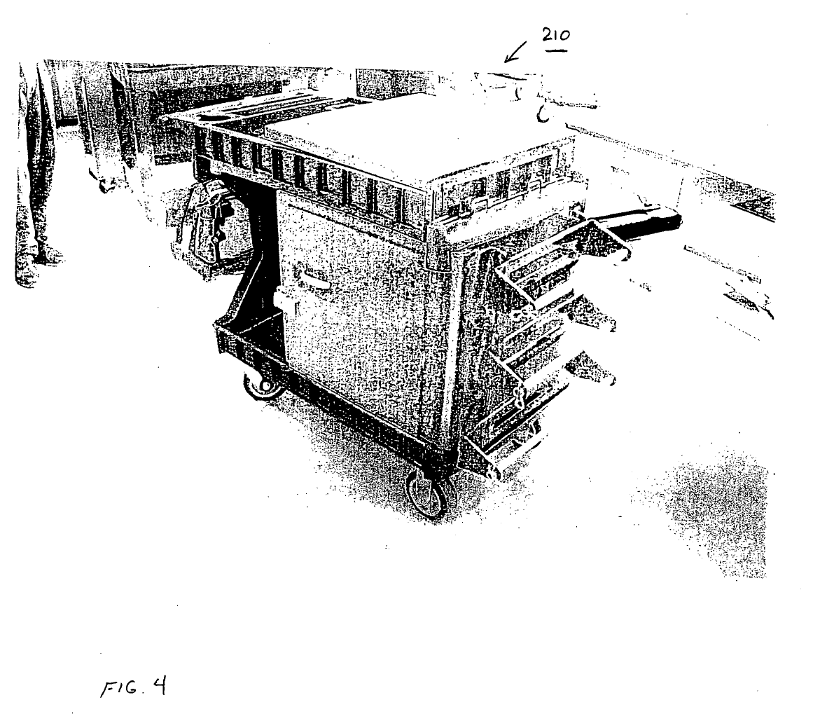

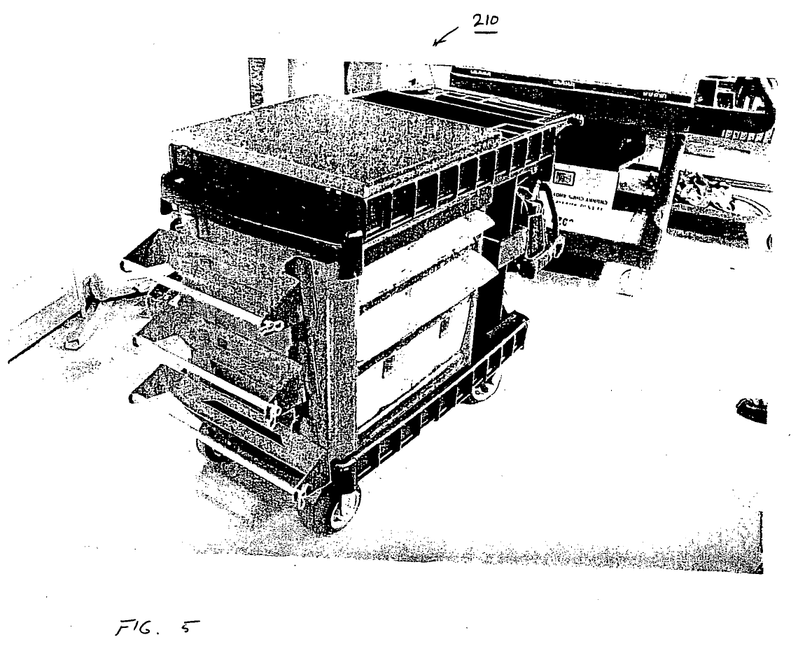

In some aspects and in some constructions, the cart 10 may also include an electrical supply arrangement. As shown in FIG. 3A, the cart 10 may include one or more outlets 292 to which an electrical device (e.g., a battery charger 66, a power tool 26, etc.) may be connected. The cart 10 may also include a connector (e.g., a cord (not shown)) for connection to a power source, such as, for example, an AC power source, a DC power source, etc. The cart 10 may include an electrical circuit (not shown) connected between the cord and the outlet(s) 292 so that power is suppliable from the power source to the outlet(s) 292.

In some aspects and in some constructions (not shown), the cart 10 and the electrical devices (e.g., the battery chargers 66, the power tool 26, etc.) may include cooperating electrical connectors other than the cord and outlet(s) 292. For example, the cart 10 and the electrical devices may include electrical connectors (not shown) similar to that provided between a power tool battery and a battery charger 66, such as that shown and described in co-pending, jointly-owned U.S. patent application Ser. No. 10/289,621, filed Nov. 7, 2002, the entire contents of which is hereby incorporated by reference. The electrical connectors may be connected when and/or as the electrical device is supported on the cart 10.

In some constructions and in some aspects, the cart 10 may include an on-board power source (not shown) for supplying power to the outlet(s) 292 and/or to the electrical devices (e.g., the battery chargers 66, the power tool 26, etc.). For example, the cart 10 may include a fuel-powered power source (e.g., a generator, an alternator, etc.), a supply battery, or other power source operable to supply electrical power.

Such a fuel-powered power source may be similar to that shown and described in co-pending, jointly-owned U.S. patent application Ser. No. 09/941,192, filed Aug. 28, 2001, now U.S. Pat. No. 6,806,680, issued Oct. 19, 2004, the entire contents of which is hereby incorporated by reference.

Such a supply battery may include one or more power tool battery packs having a nominal voltage of between 9.6 V and 50 V and including cells having a chemistry of, for example, NiCd, NiMH, Li-ion, etc. Such a power tool battery pack may be similar to that shown and described in U.S. patent application Ser. Nos. 10/719,680, filed Nov. 20, 2003; Ser. No. 10/720,027, filed Nov. 20, 2003; and Ser. No. 10/721,800, filed Nov. 24, 2003; and in U.S. Provisional Patent Application Ser. Nos. 60/574,278, filed May 24, 2004; 60/582,138, filed Jun. 22, 2004; 60/582,728, filed Jun. 24, 2004; 60/582,730, filed Jun. 24, 2004; 60/612,352, filed Sep. 22, 2004; 60/626,013, filed Nov. 5, 2004; and 60/643,396, filed Jan. 12, 2005; the entire contents of all of which are hereby incorporated by reference.

In some constructions and in some aspects, the cart 10 may be a power-driven cart and may include a motor (not shown) drivingly connected to one or more of the wheels 18 to drive the cart 10 to, from and/or around a work site. In such constructions, the motor may be powered by a power source, such as, for example, a fuel-powered power source (e.g., the fuel-powered power source described above), a battery power source (e.g., the supply battery described above), or other power source operable to power the motor. In such constructions, the cart 10 may include a suitable drive arrangement (not shown) for transferring drive power from the motor to one or more drive wheels (such as one or more of the wheels 18) and a suitable control arrangement (not shown) for providing and controlling movement of the cart 10.

In some aspects and in some constructions, the cart 10 may be similar to the carts 110, 210 and 310 described below and shown in the respective figures.

FIG. 2 illustrates a second construction of an industrial cart 110 that may be generally used for metal working. The cart 110 may be similar to the carts 10, described above, 210 and 310, described below, and shown in the respective figures, and common elements have the same reference number “100”. An element identified by a reference number in the “100” series and including “′” identifies an element which is different than an element in another series having the same reference number.

As shown in FIG. 2, the cart 110 generally includes a frame 114, wheels 118 supporting the frame 114, and a work surface 122. In the illustrated construction, the power tool 126 may include a metal cutting chop saw, cutter, grinder, jigsaw, band saw, drill, other similar power tool, other equipment, etc. The work surface 122 includes table top portions 130 on opposite sides of the power tool 126 and respective telescoping extensions 138.

In the illustrated construction, the frame 114 include a column 150′ on each side of the frame 114 extending upwardly from the base 124 to support the work surface 122. Arms 154′ extend outwardly from opposite sides of the column 150′ to provide support ledges for supporting materials, work pieces, etc. The arms 154′ extending from each column 150′ may be positioned at substantially the same height as a corresponding arm 154′ extending from the other column 150′ to provide a relatively uniform and level support surface. Each arm 154′ includes a raised surface or boss 158′ at the end of the arm 154′ opposite the column 150′ to help retain the work piece on the arms 154′.

Metal working generally includes working with heavier materials, such as steel, as compared to woodworking. The frame 114 of the cart 110 may be made from a relatively sturdier or heavier duty material, such as steel or another similar metal, to support the weight of the metal materials being stored on the frame 114 and operated upon on the work surface 122.

In some constructions, as described below in more detail, the sturdier frame 114 may be formed as a frame assembly including a first frame member similar to or the same as that provided in the carts 10, described above, and 210 and 310, described below, and a second or reinforcing frame member to provide additional support to the frame assembly. As such, a common or single first frame member may be used in each of the carts 10, described above, 210 and 310, described below, and 110.

As described above in relation to the previous cart, the cart 110 may also include other various additional features, such as, for example, a vise 162, clamp, an electrical supply arrangement, one or more battery chargers (not shown), etc.

FIGS. 3, 3A and 4-7 illustrate a third construction of an industrial cart 210 that may be generally used for electrical work or by an electrician. The cart 210 may be similar to the carts 10, 110, described above, and 310, described below, and shown in the respective figures, and common elements have the same reference number “200”. An element identified by a reference number in the “200” series and including “″” identifies an element which is different than an element in another series having the same reference number.

The cart 210 includes a frame 214, one or more lockable wheels 218 supporting the frame 214, and a work surface 222. In the illustrated construction, the rear wheels 218 are lockable to selectively hold the cart 210 in a location.

The frame 214 includes a base 224 and ends 230″, 234″ disposed opposite one another and extending upwardly from the base 224 to the work surface 222. The work surface 222 includes a table top portion 230 connected to the top of the frame 214. In the illustrated construction, the table top portion 230 is slidably connected to the frame 214 and may slide in a generally linear direction with respect to the frame 214 to expose storage, such as storage bins 242″, positioned below the sliding table top portion 230. The storage bins 242″ may hold various items, such as, for example, electrical accessories, materials, supplies or tools. In alternate constructions, the table top portion 230 may be pivotally connected to the frame 214 (as shown in FIG. 3A) or may be swivelably connected to the frame 214 to uncover/open the storage area.

The table top portion 230 includes a recessed main surface 246″ and a raised ridge 250″ extending around the main surface 246″. Electrical work commonly includes relatively small pieces, such as, for example, wire endings, outlets, small screws, connectors, or other similar pieces, and relatively small hand tools, such as, for example, pliers, crimpers, wire strippers, soldering devices, or other similar tools. The recessed main surface 246″ and raised ridges 250″ may prevent small electrical accessories, pieces, or tools from sliding off the table top portion 230.

The table top portion 230 also provides a relatively large flat surface for displaying documents, such as, for example, blueprints, job designs, diagrams, or other work specifications. The pivotable table top portion 230 (for example, shown in FIG. 3A) may position such documents in an improved viewing position. A light (not shown) may be provided to illuminate such documents. Also, a holding arrangement, such as, for example, one or more clips (not shown), may be provided to retain the documents in position.

The table top portion 230 also includes a recessed channel 254″ extending across the table top portion 230. The channel 254″ may have a generally V-shaped cross-section and includes two slanting surfaces extending downwardly toward an intersection. The channel 254″ may receive and retain electrical conduit sections of varying cross-section and/or diameter with the slanted surfaces supporting the conduit. The retained conduit sections may be cut to desired lengths while retained in the channel 254″. The open ends of the channel 254″ permit a conduit section having a length longer than the channel 254″ or table top portion 230 to be supported.

In the illustrated construction, the cart 210 includes reel racks 258″ connected to the first side 230″ of the frame 214 for retaining reels of electrical wire. In the illustrated construction, the cart 210 includes three reel racks 258″. Each rack 258″ includes opposing first and second brackets 262″, 266″ at opposite ends of the rack 258″ for supporting a removable rod 270. A first bracket 262″ defines an aperture or recess 274 for retaining a first end of the rod 270, and the second bracket 266″ defines a channel 278 for supporting the second end of the rod 270. The second end of the rod 270 may be inserted through the channel 278 to position the rod 270 within the rack 258″.

Multiple spools or reels 280 of electrical wire may be removably positioned on the rod 270 and stored on the racks 258″. The racks 258″ also include a bar 282 extending between the brackets 262″, 266″ and at least partially protecting the reels 280. The user may add or remove reels 280 to select the desired electrical wire to suit the required application. The reels 280 may be standard reels that may be easily supported and stored in other areas such as, for example, a work shop, a truck, etc., and transferred to/from the cart 10 for use.

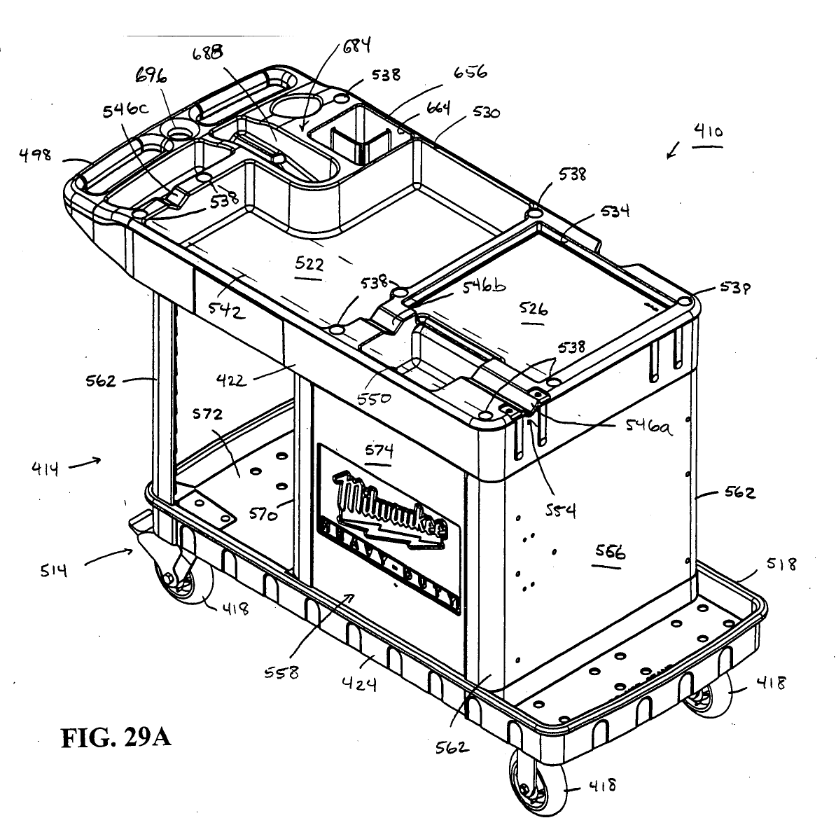

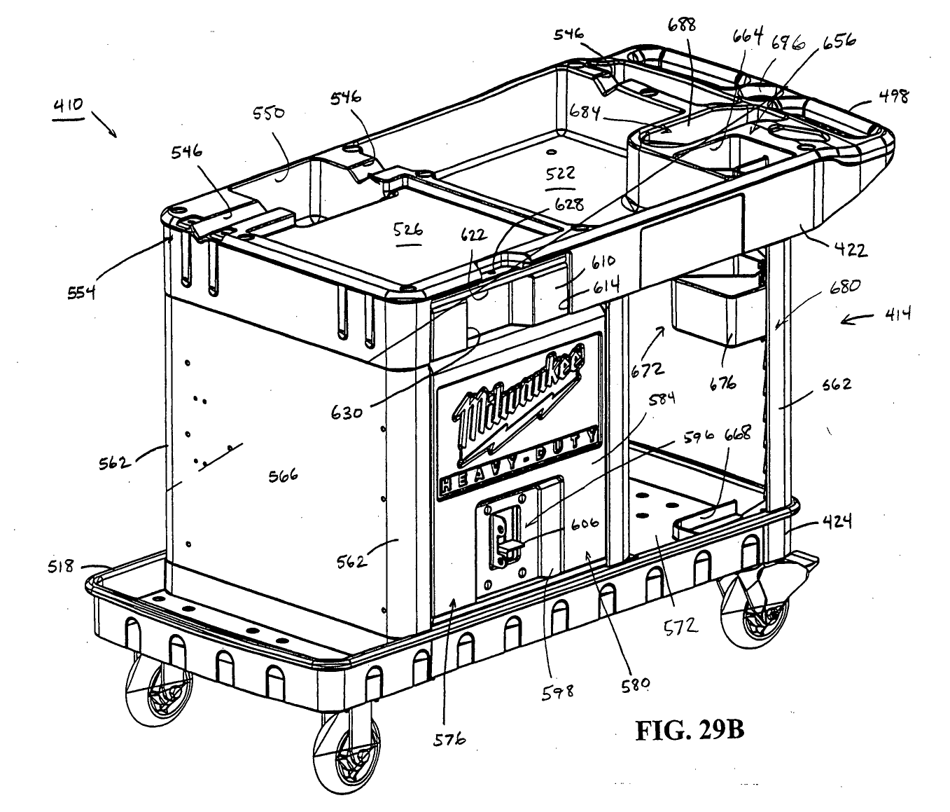

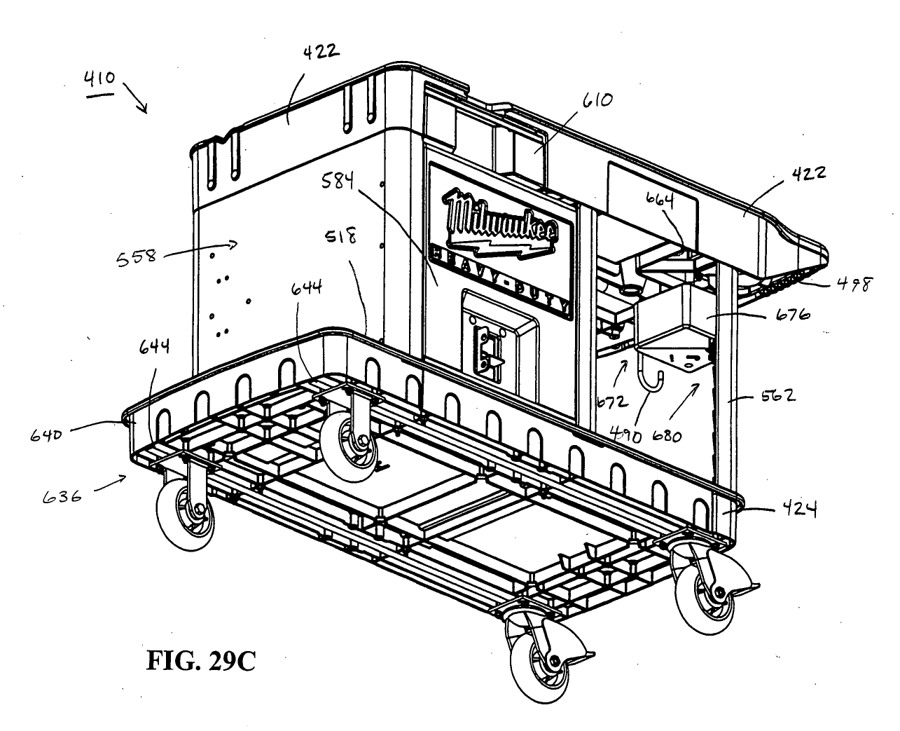

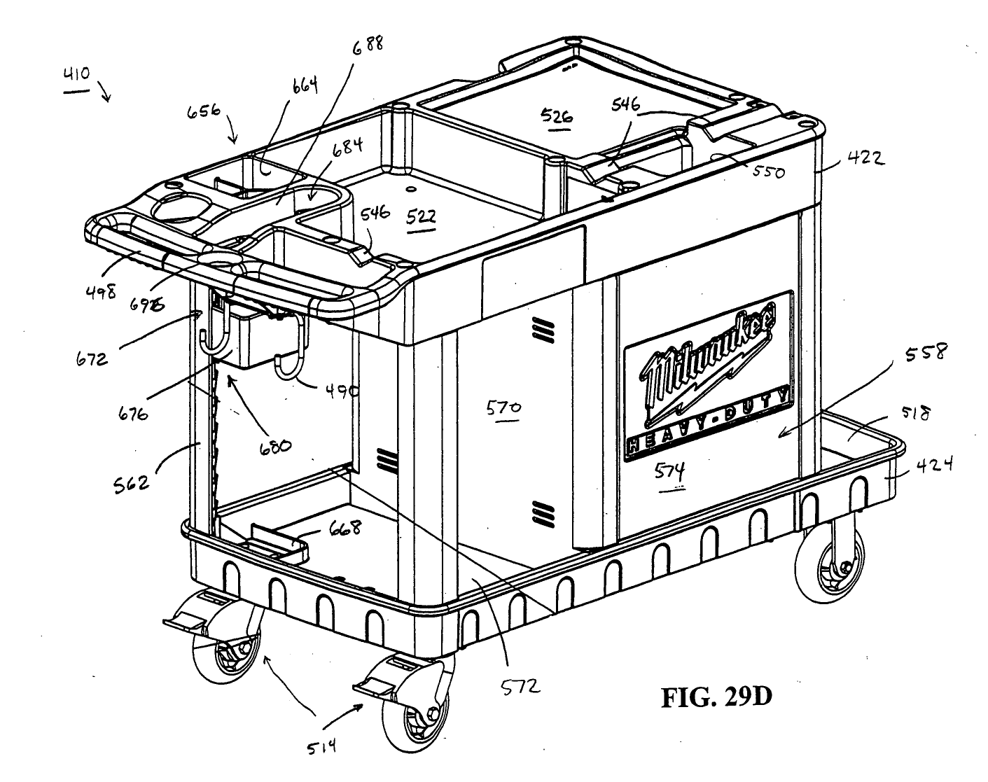

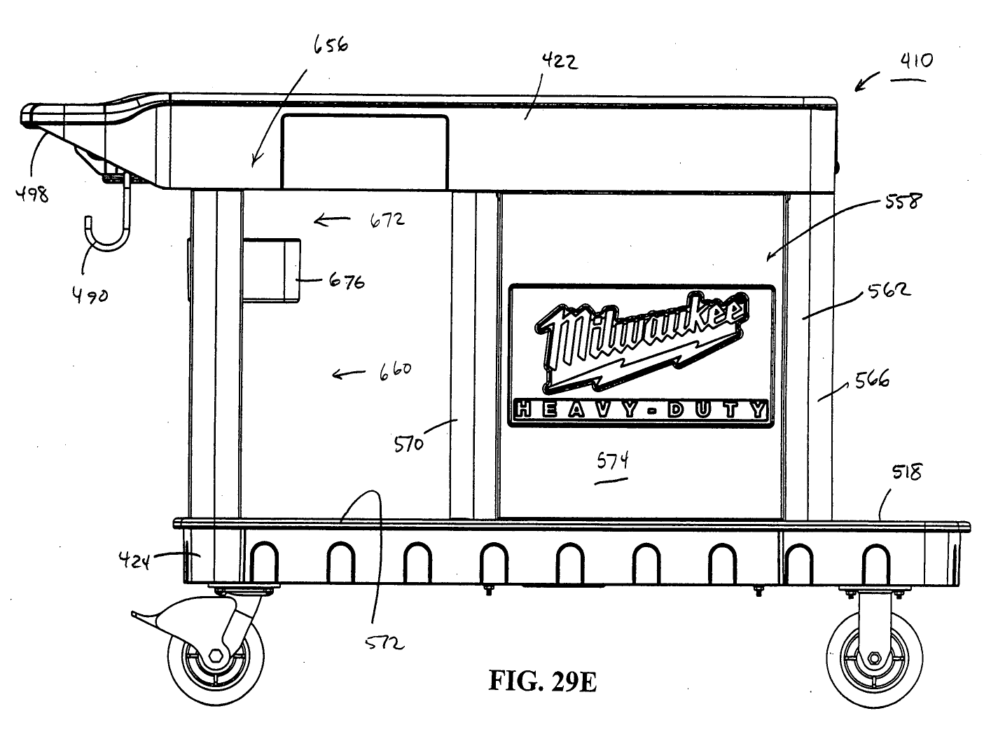

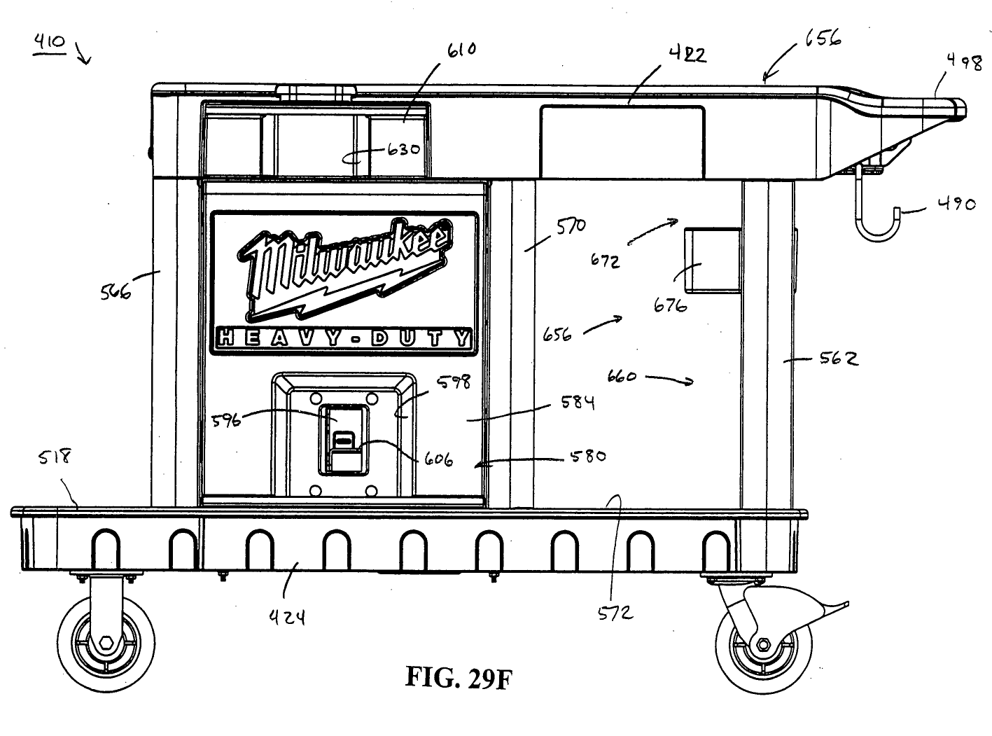

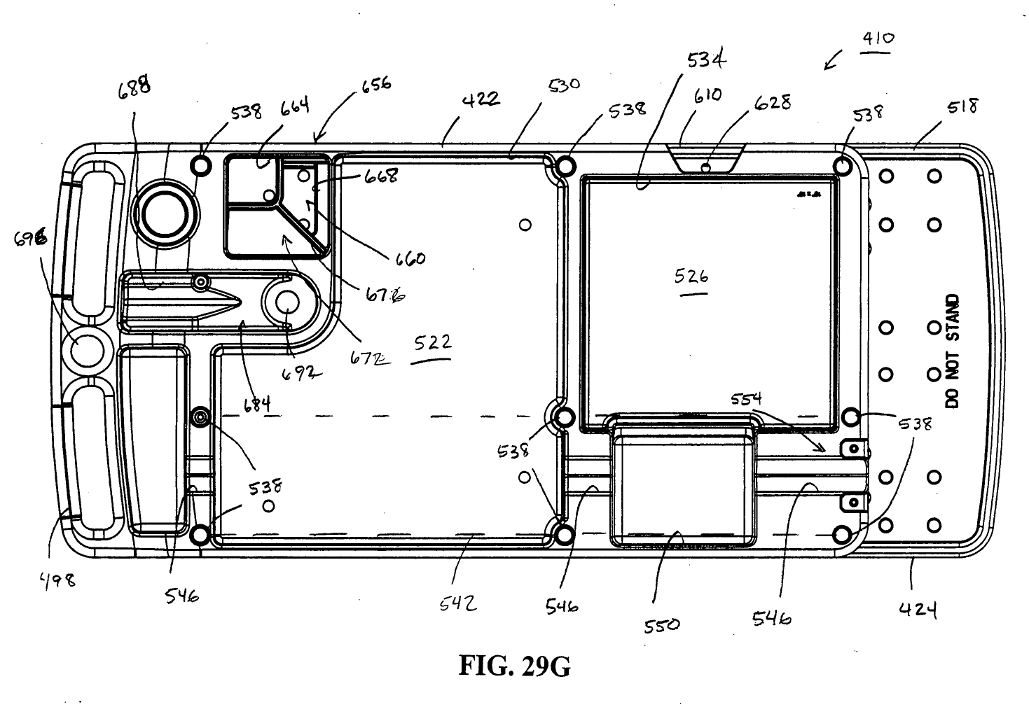

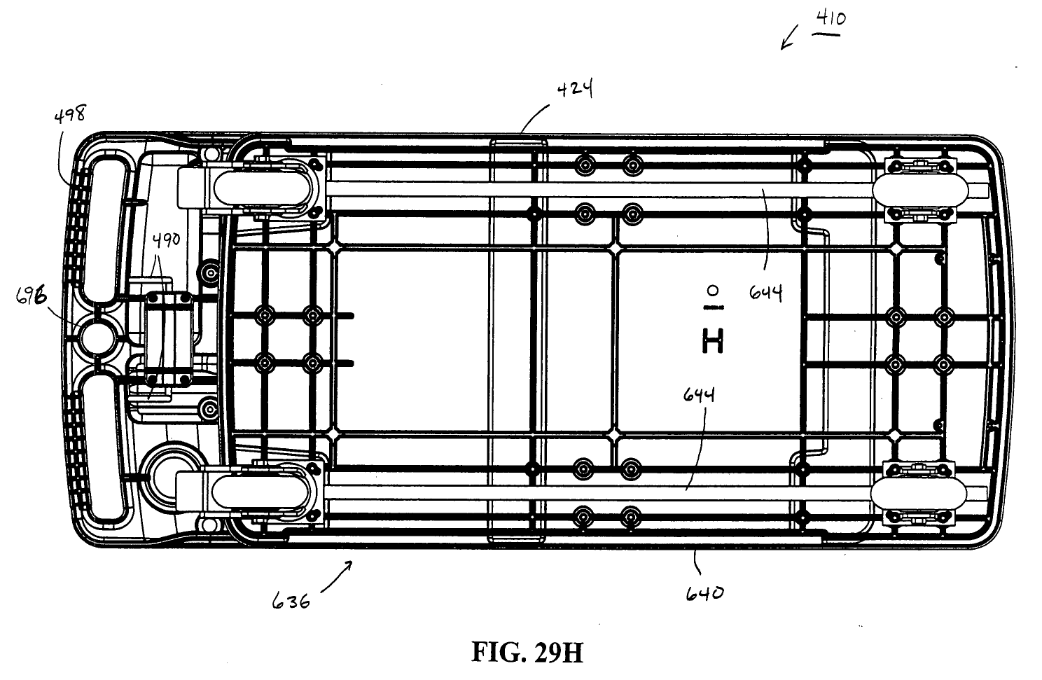

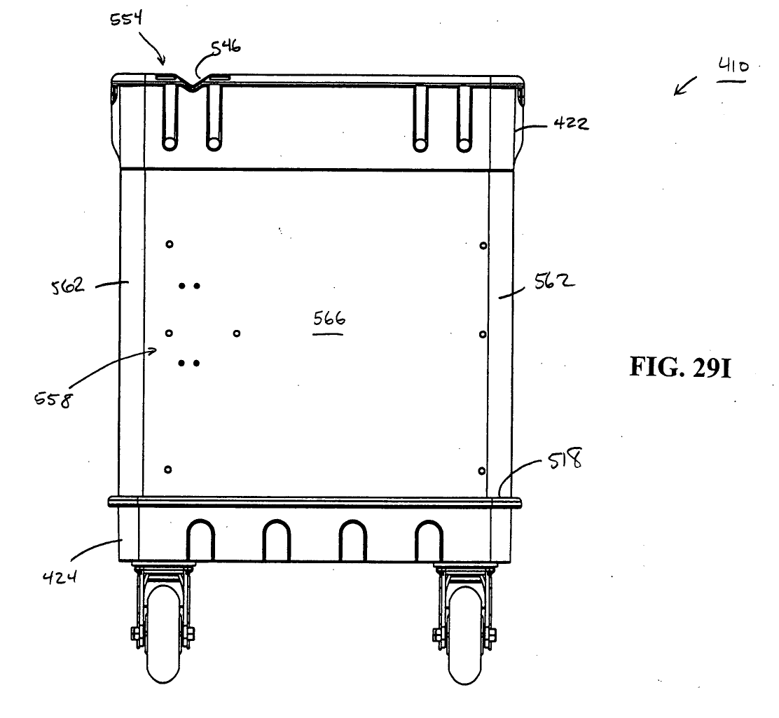

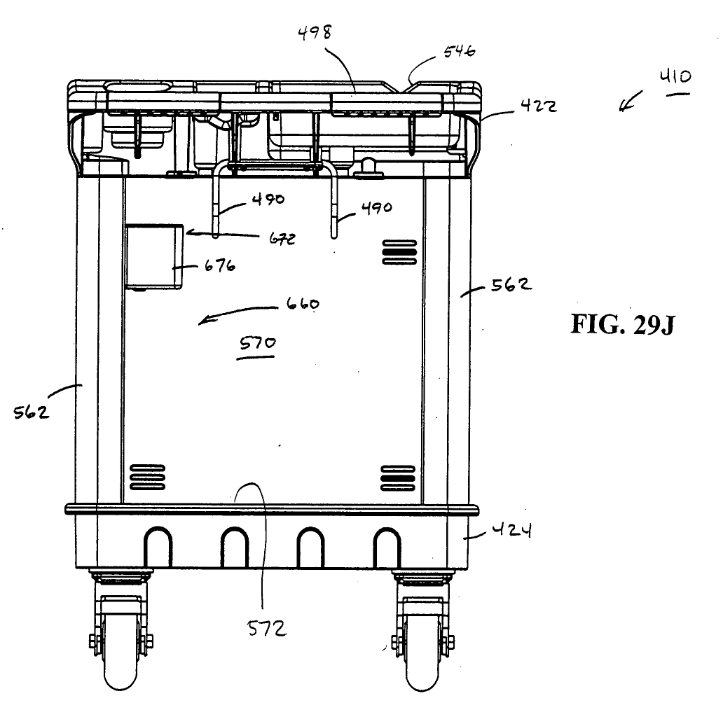

The cart 210 also includes a conduit holder 284 including a holder base 286 disposed near the base 224 of the cart 210 and a retainer 288 disposed near the top of the cart 210. The holder base 286 defines a cavity having raised edges to retain the ends of the conduit sections. The retainer 288 defines a generally ring shaped portion holding the conduit sections in an upright position. Conduit sections may be inserted into the top of the retainer 288 and slid downwardly until the end of the conduit section is positioned within the cavity of the holder base 286. The holder base 286 and retainer 288 may include one or more dividers to define separate compartments of the holder 284. Each compartment may be used to retain different types of conduit. The cart 210 may include additional holders 284 to store additional conduit sections. In alternate constructions (not shown), the conduit holder 284 may include a single elongated tubular holder having one closed end and one open end. As shown in FIGS. 4-7 (and in FIGS. 29-36, as described below), the conduit holder 284 may be provided within the periphery of the cart 210, rather than extending outwardly from a wall of the cart 210 (as shown in FIGS. 3 and 3A).

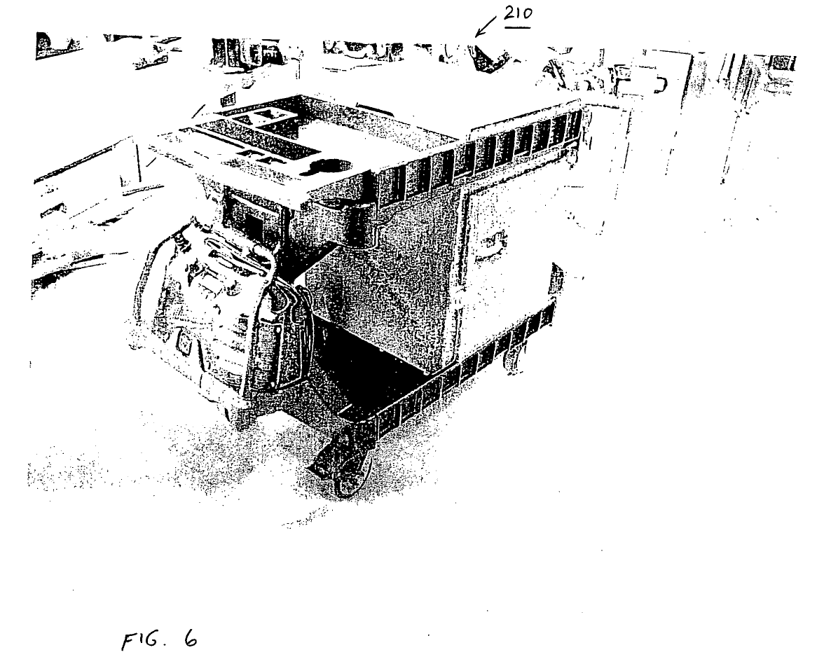

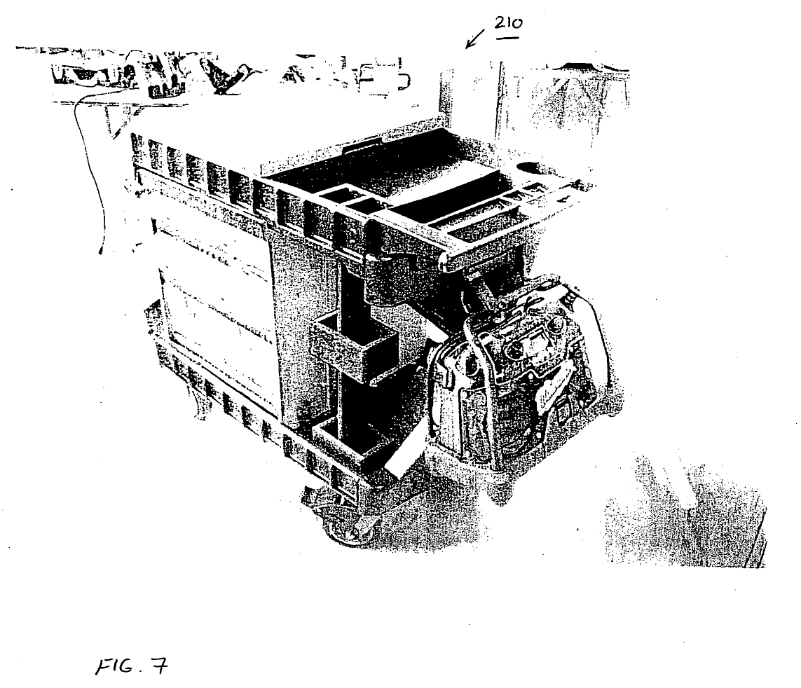

In the illustrated construction, the end 234″ of the cart 210, opposite the racks 258″, includes hooks 290 extending from the frame 214. The hooks 290 may hold various accessories, such as, for example, a radio (see FIGS. 4-7), a battery charger, a multi-bay battery charger, a battery charger caddy, additional power tools, other similar equipment or accessories, etc. As shown in FIGS. 6-7, the hooks 290 may be lockable to secure the accessory and to prevent the accessory from moving or being removed from the hook 290.

As described above in relation to the previous carts, the cart 210 may also include other various additional features, such as, for example, a vise (not shown), clamp (not shown), an electrical supply arrangement (including outlets 292), one or more battery chargers 266, etc.

The cart 210 may also include various storage bins 296, containers, drawers, and shelves for storing various electrical components, accessories, parts, or any other desired implements. As shown in FIG. 3, the cart 210 also includes a handle 298 to facilitate moving the cart 210. The handle 298 may include an elastomeric grip portion to, for example, improve the comfort of the user, provide improved gripping, reduce vibration transmitted to the user, etc.

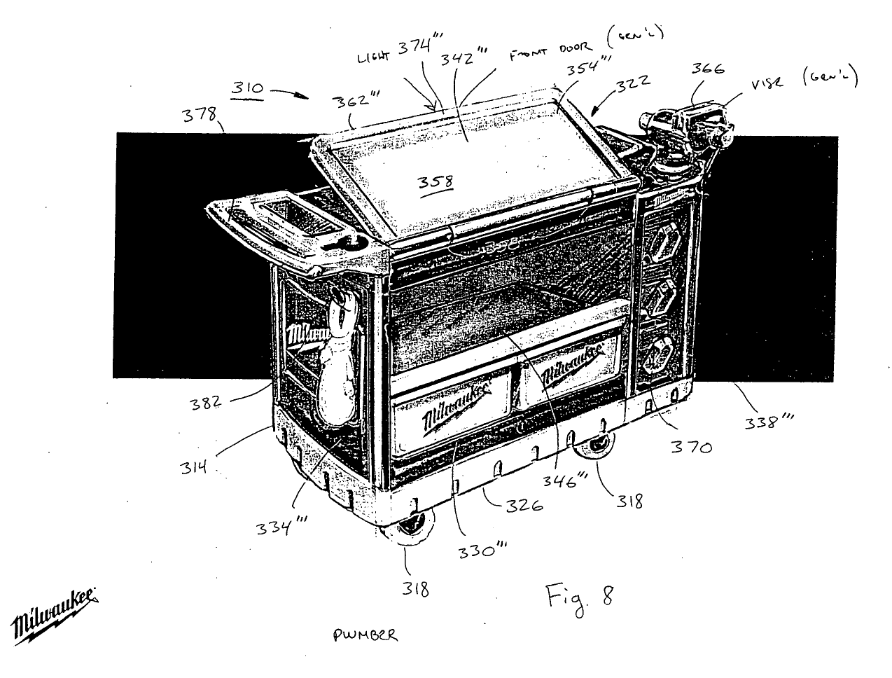

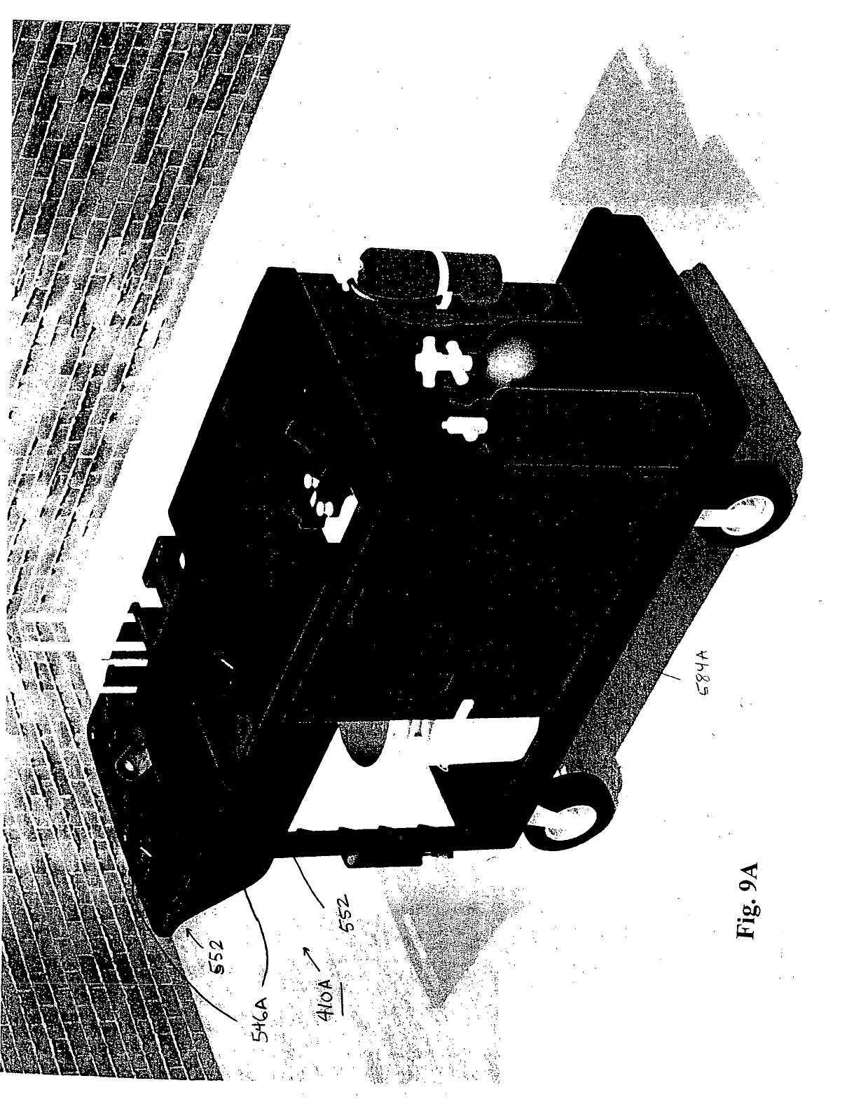

FIG. 8 illustrates a fourth construction of an industrial cart 310 that may be generally used for plumping work. The cart 310 may be similar to the carts 10, 110 and 210, described above, and shown in the respective figures, and common elements have the same reference number “300”. An element identified by a reference number in the “300” series and including “′″” identifies an element which is different than an element in another series having the same reference number.

The cart 310 includes a frame 314, wheels 318 supporting the frame 314, and a work surface 322 near the top of the cart 314. The frame 314 includes a base 324, a side portion 330′″ and ends 334′″, 338′″ extending upwardly from the base 324 to the work surface 322 on opposite ends of the portion 330′″.

The cart 310 includes a door 342′″ disposed on the side portion 330′″ of the cart 310. The door 342′″ may cover a storage area 346′″ within the cart 310 for storing additional tools, piping, joints, accessories, other similar implements, etc. The storage area 346′″ may include a shelf and storage bins, as shown in FIG. 8. The door 342′″ includes a lock to lock the door 342′″ in a closed position with respect to the frame 314 and secure the storage area.

In the illustrated construction, the door 342′″ is connected to the frame 314 with hinges 350′″ near the top of the door 342′″, and the door 342′″ pivots upwardly to open. The door 342′″ may swing open such that the front portion of the door 342′″ rests on the top of the cart 310 and the back portion of the door 342′″ is exposed and provides a table top surface 354′″ near the work surface 322 of the cart 310. In the open position, the door 342′″ may be positioned within the periphery of the cart 310 so that the door 342′″, when open, does not increase the overall dimension (e.g., width, length, etc.) of the cart 310.

The table top surface 354′″ of the door 342′″ includes a recessed main surface 358′″ and a raised ridge 362′″ extending around the main surface 358′″. The recessed main surface 358′″ and raised ridge 362′″ help prevent parts, tool, accessories, or other implements from sliding off the table top surface 354′″. Also, the table top surface 354′″ also provides a relatively large flat surface for displaying blueprints, job designs, diagrams, other work specifications, etc.

A light 374′″ may be provided adjacent the table top surface 354′″ to provide illumination. The light 374′″ may be formed integrally with the cart 310 or may be removably mounted on the cart 310. The light 374′″ may be battery-powered or may be powered through the electrical supply arrangement.

As described above in relation to the previous carts, the cart 310 may also include other various additional features, such as, for example, a vise 362, clamp (not shown), an electrical supply arrangement (not shown), one or more battery chargers 366, etc.

The cart 310 may also include various storage bins, containers, drawers, and shelves for storing various electrical components, accessories, parts, or any other desired implements. As shown in FIG. 3, the cart 310 also includes a handle 398 to facilitate moving the cart 310.

The cart 310 may include a hook 390 projecting from one end 334′″ of the cart. The hook 390 may also hold various other accessories, such as, for example, a radio, a multi-bay battery charger, a battery charger caddy, additional power tools, other similar accessories, etc. The hooks 390 may be lockable to retain the accessory and prevent the accessory from moving or being removed from the hook 390.

FIGS. 29-34 illustrate additional constructions of an industrial cart 410. The cart 410 may be similar to the carts 10, 110, 210 and 310 described above and shown in the respective figures, and common elements have the same reference number “400” (and including “′”, “″”, “′″”, if provided).

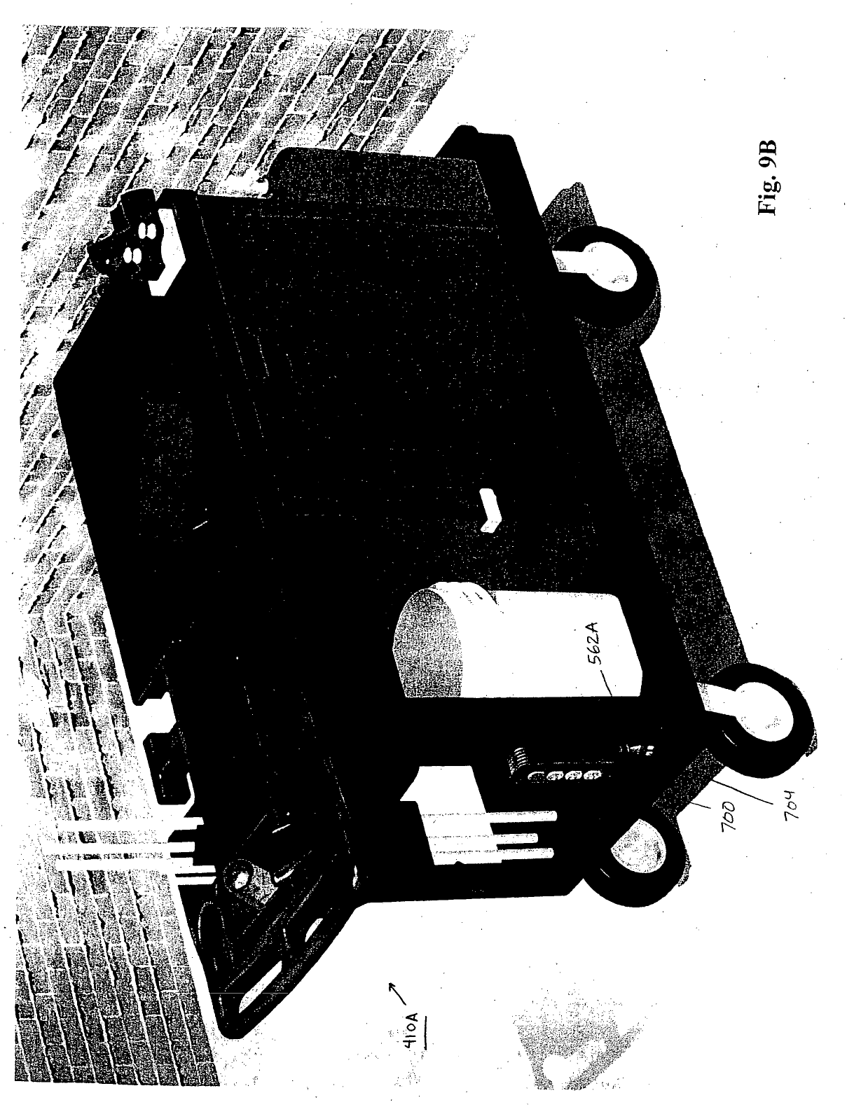

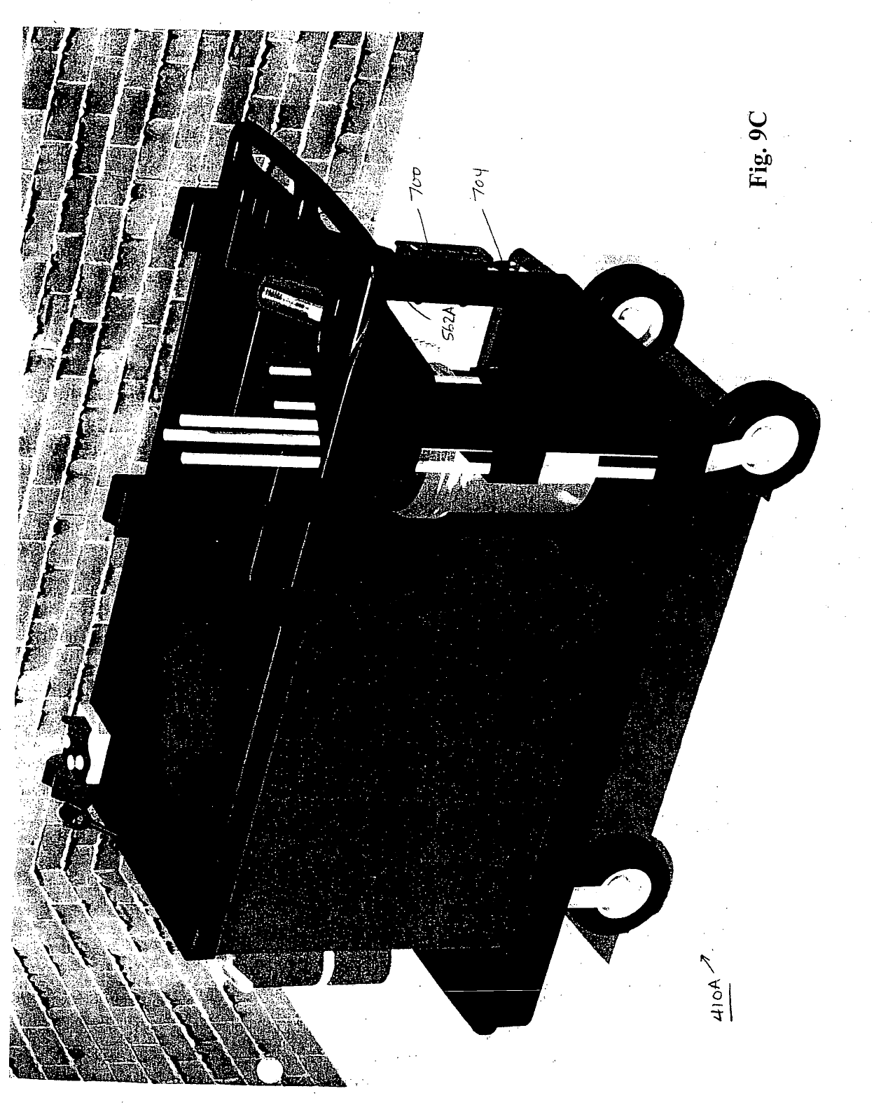

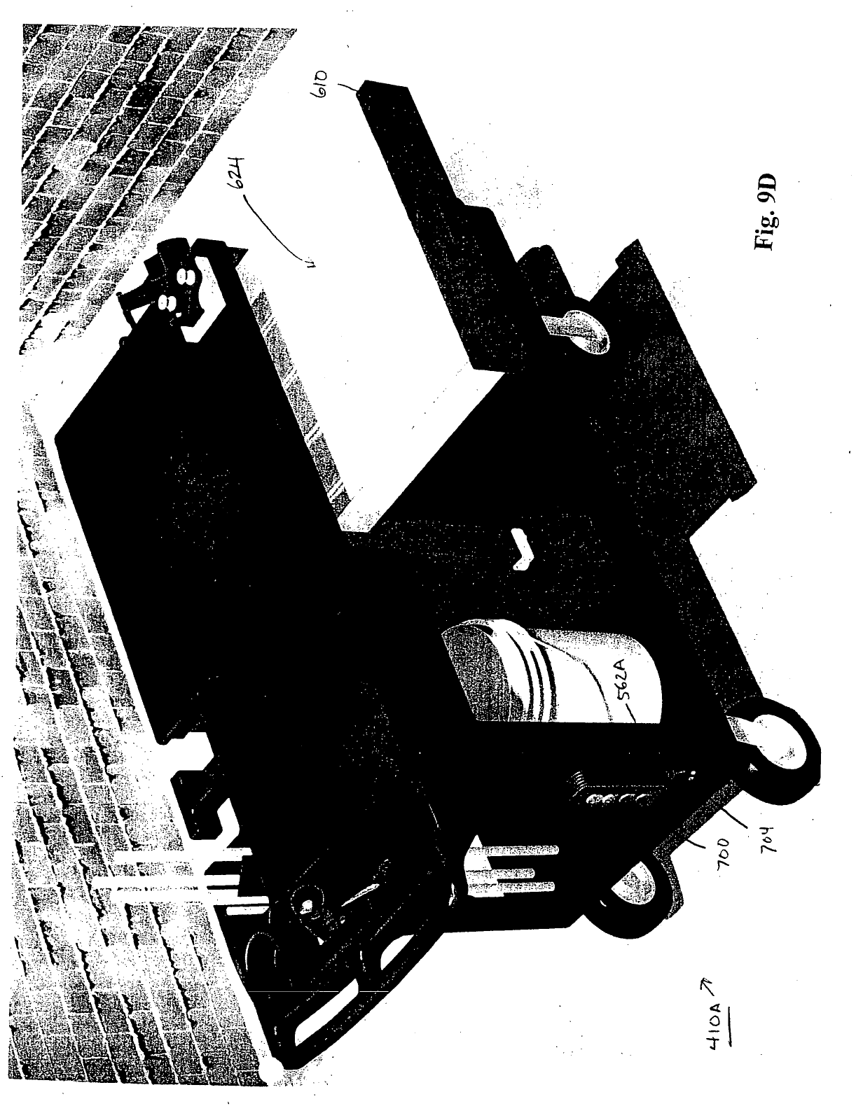

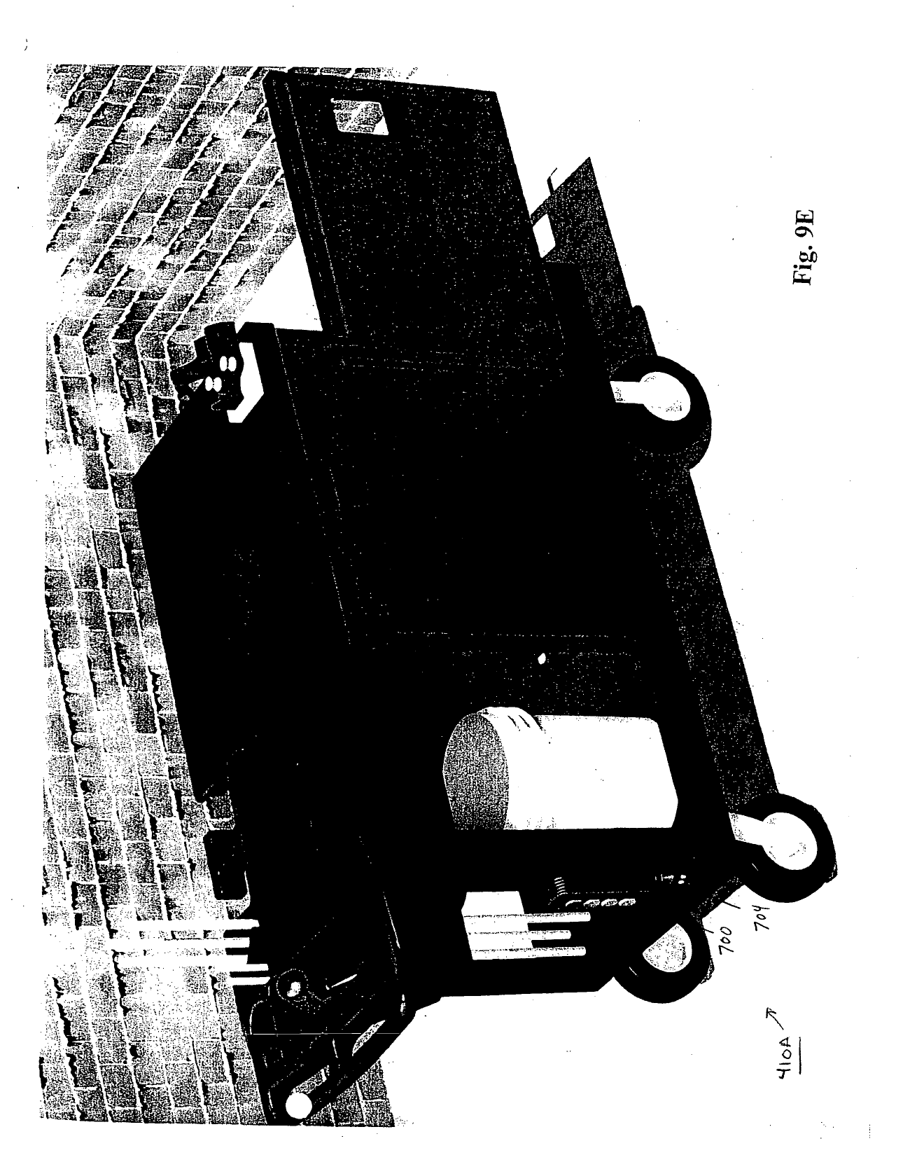

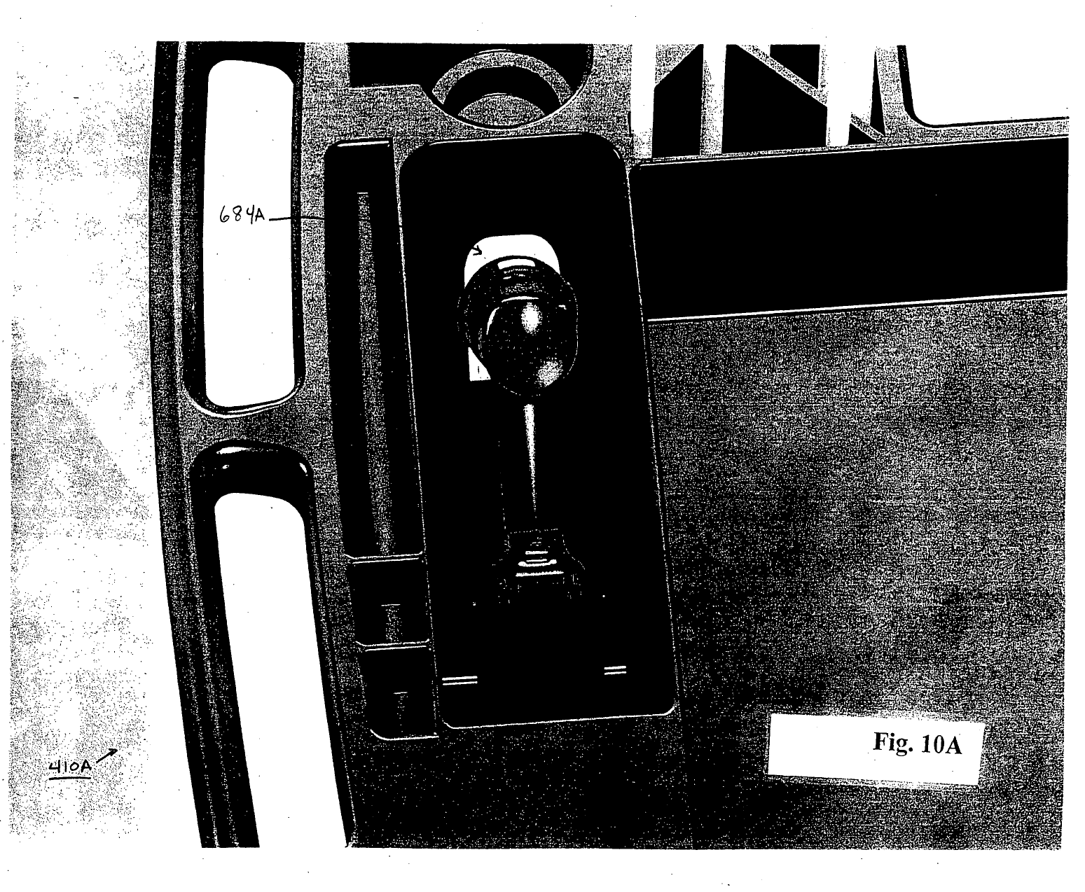

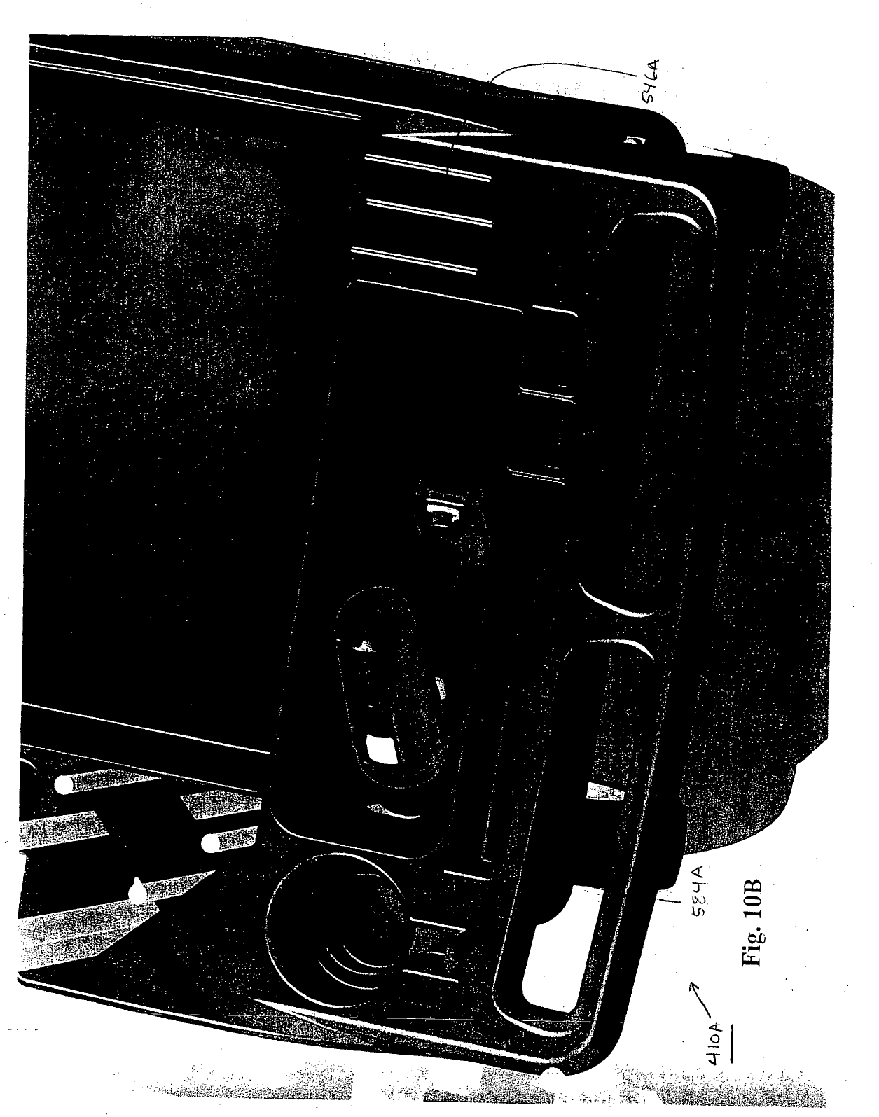

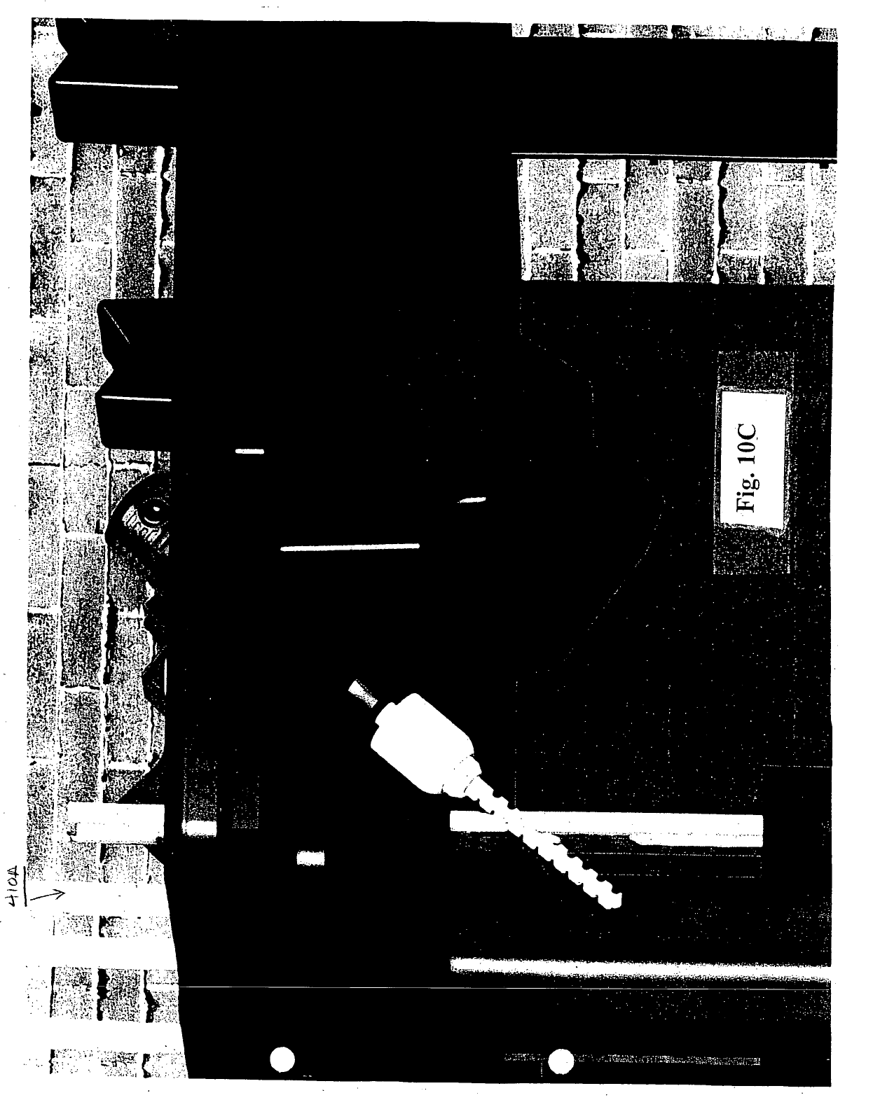

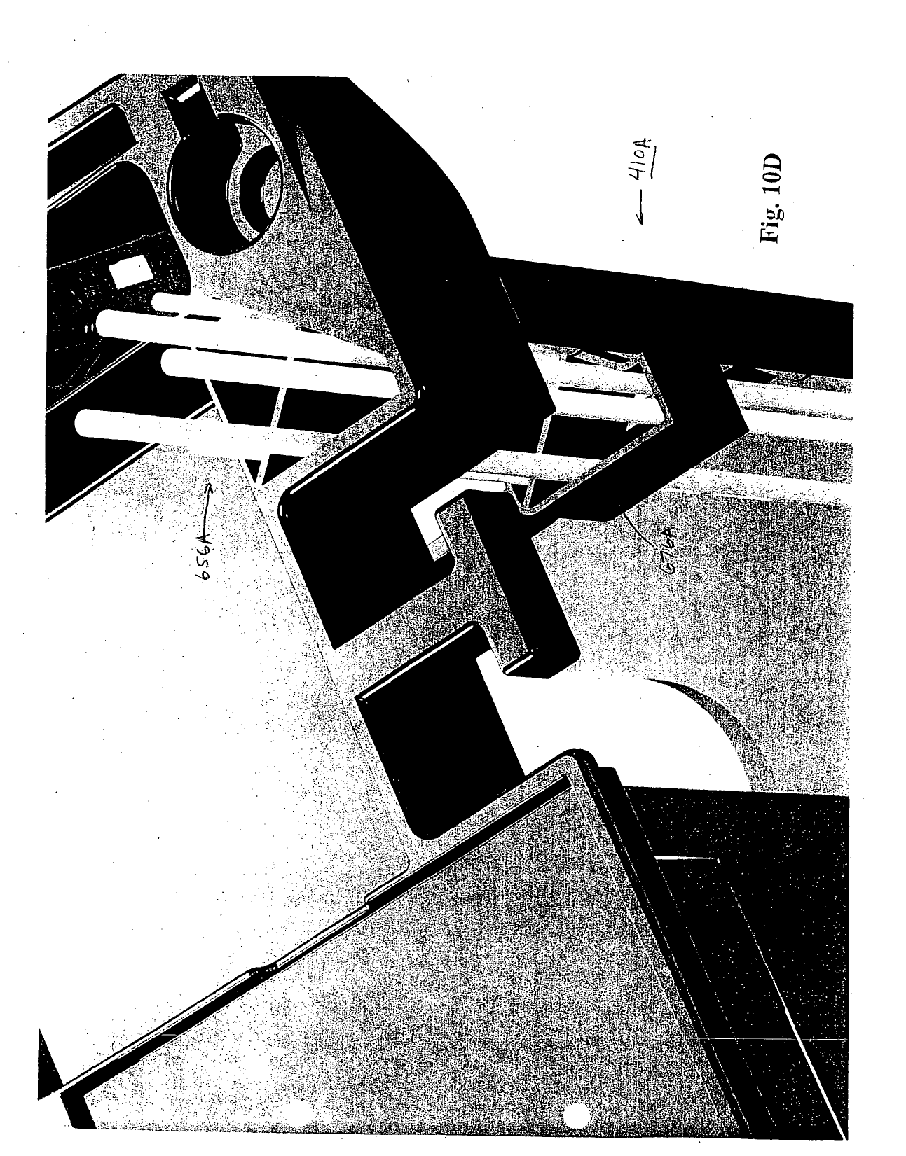

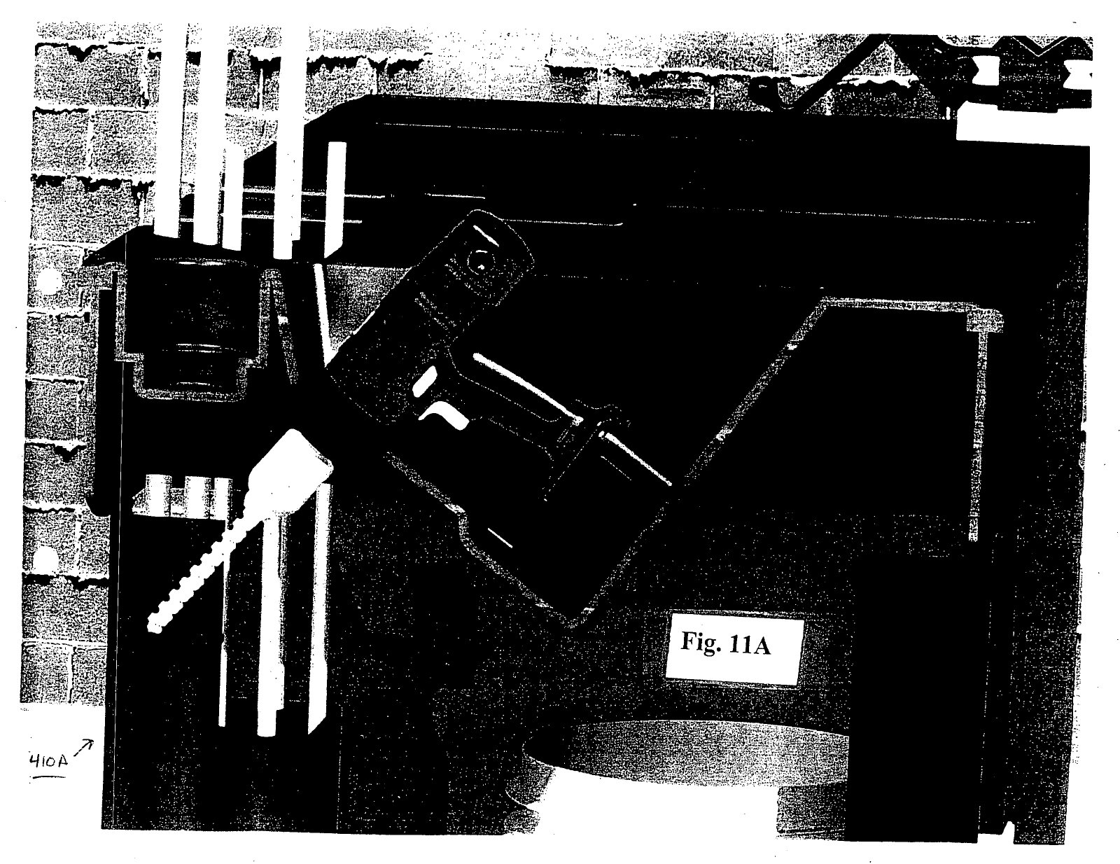

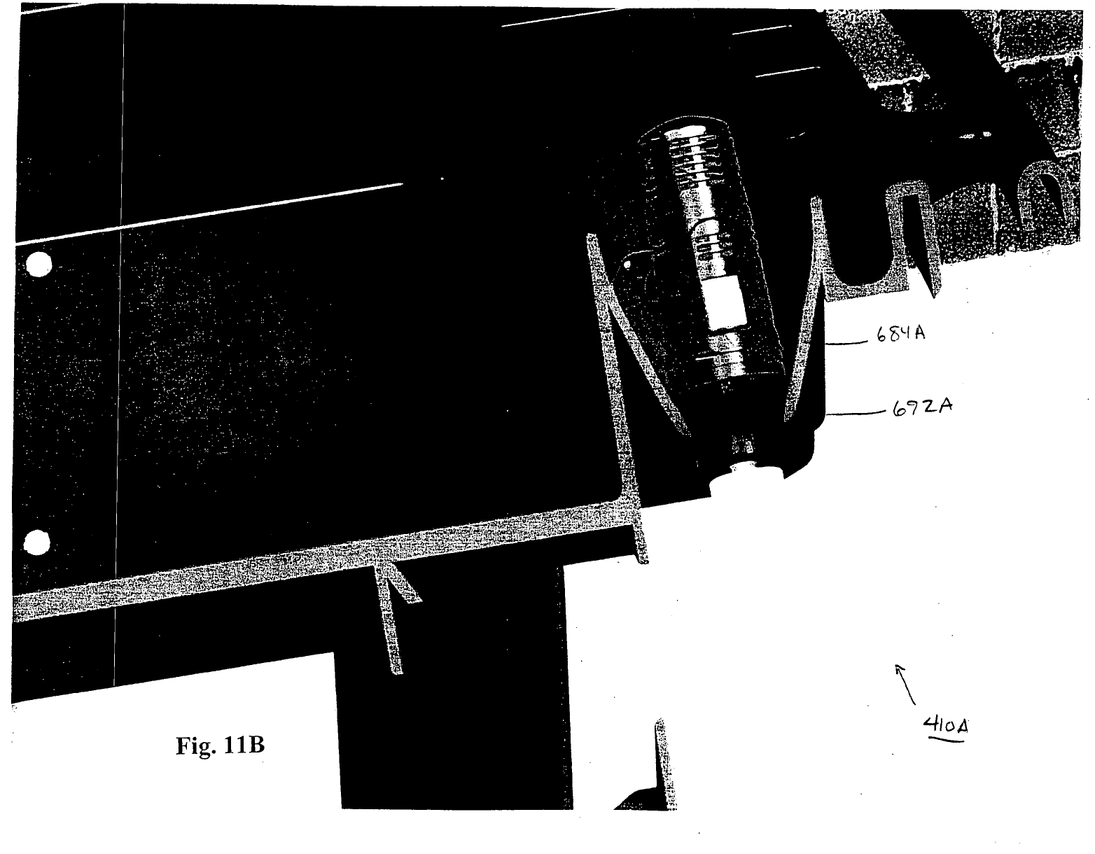

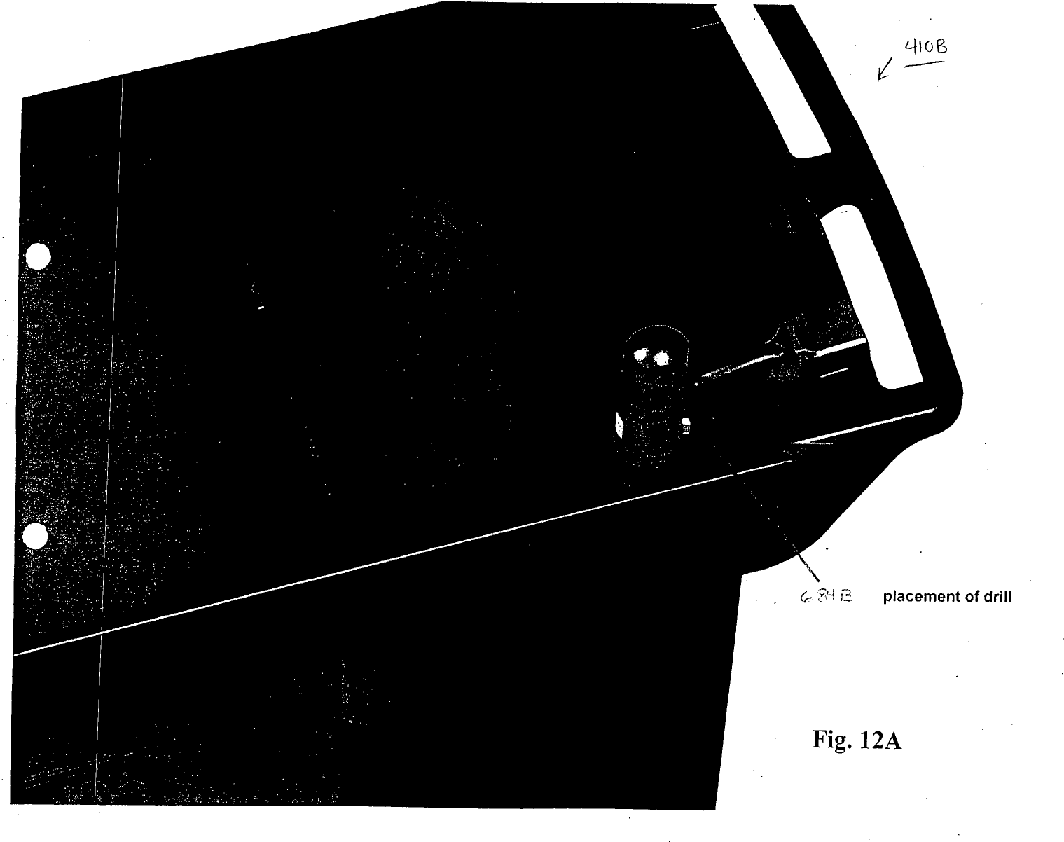

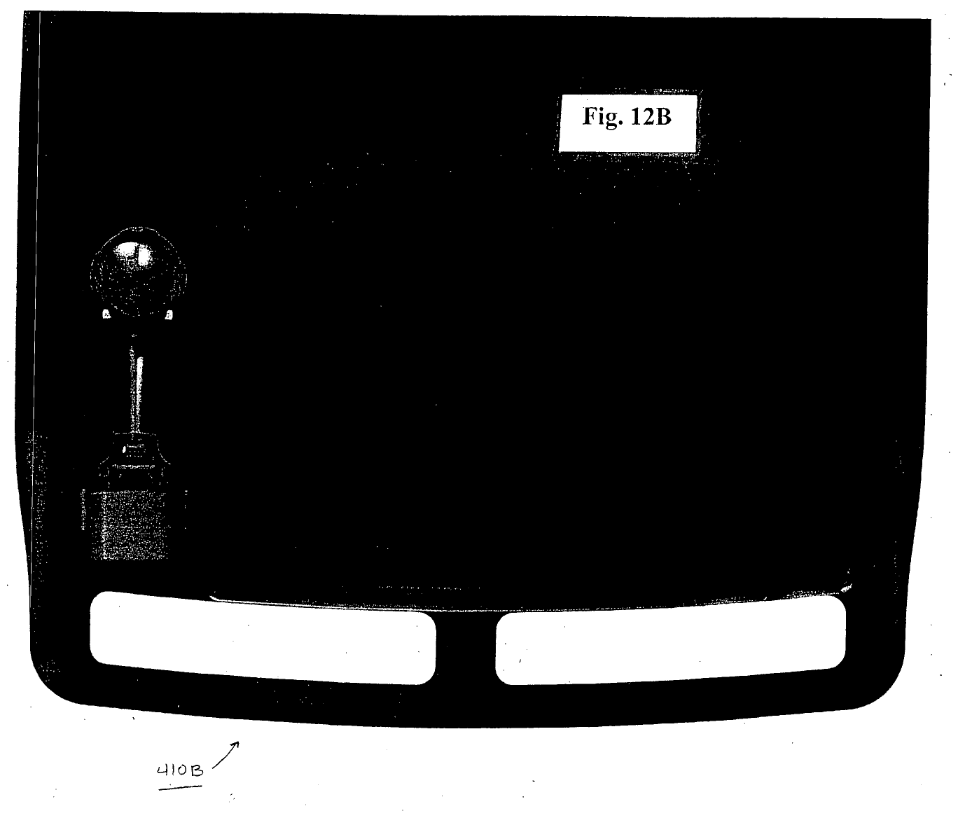

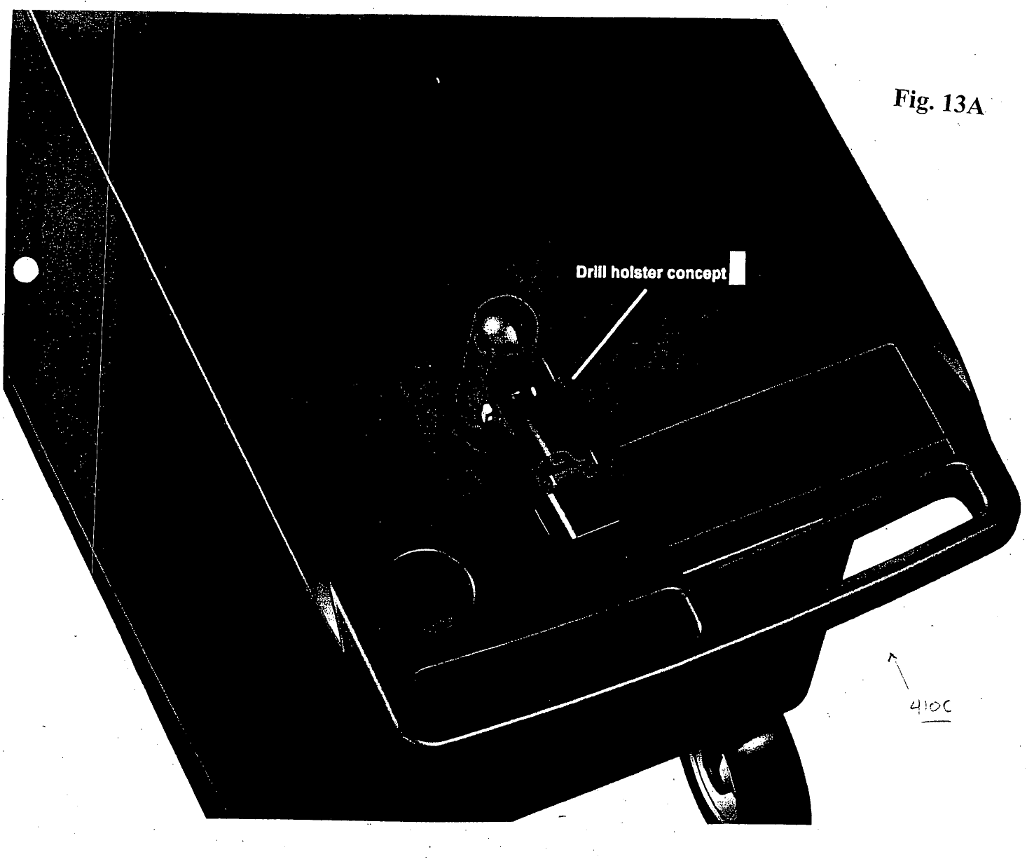

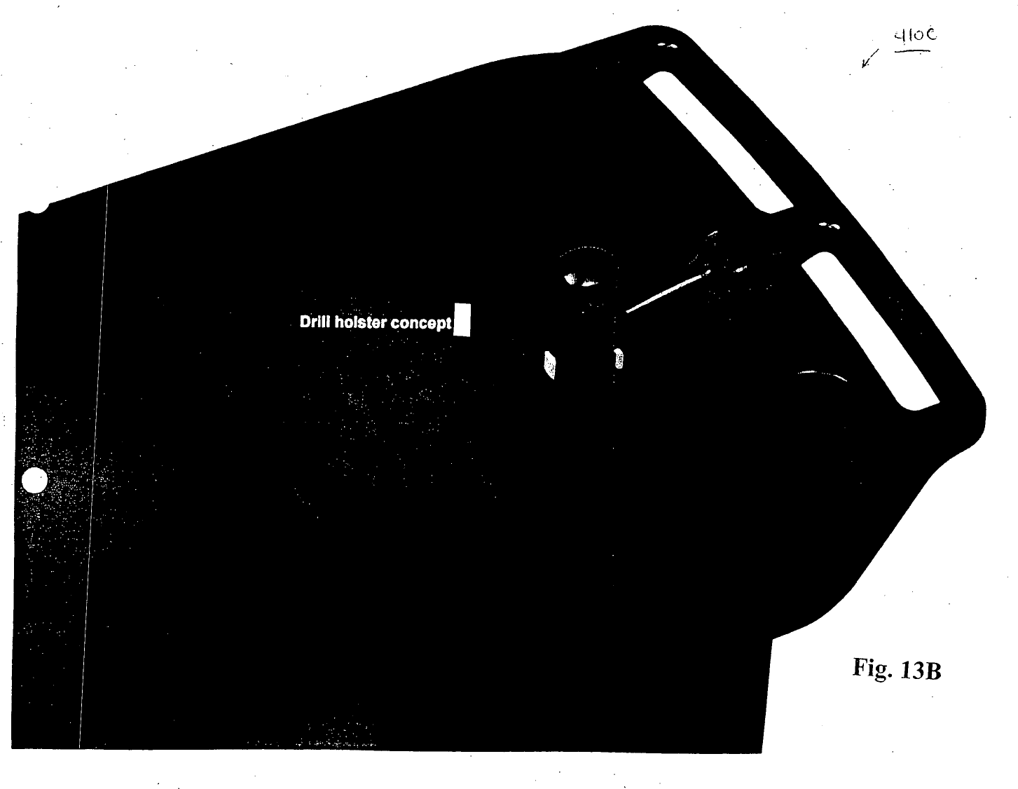

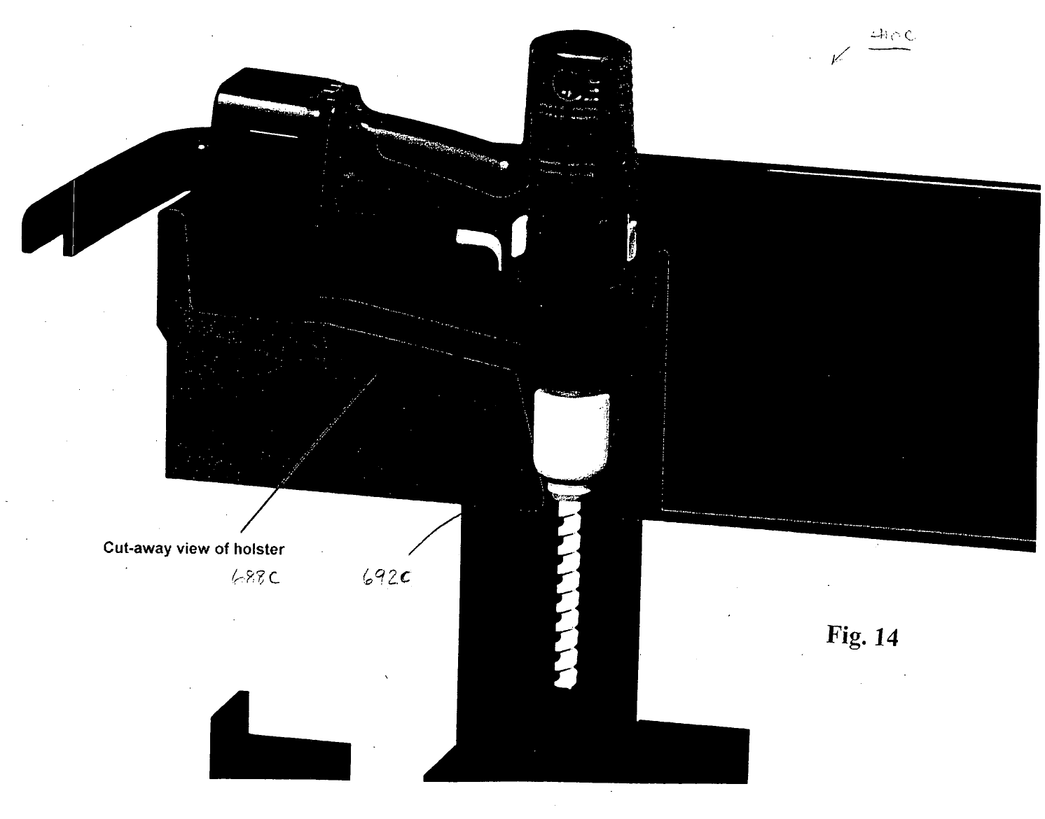

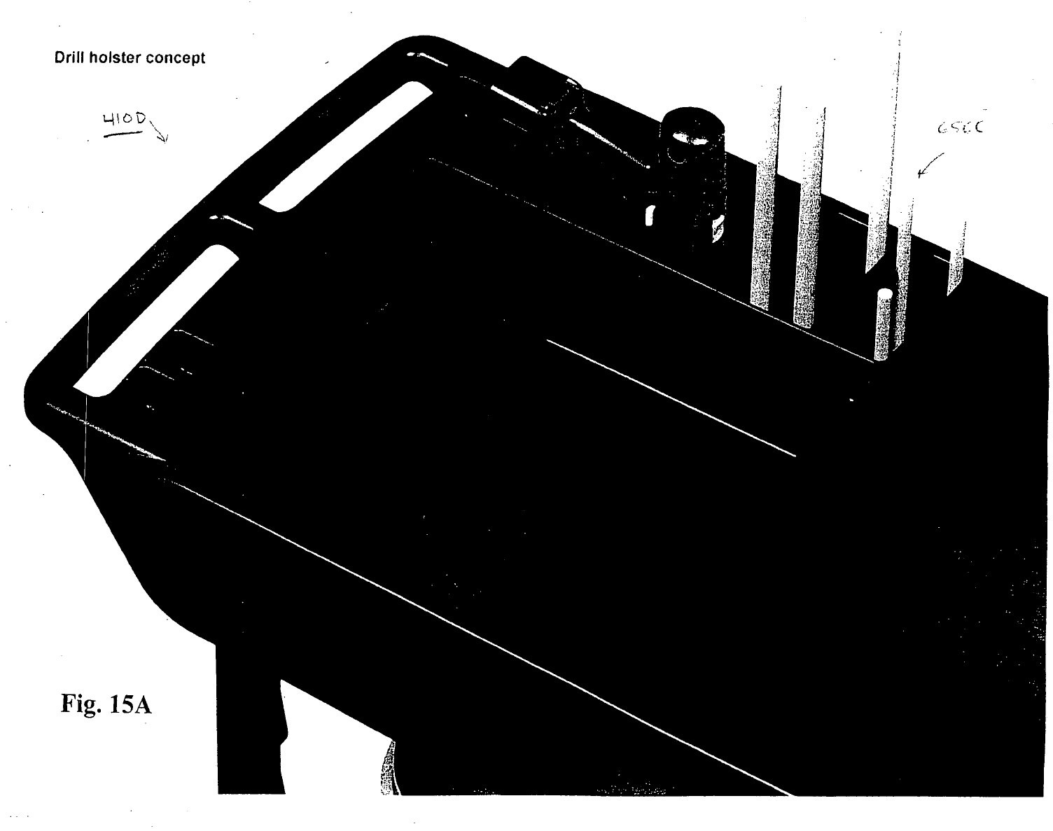

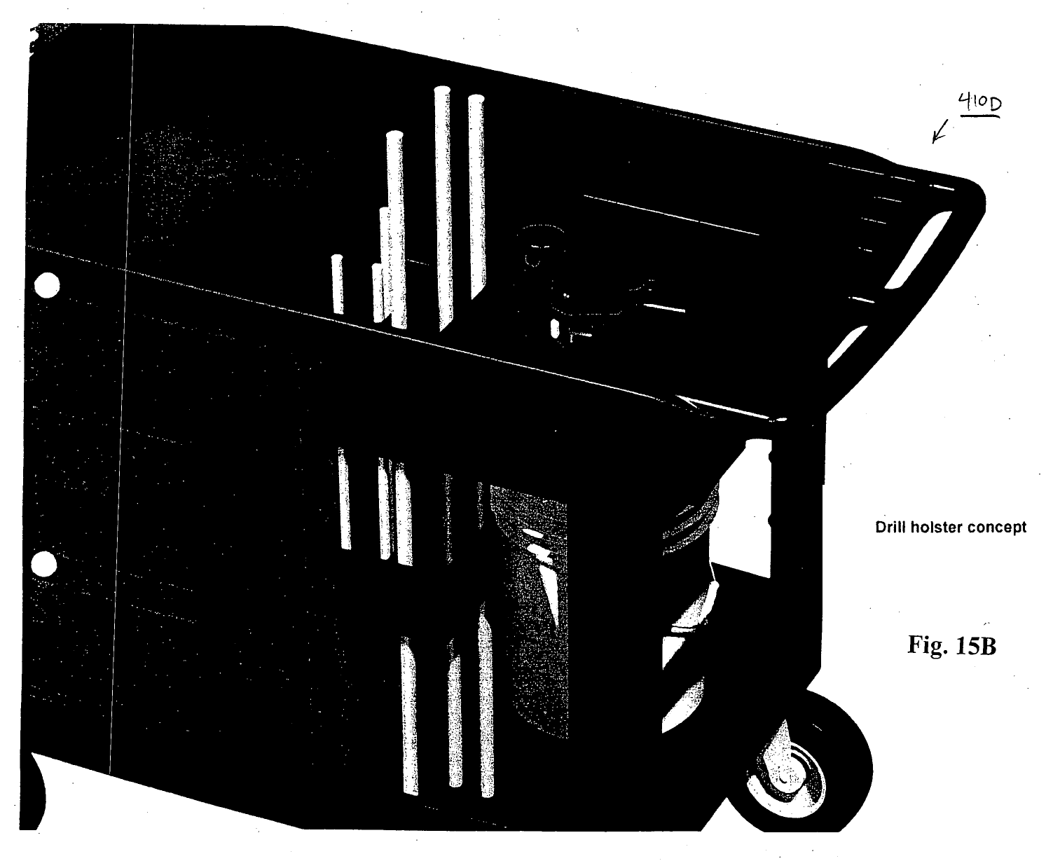

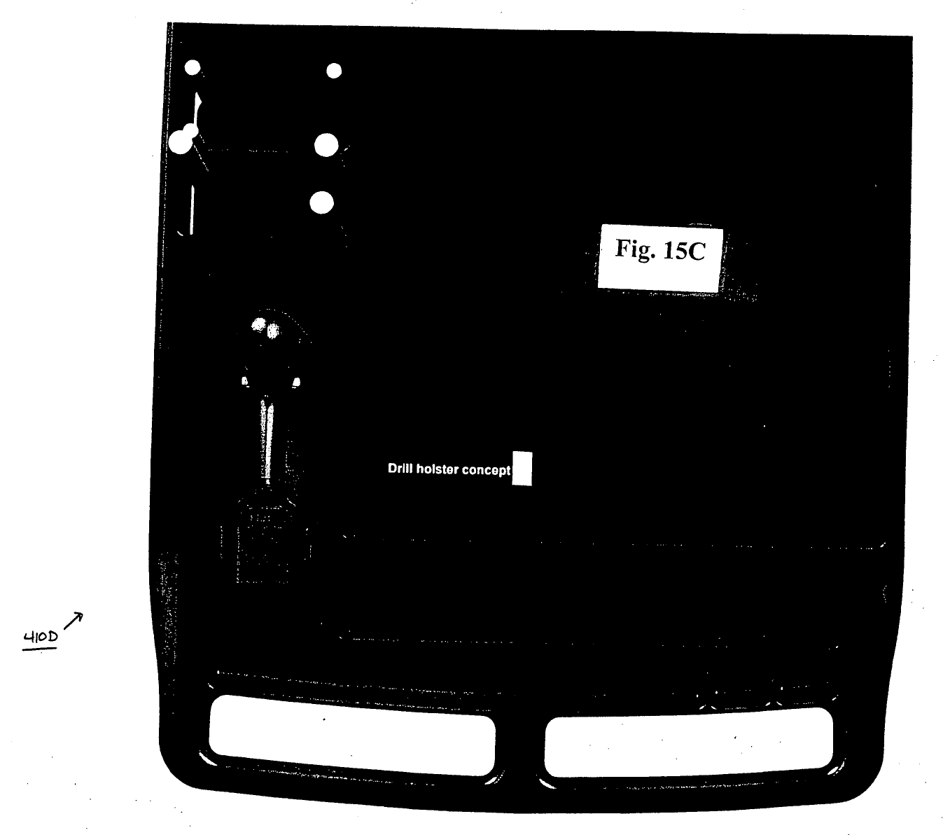

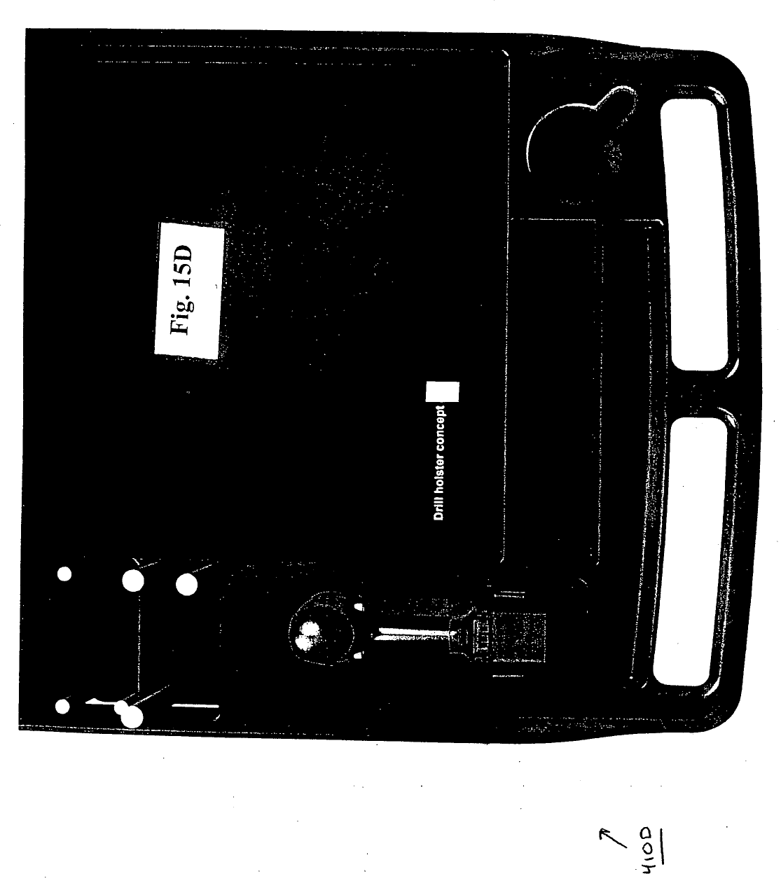

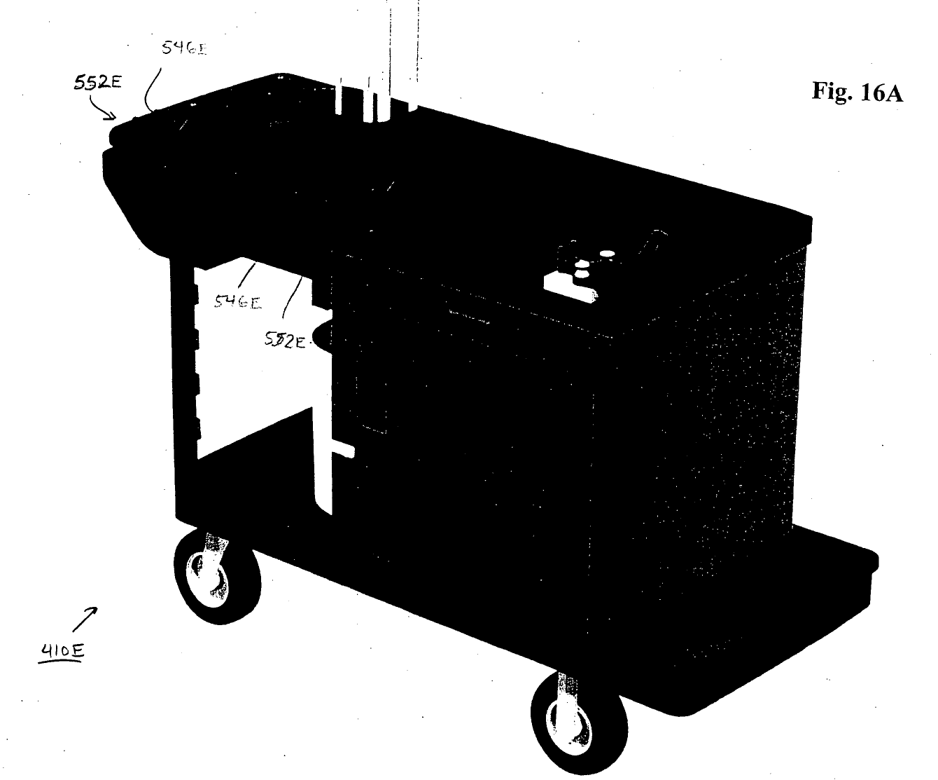

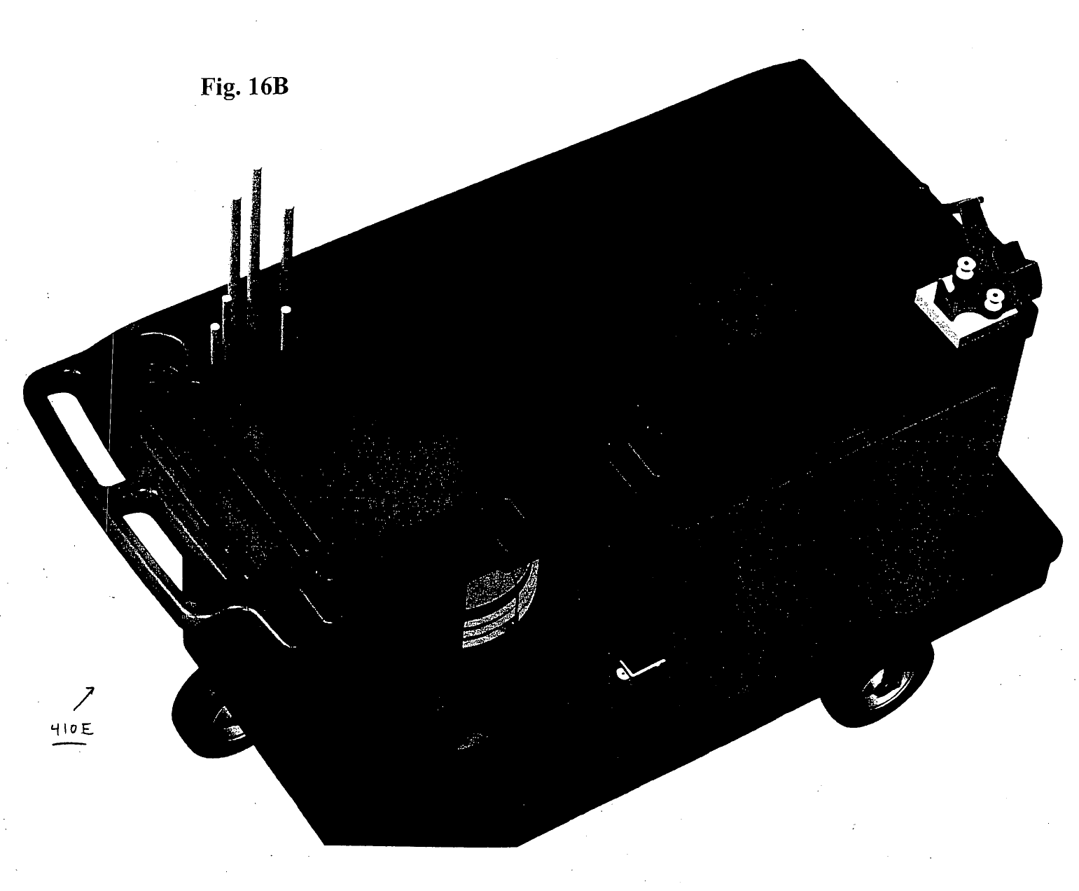

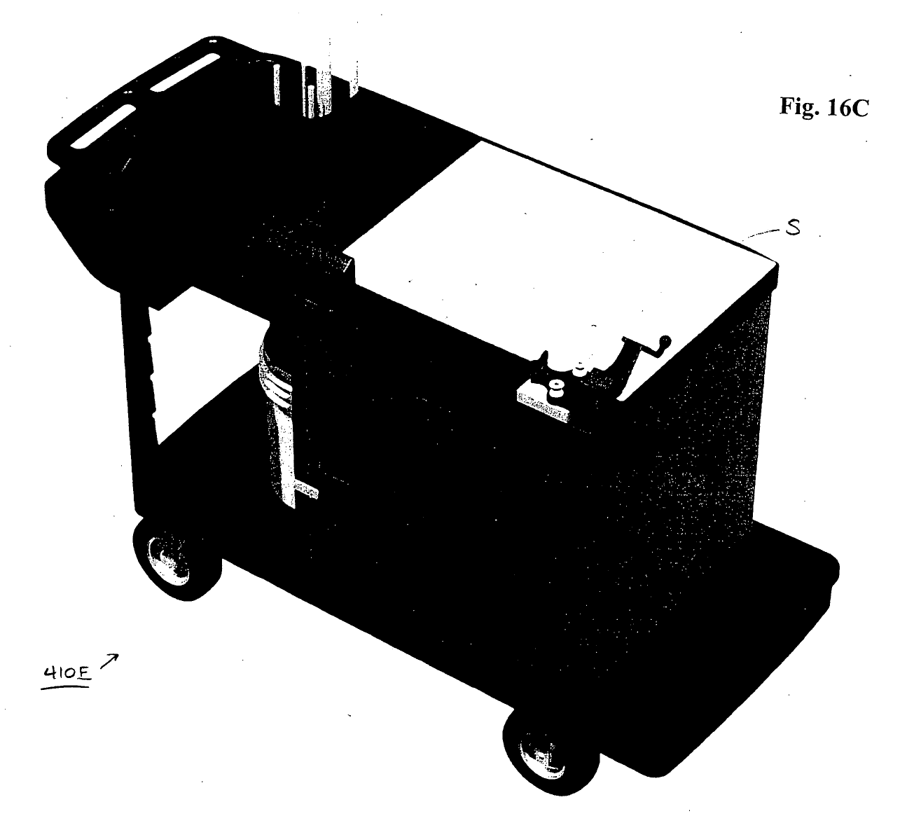

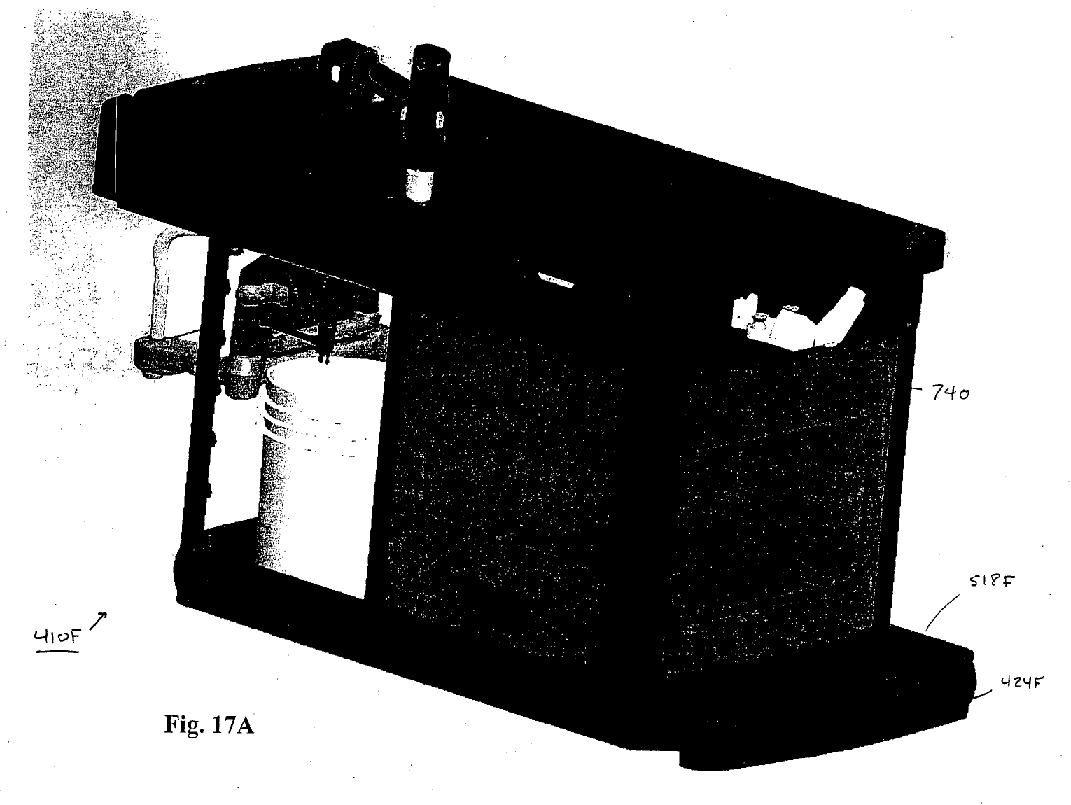

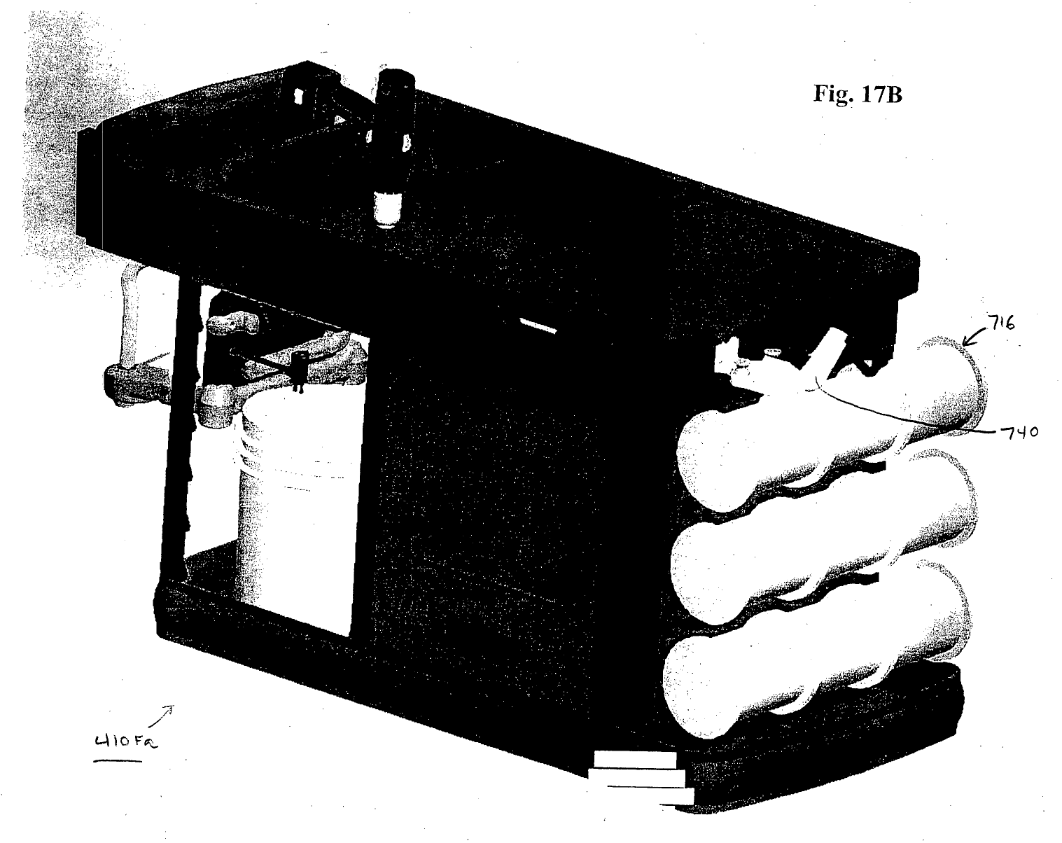

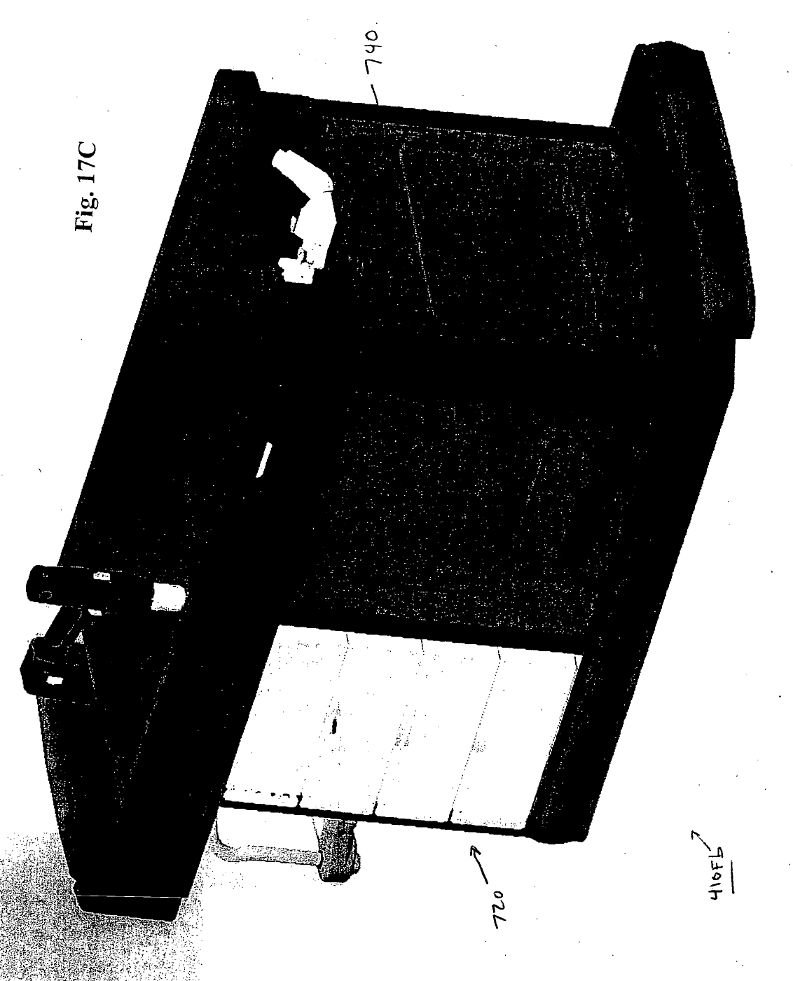

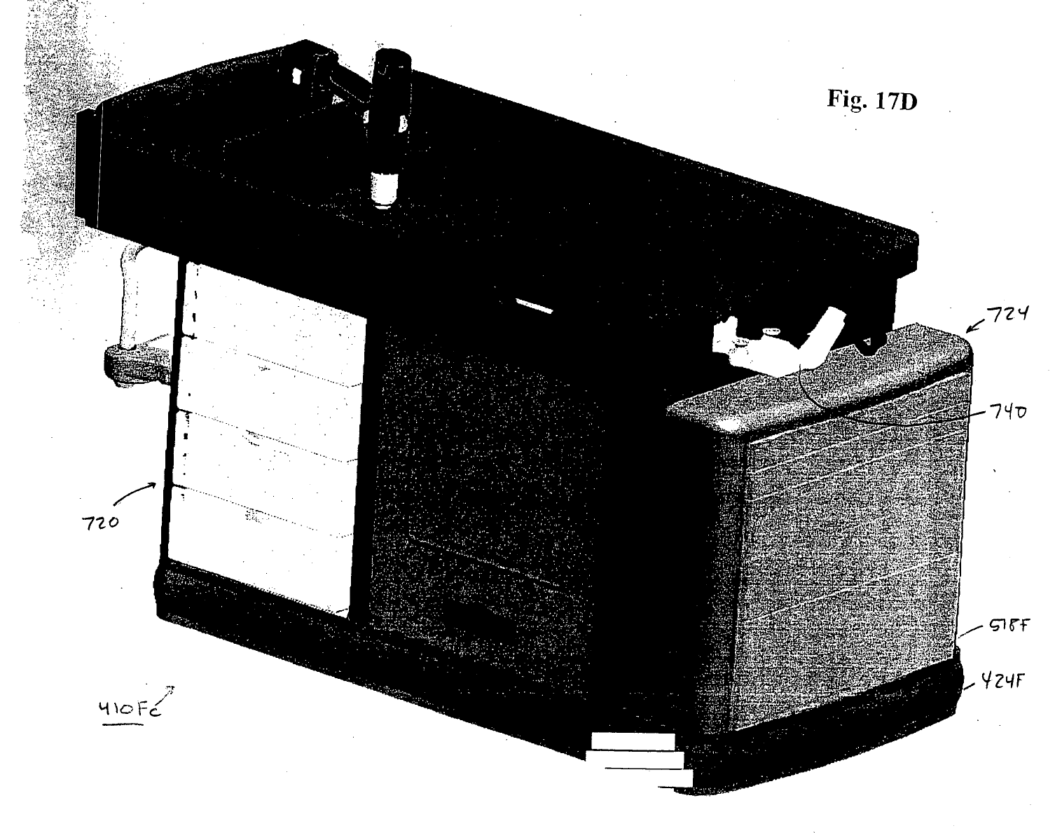

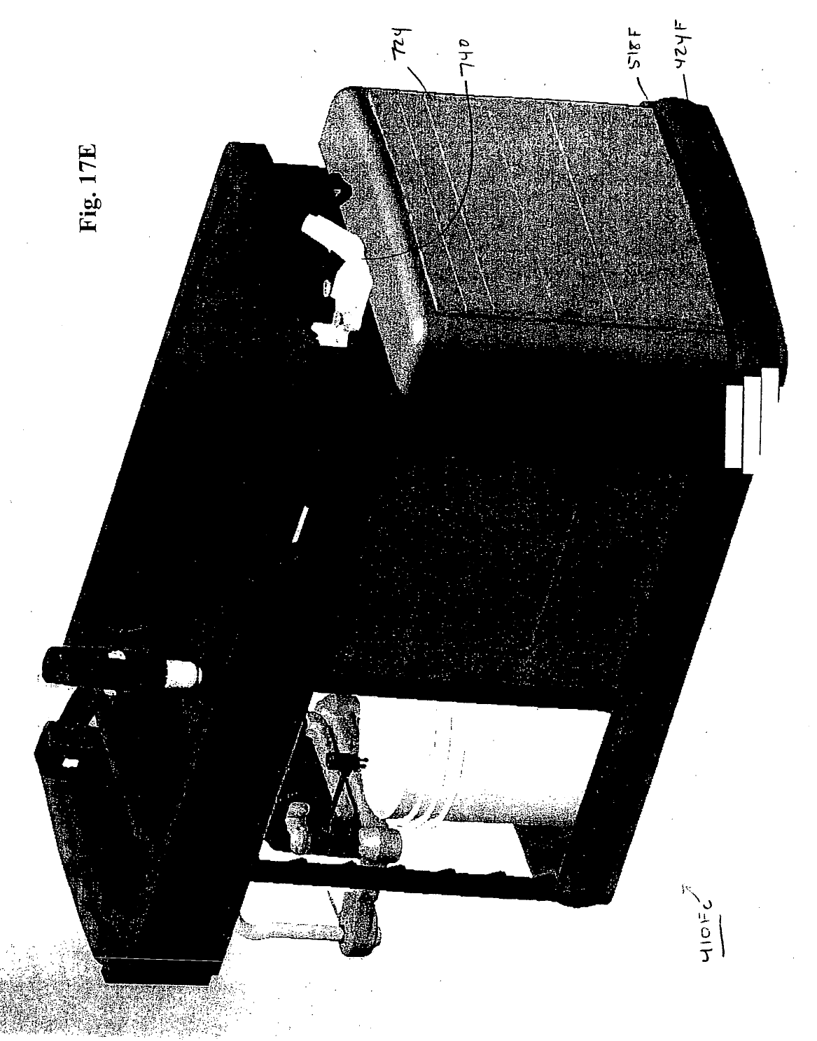

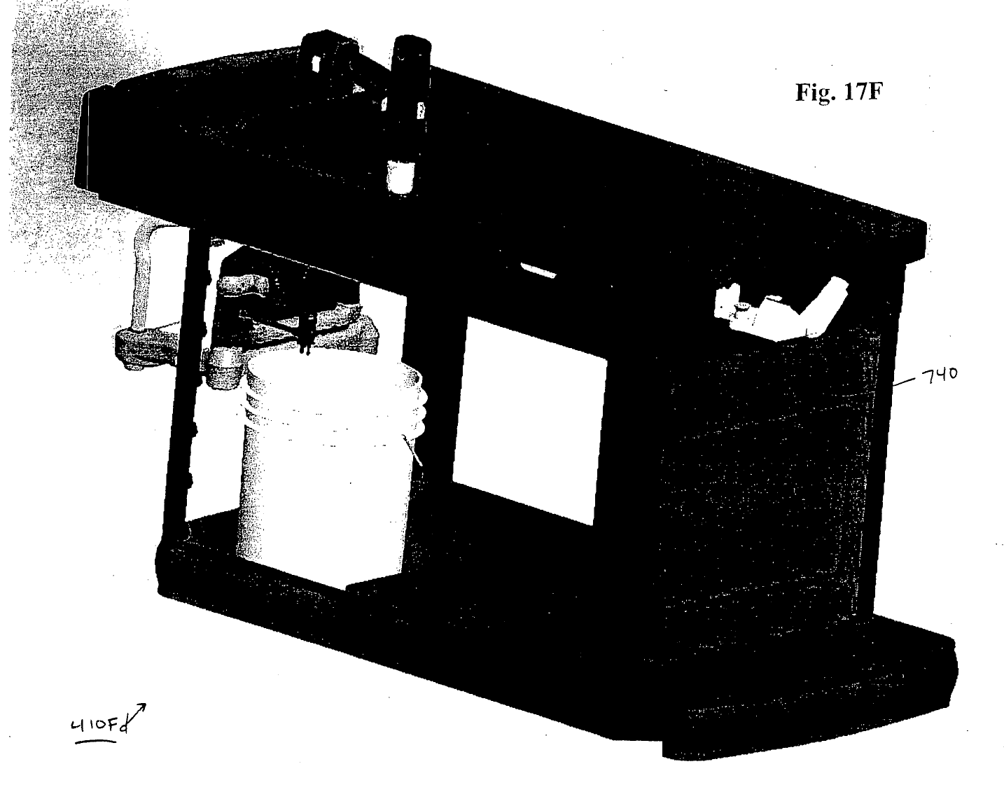

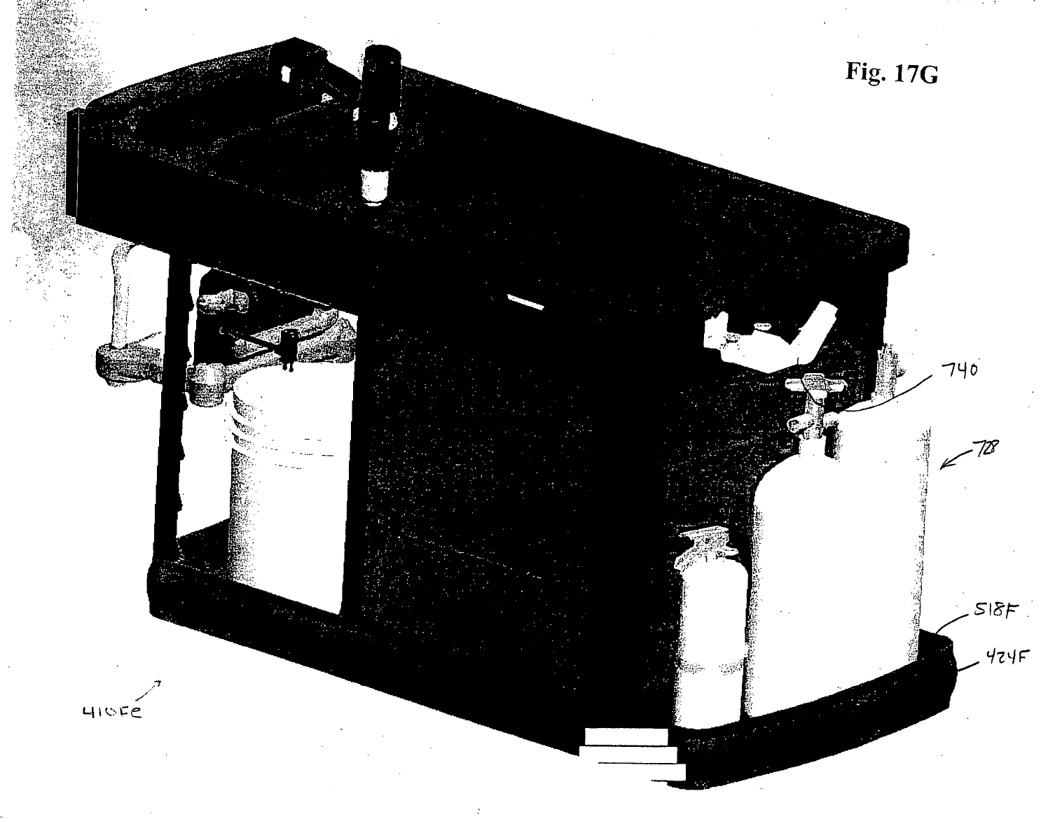

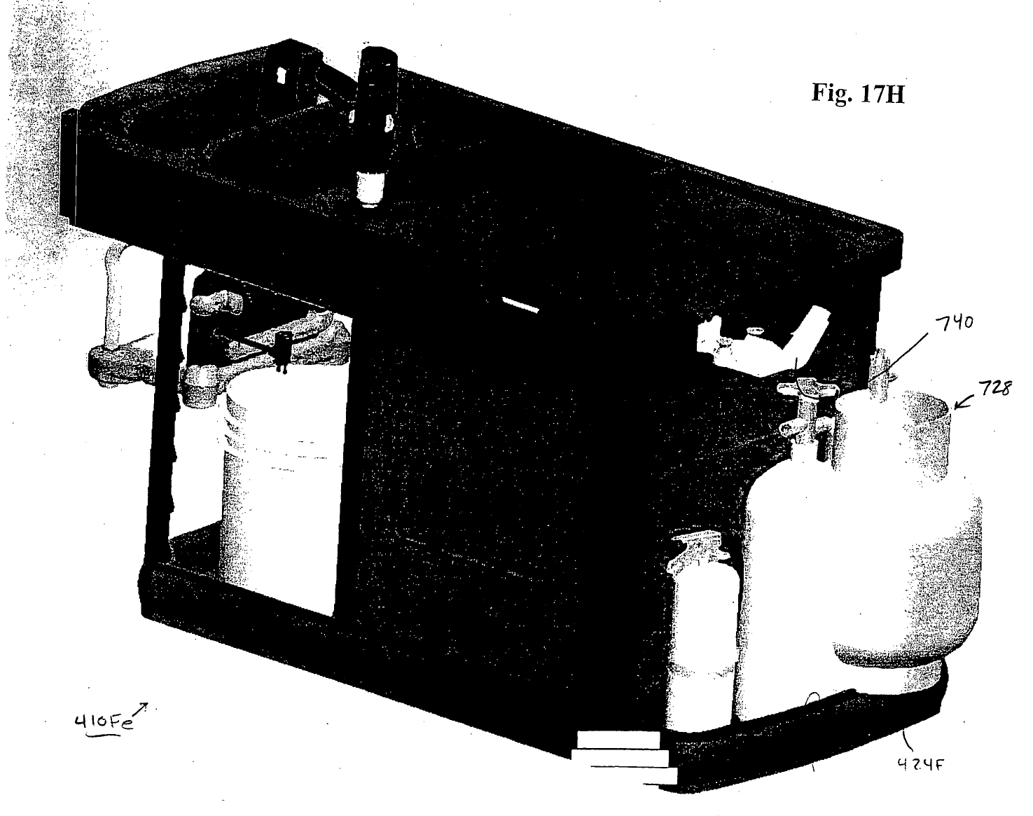

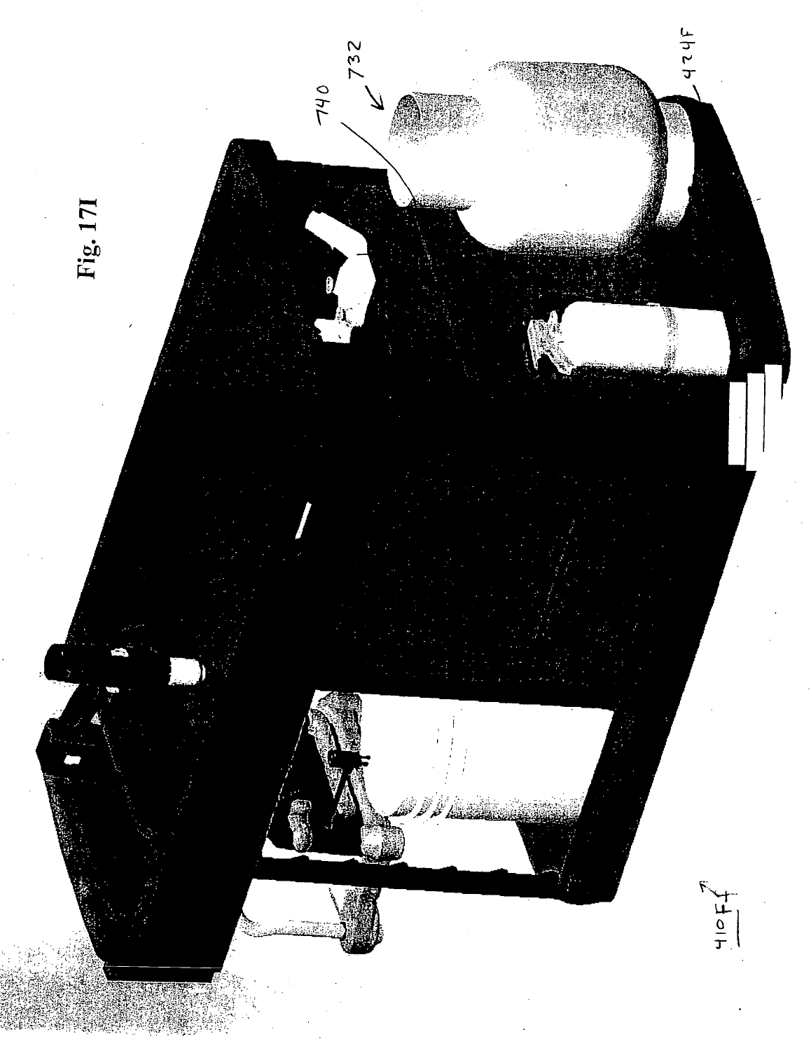

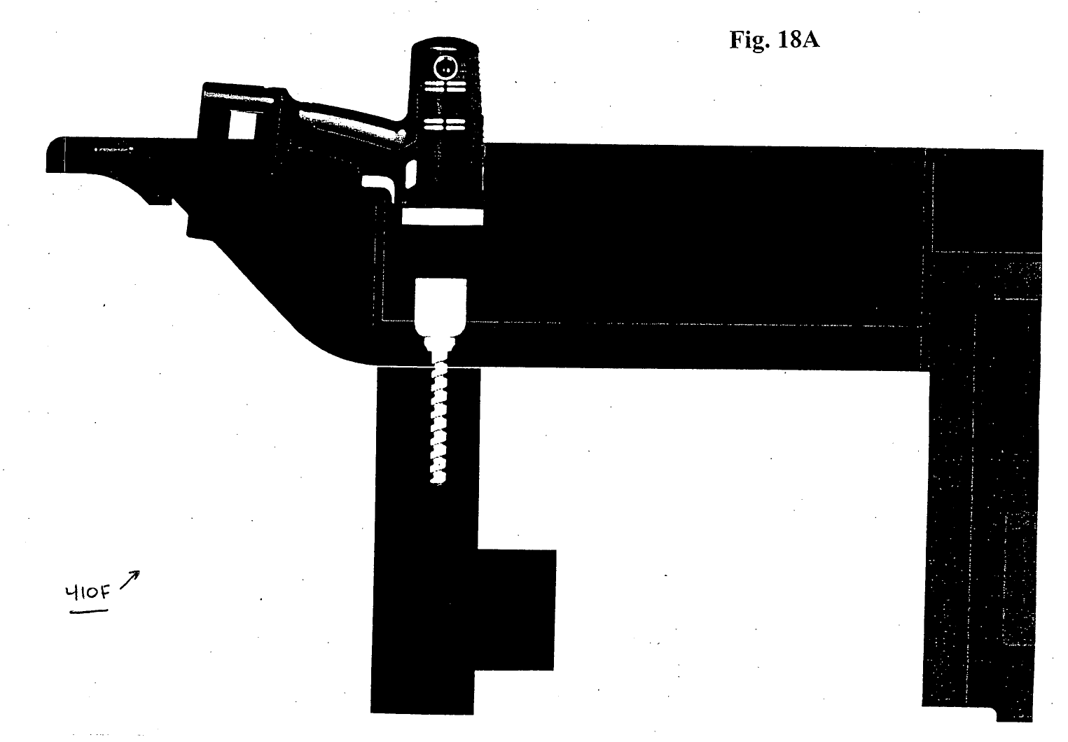

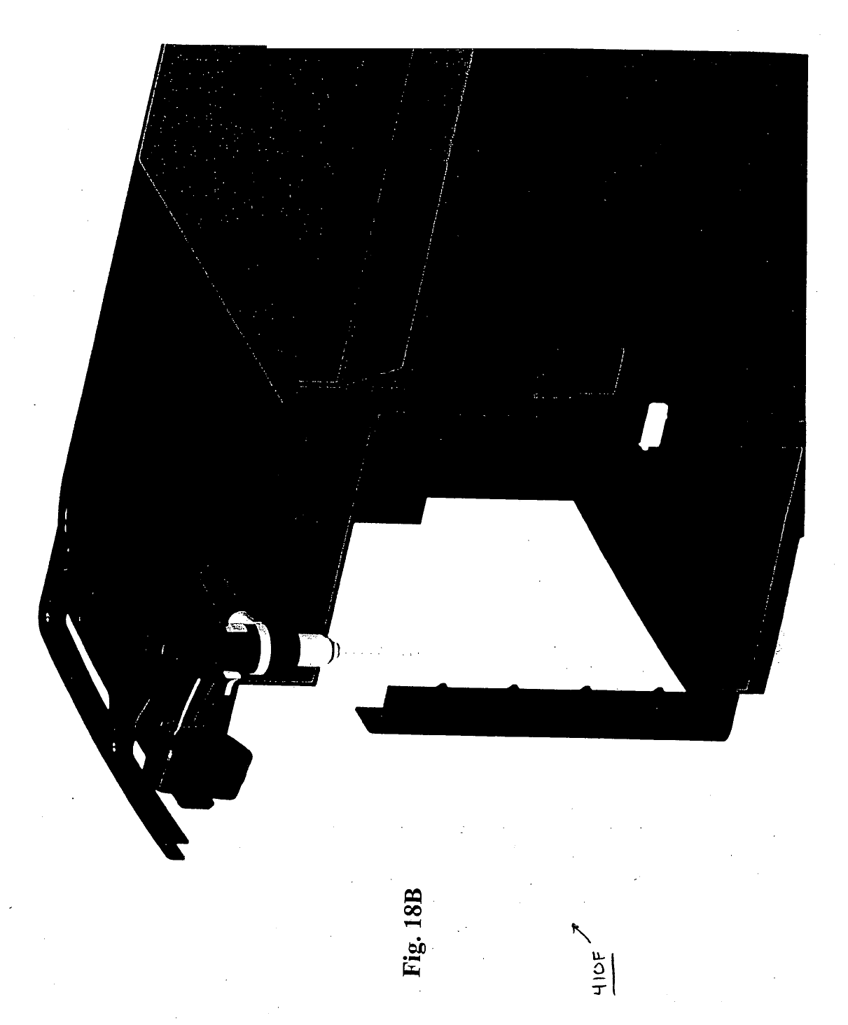

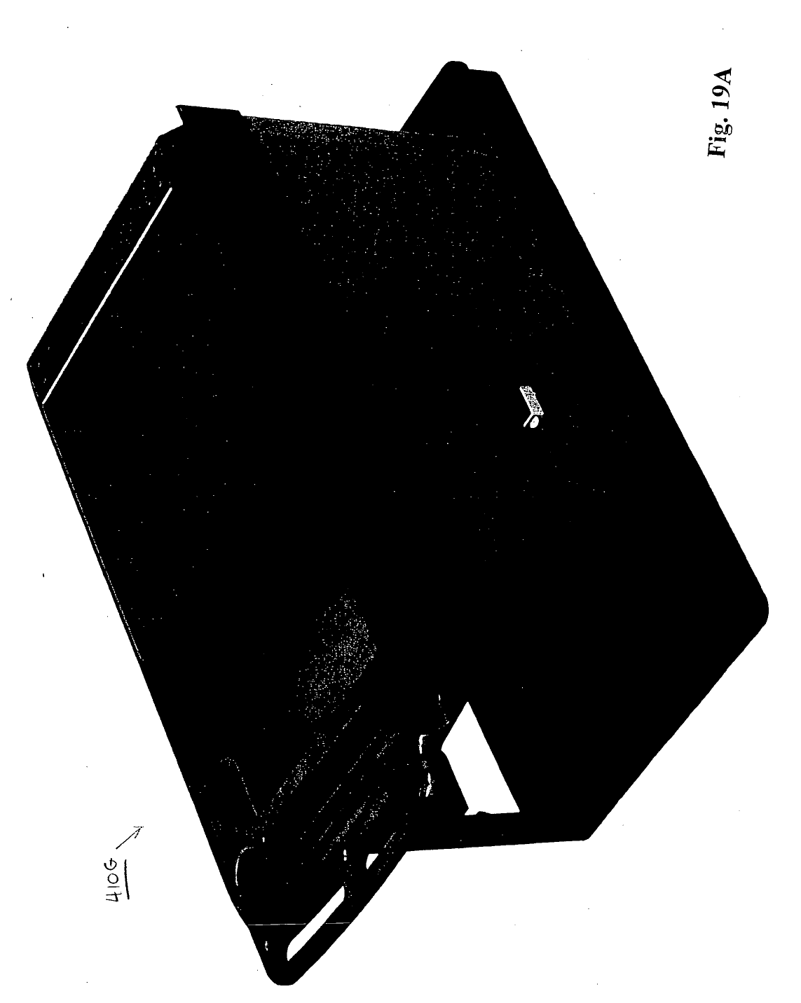

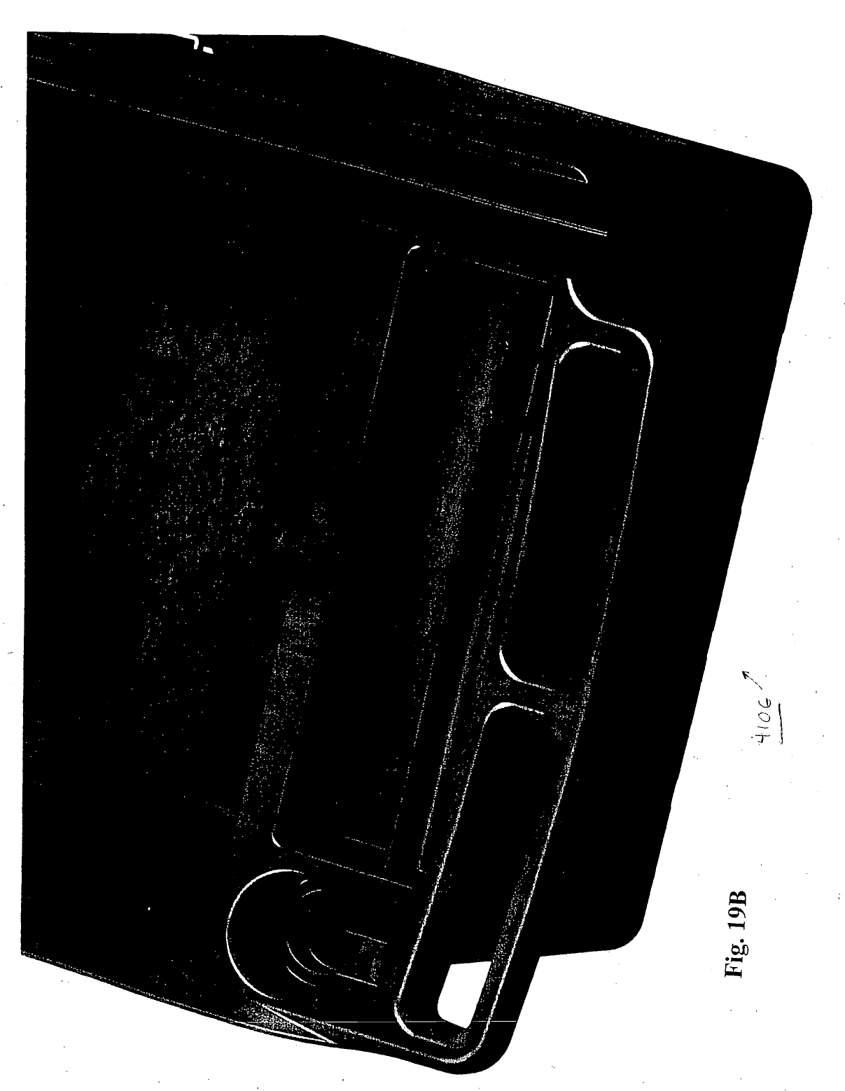

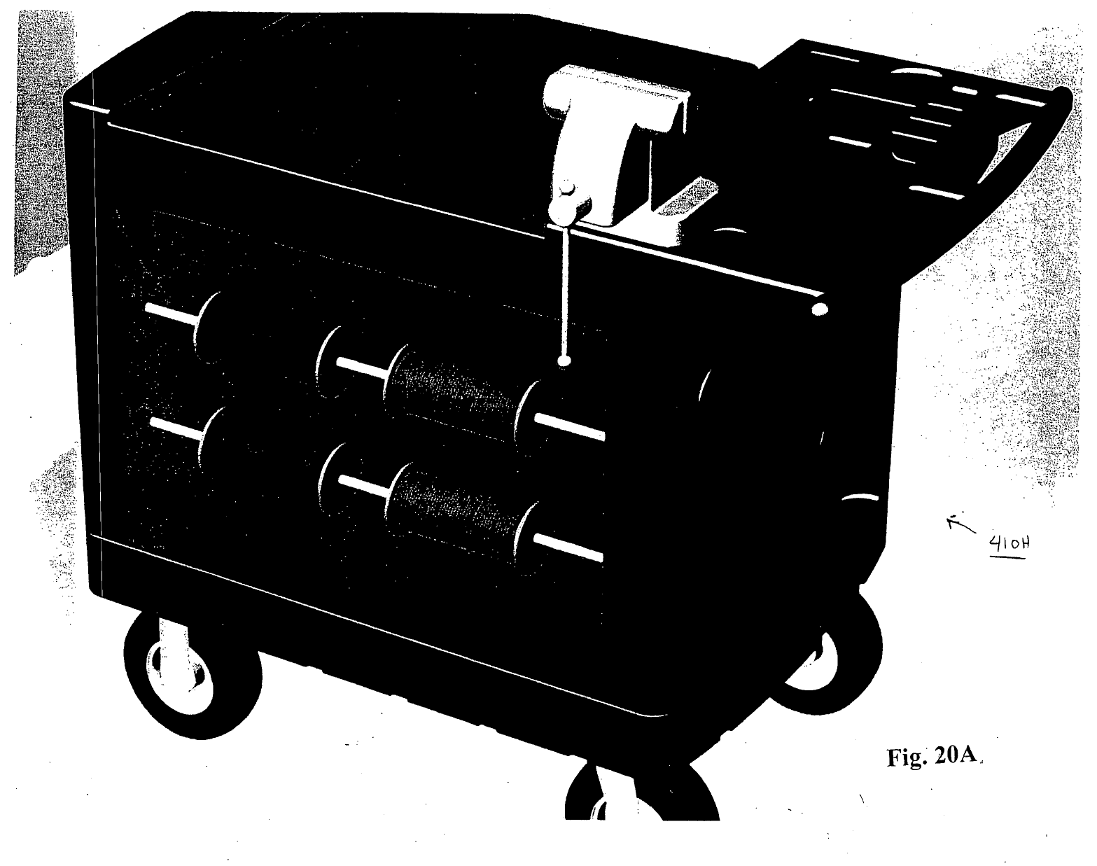

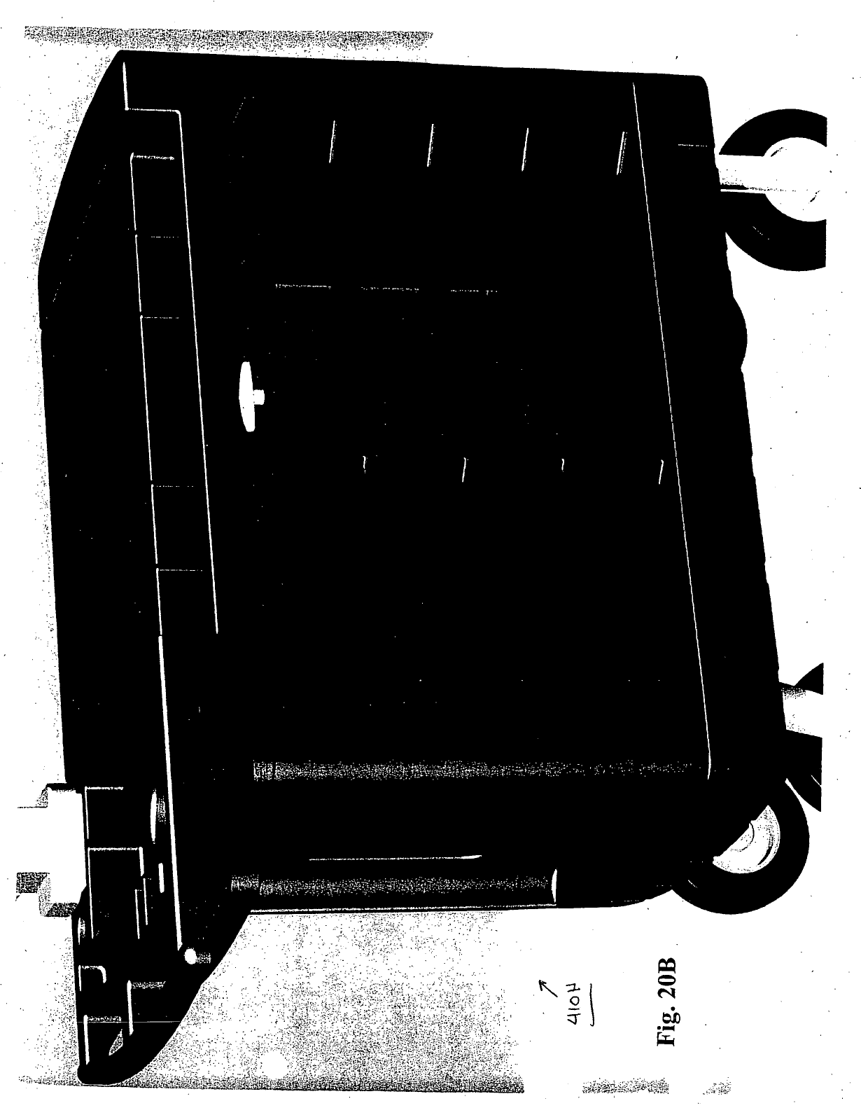

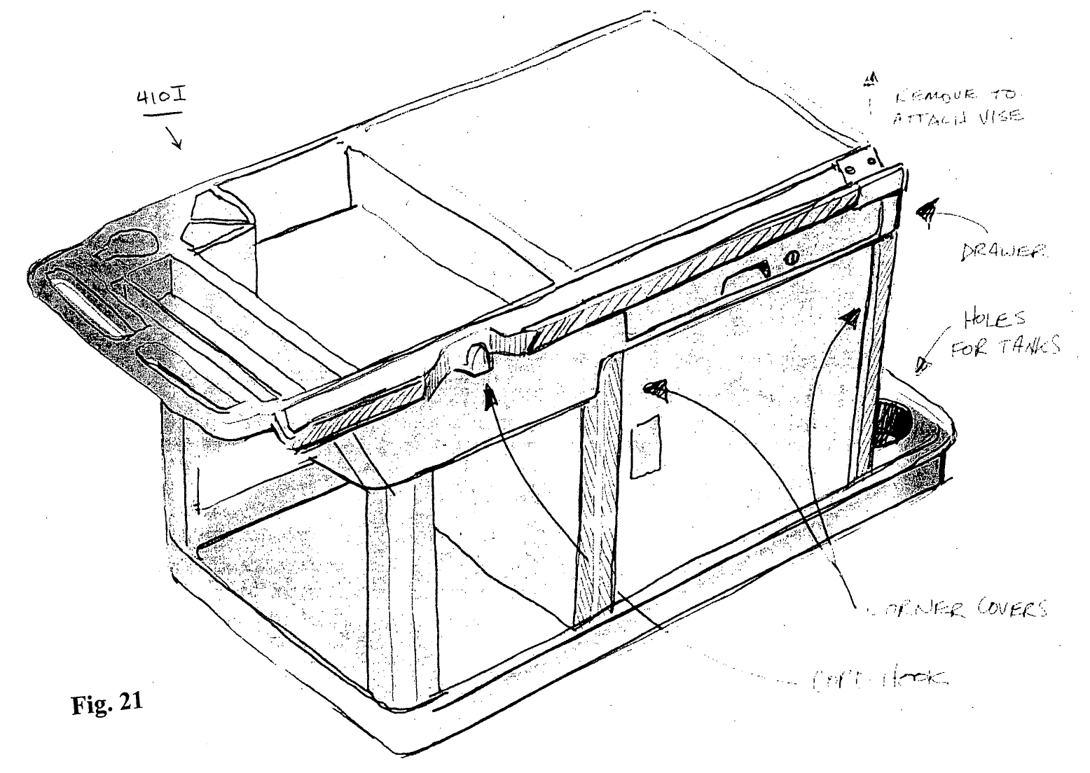

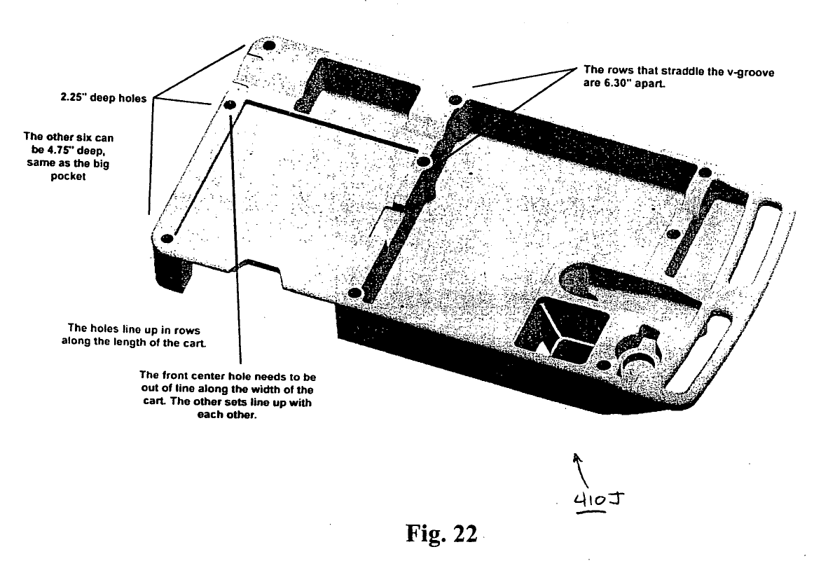

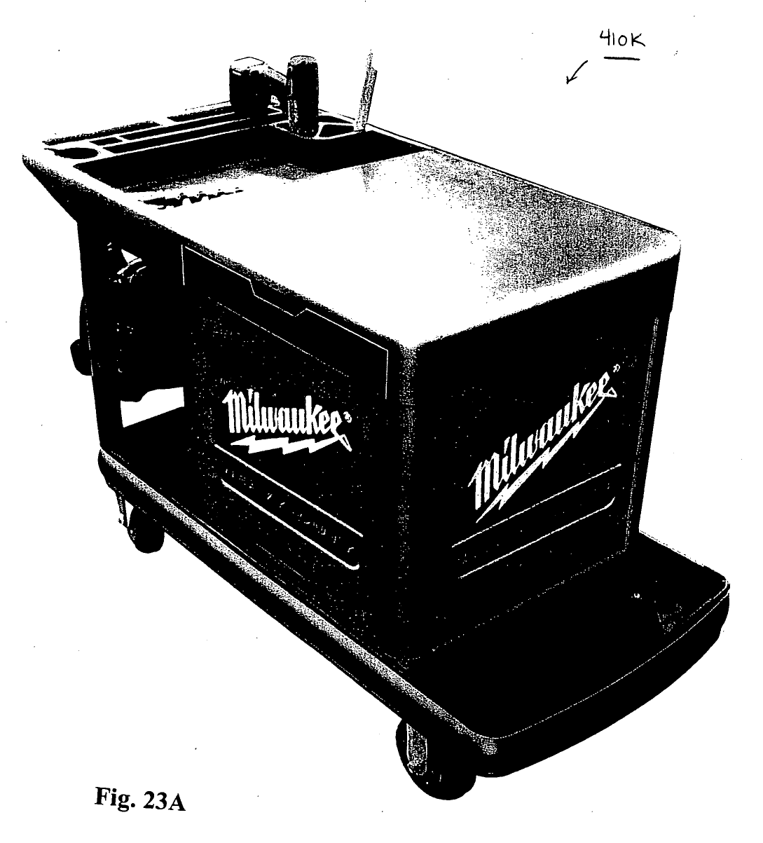

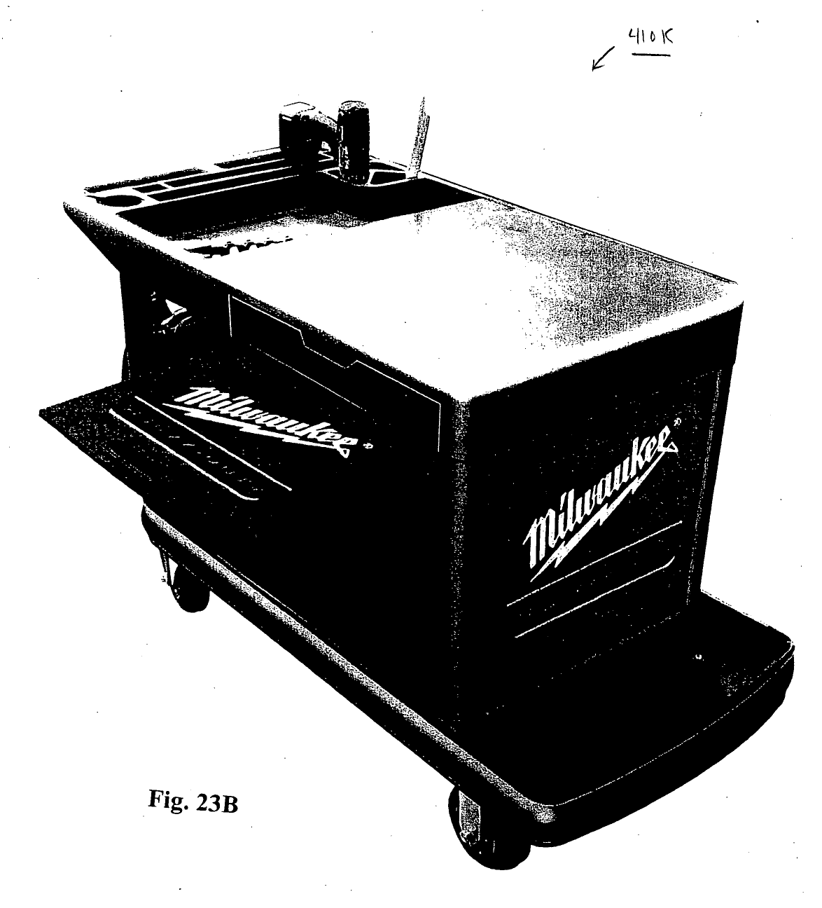

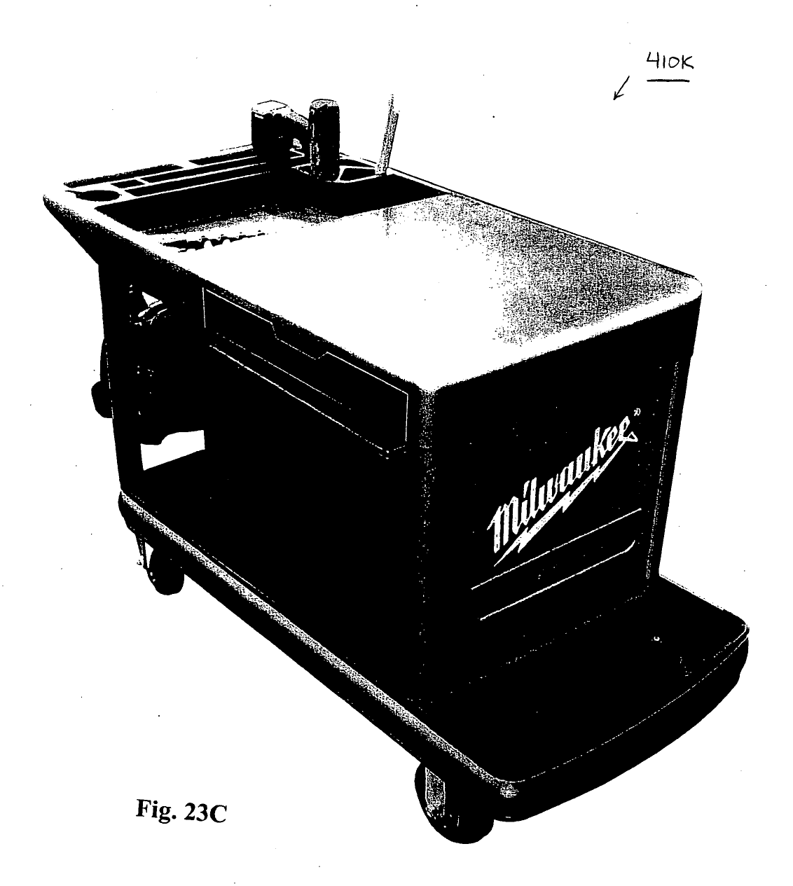

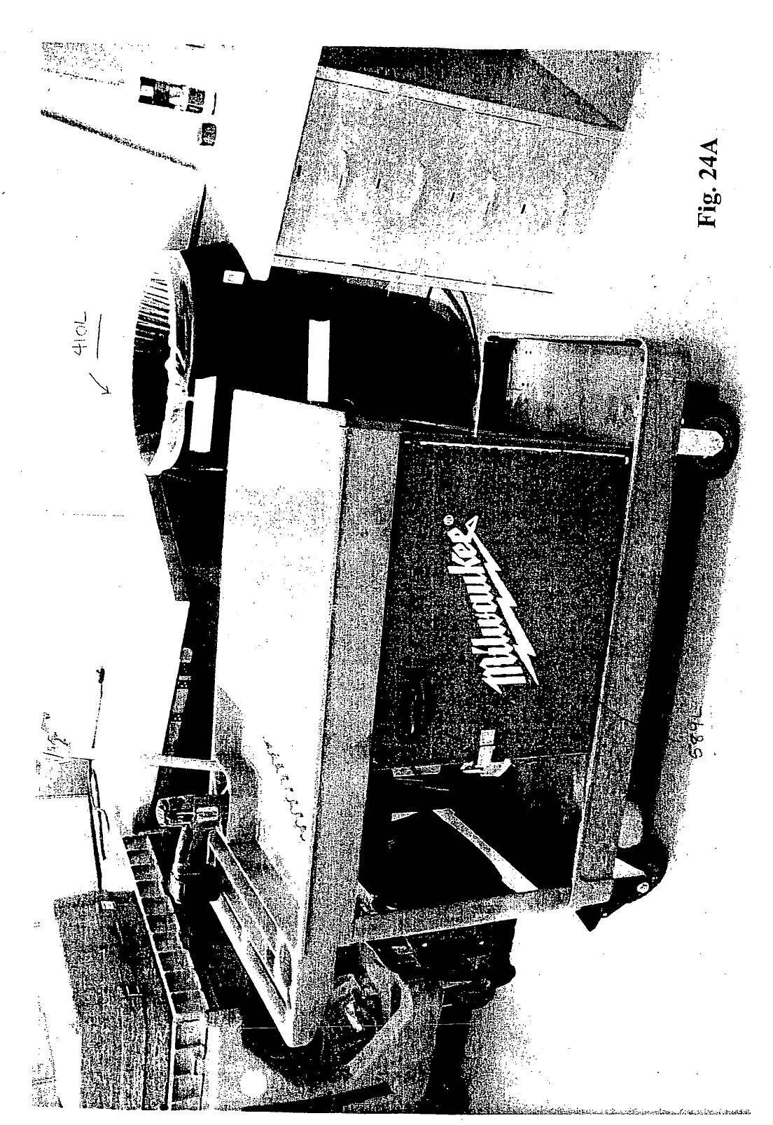

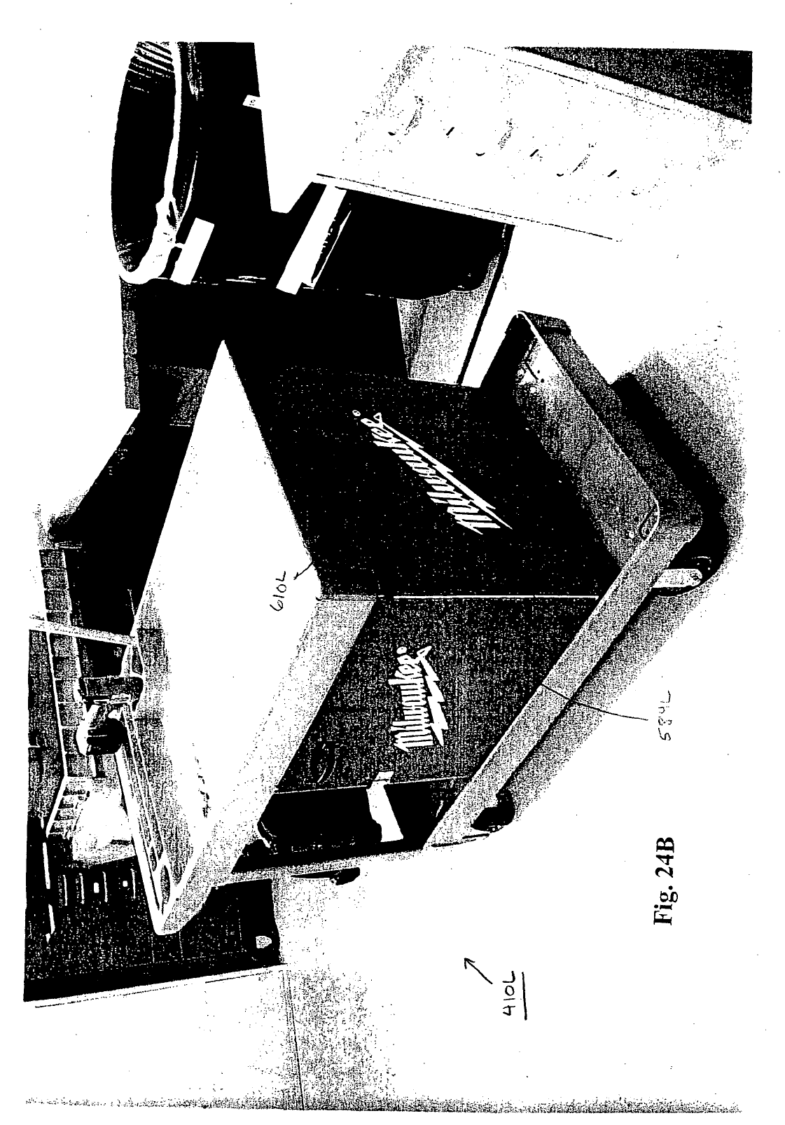

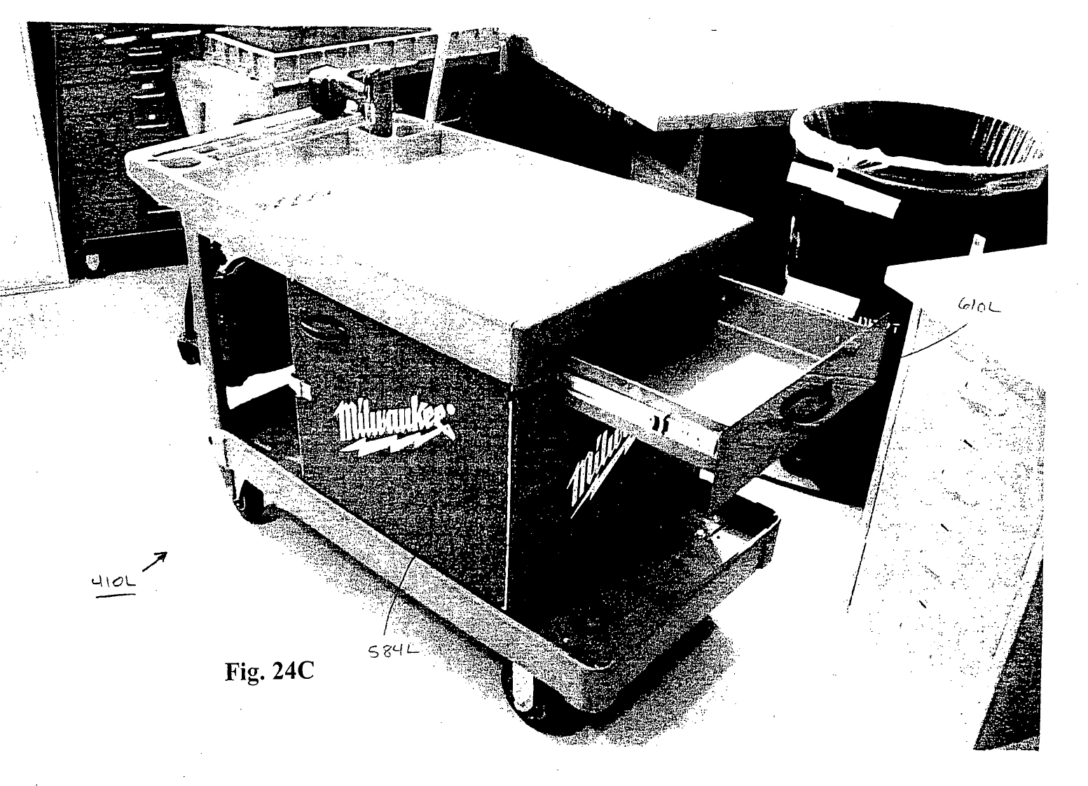

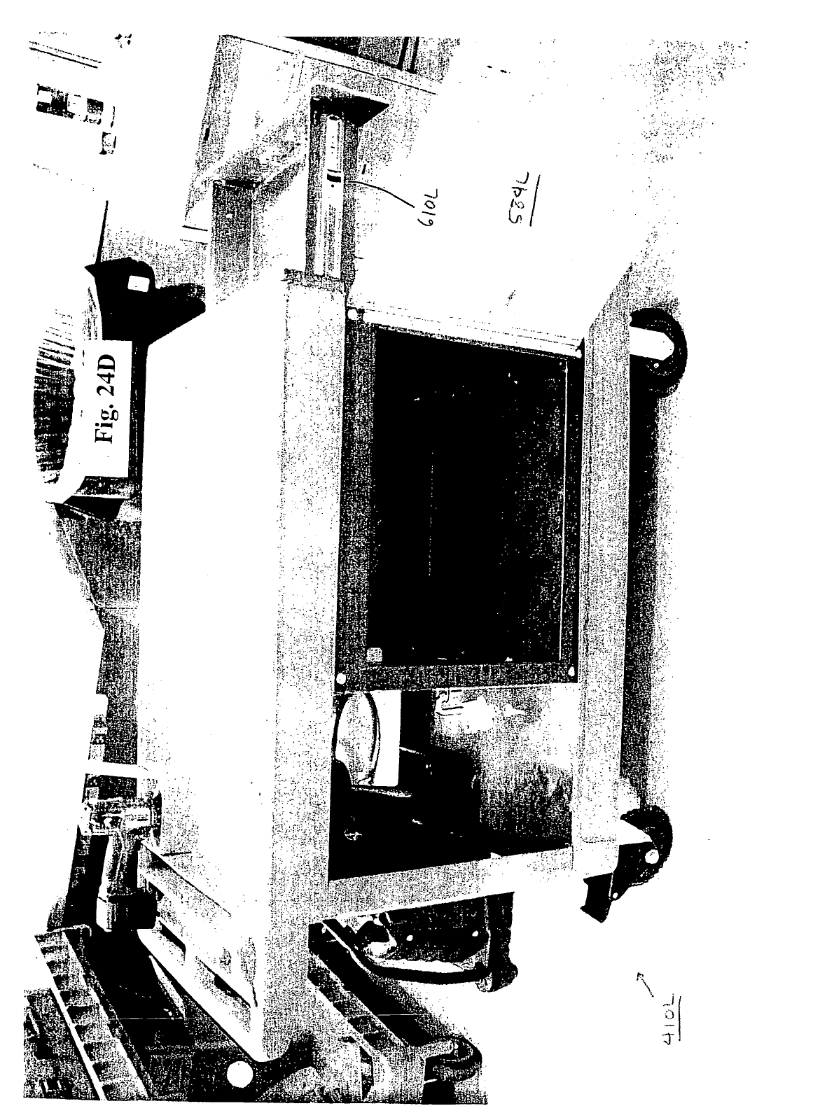

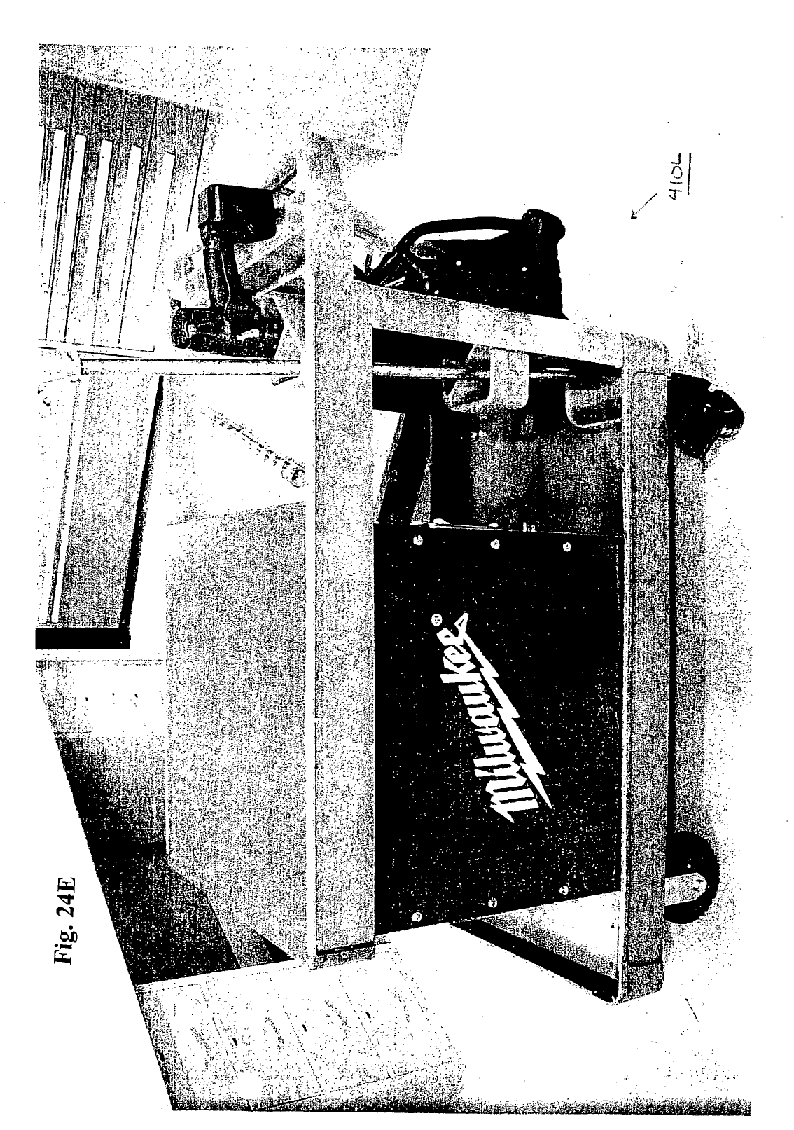

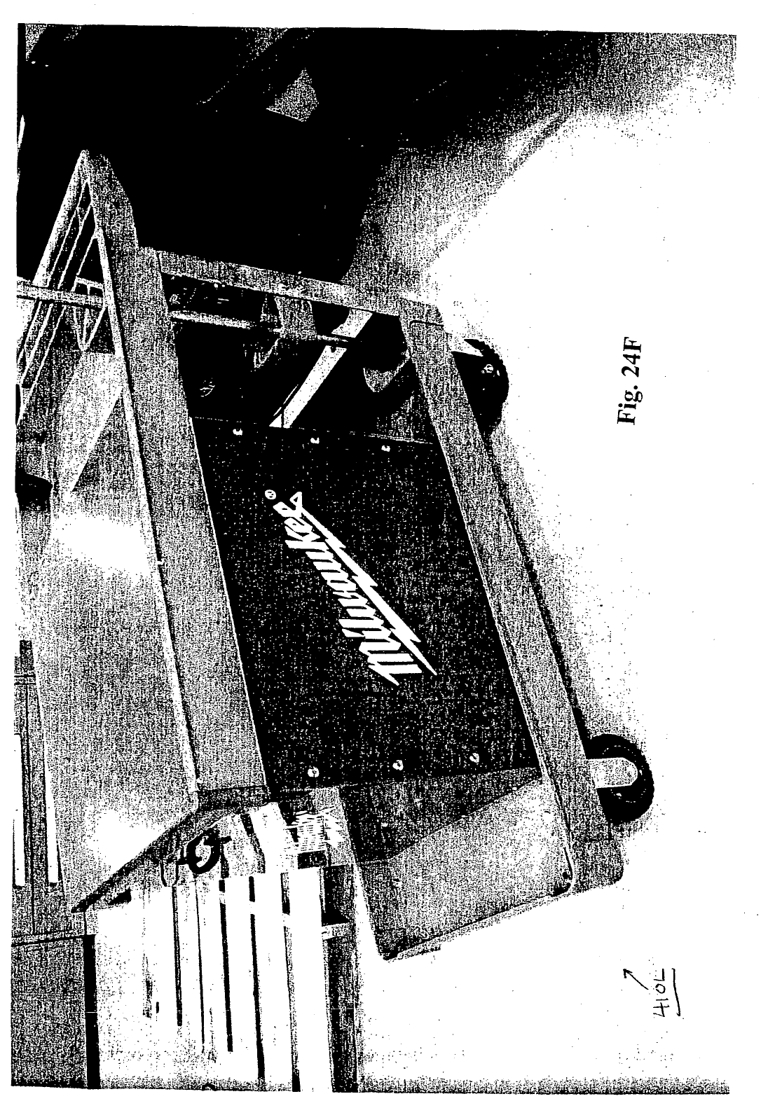

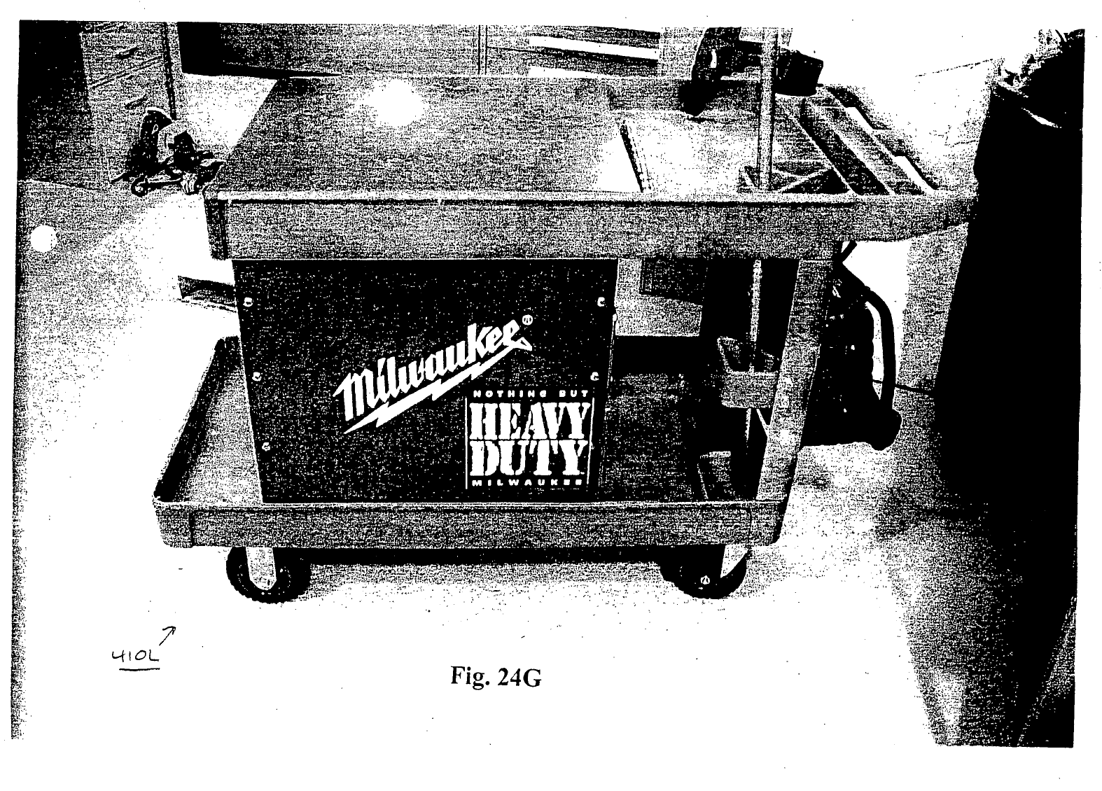

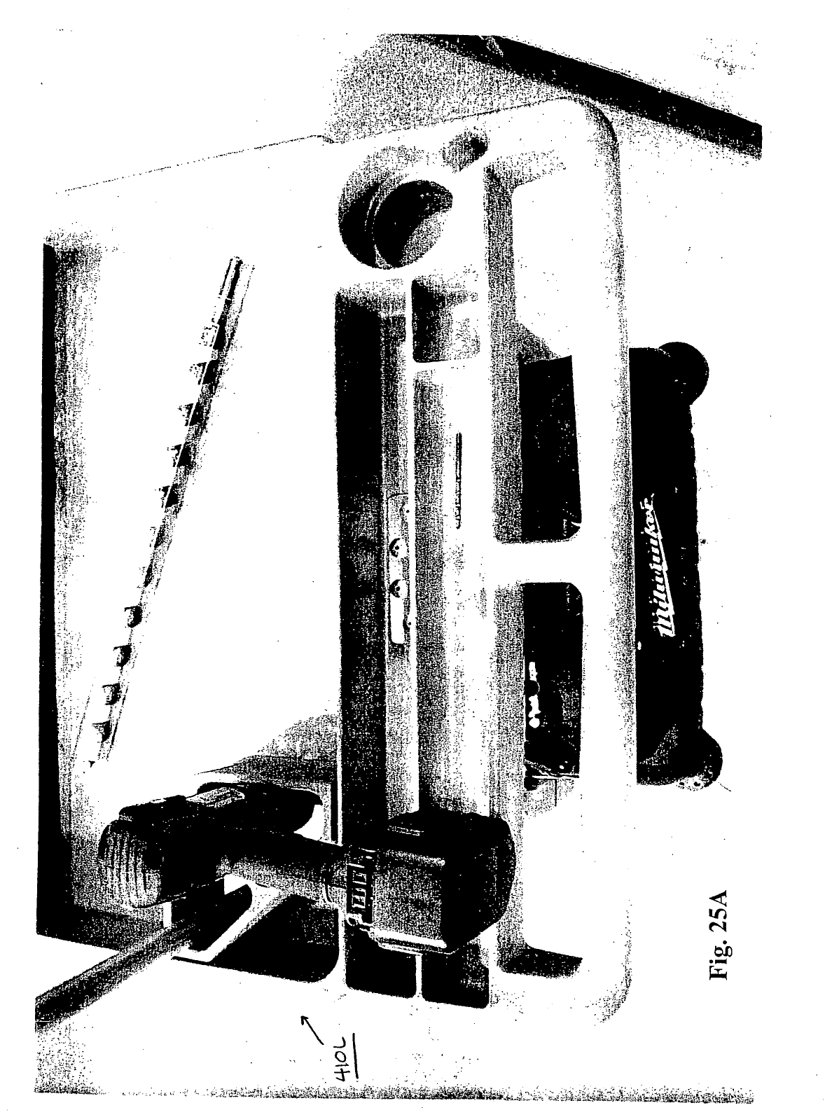

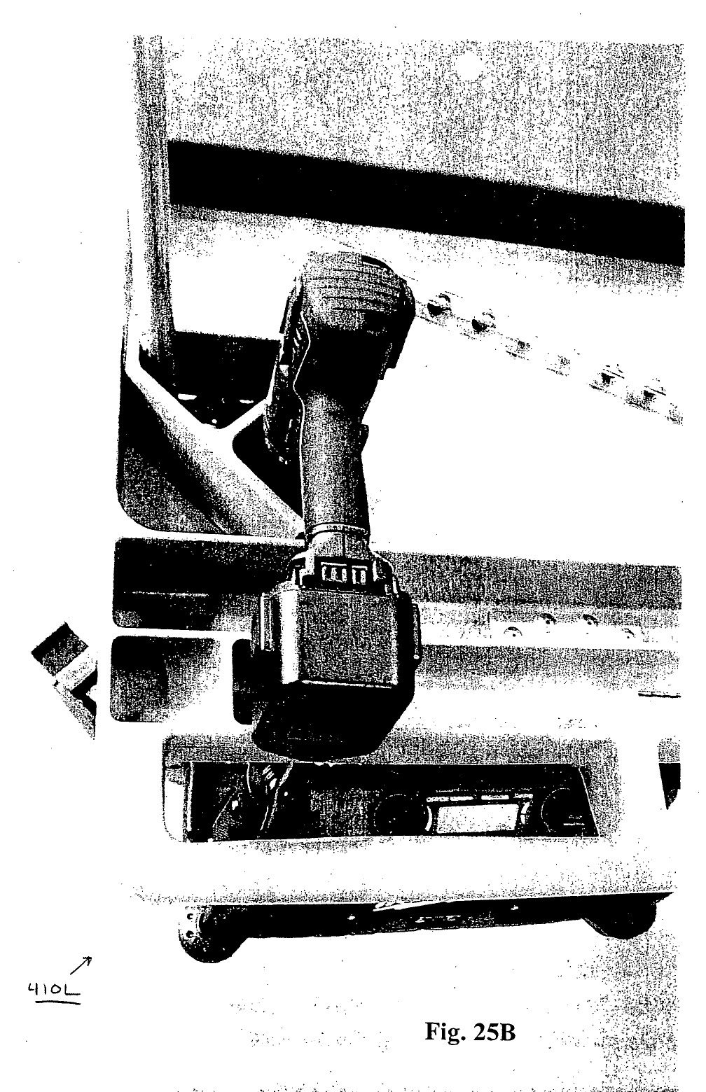

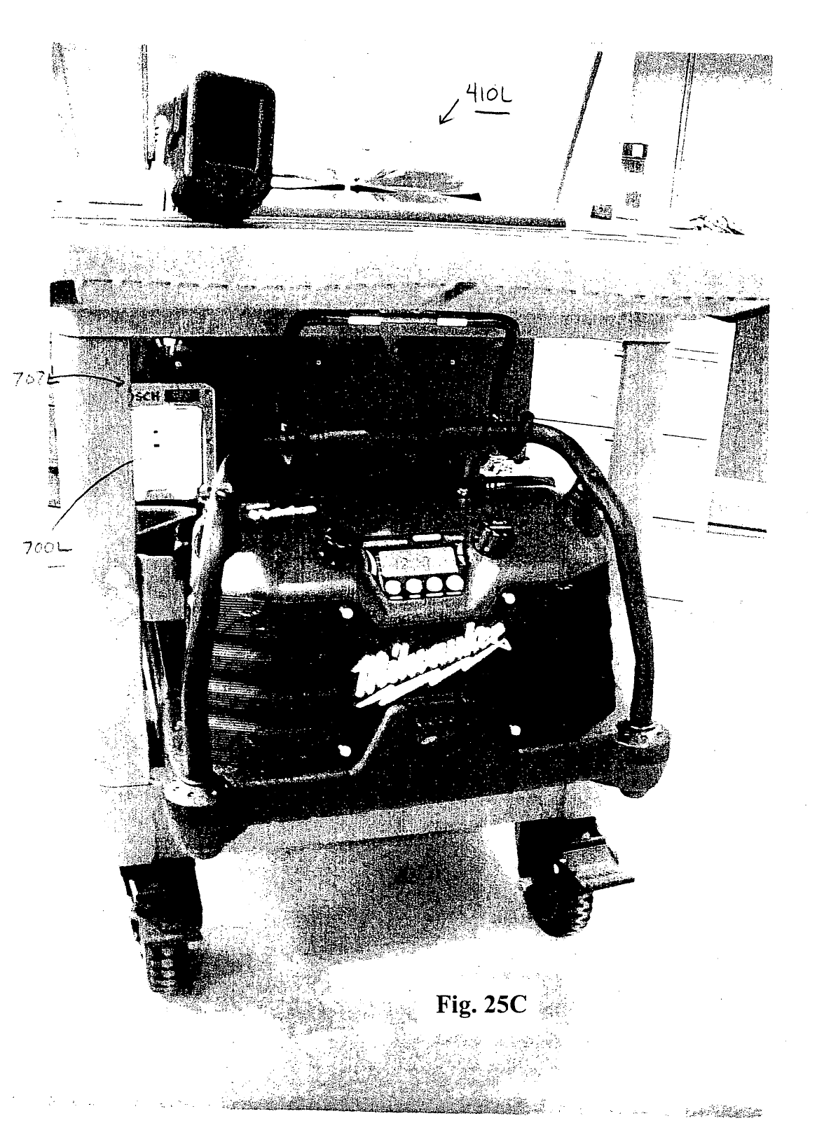

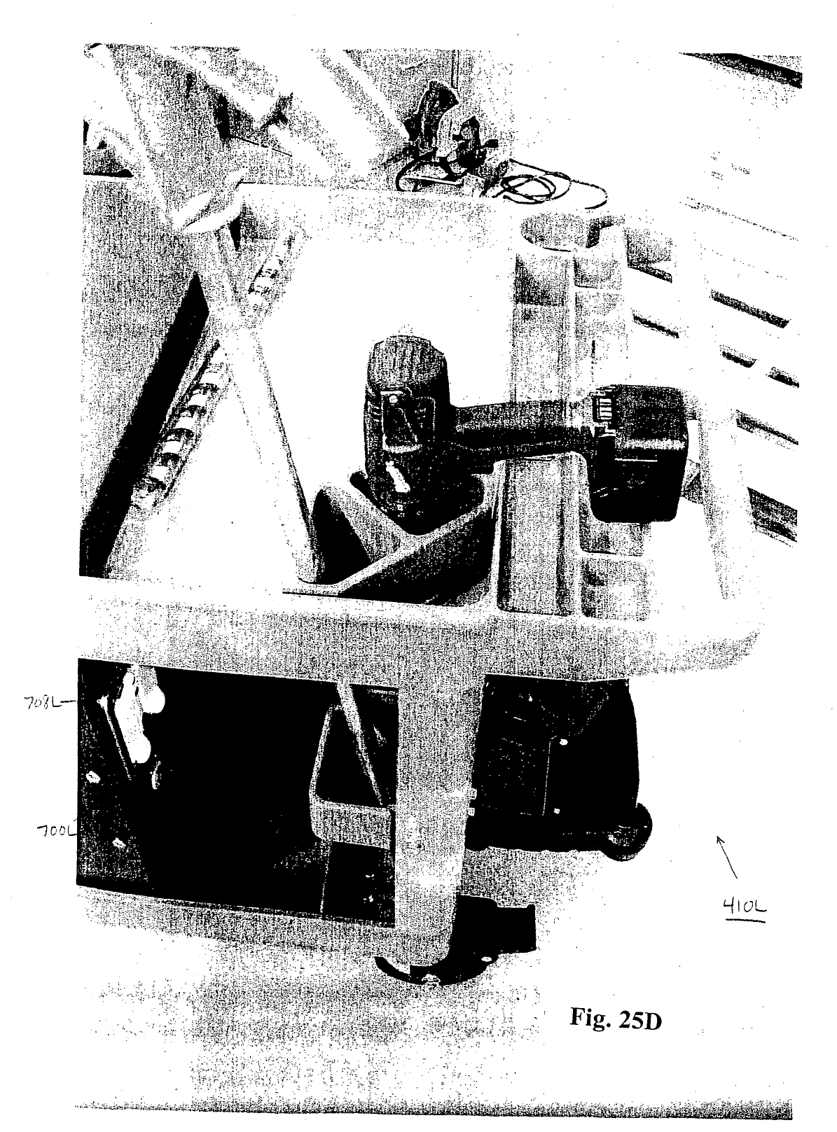

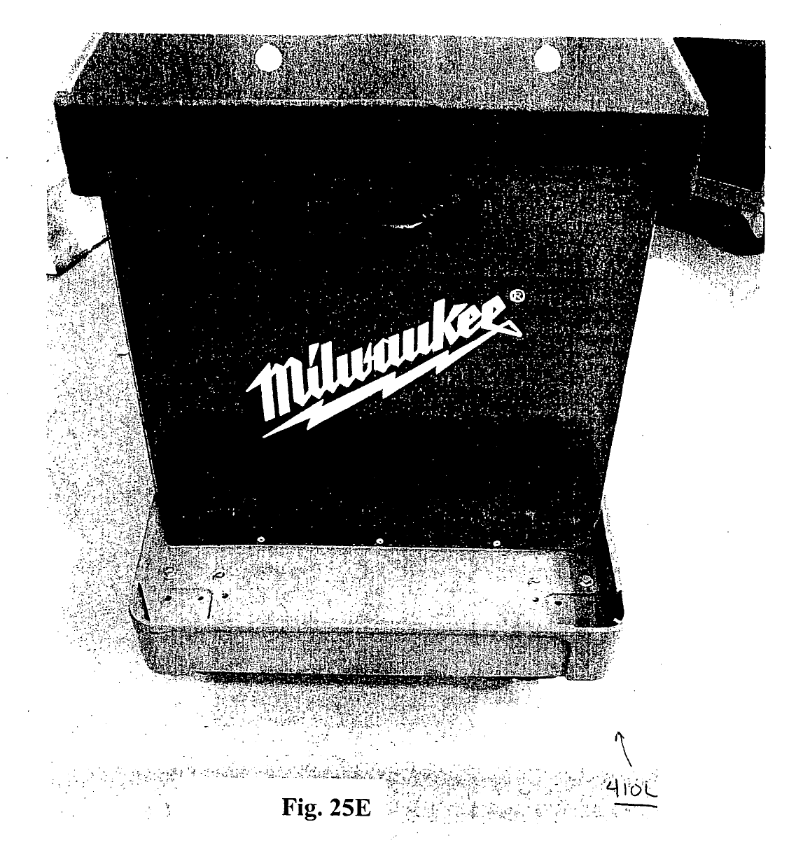

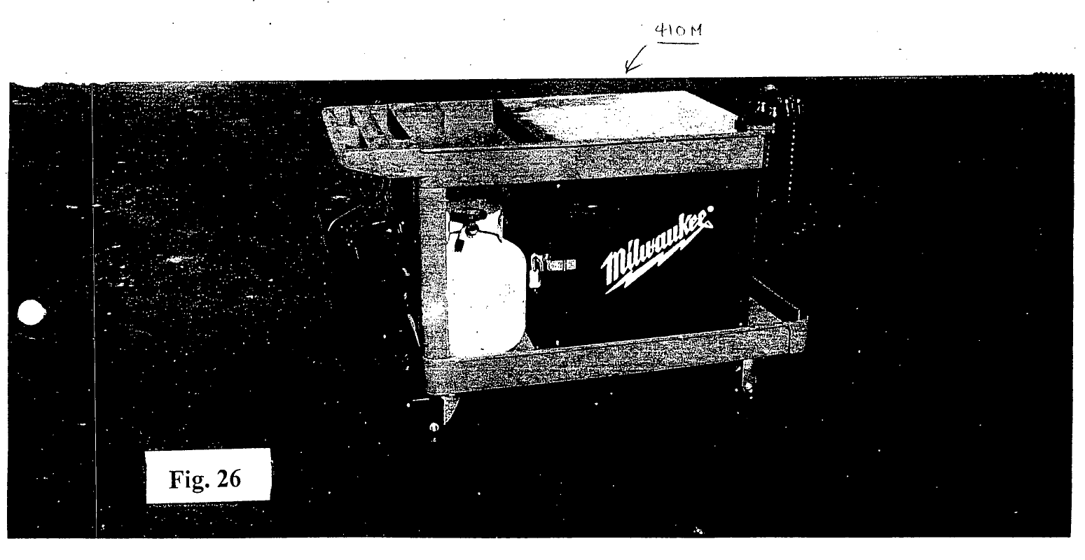

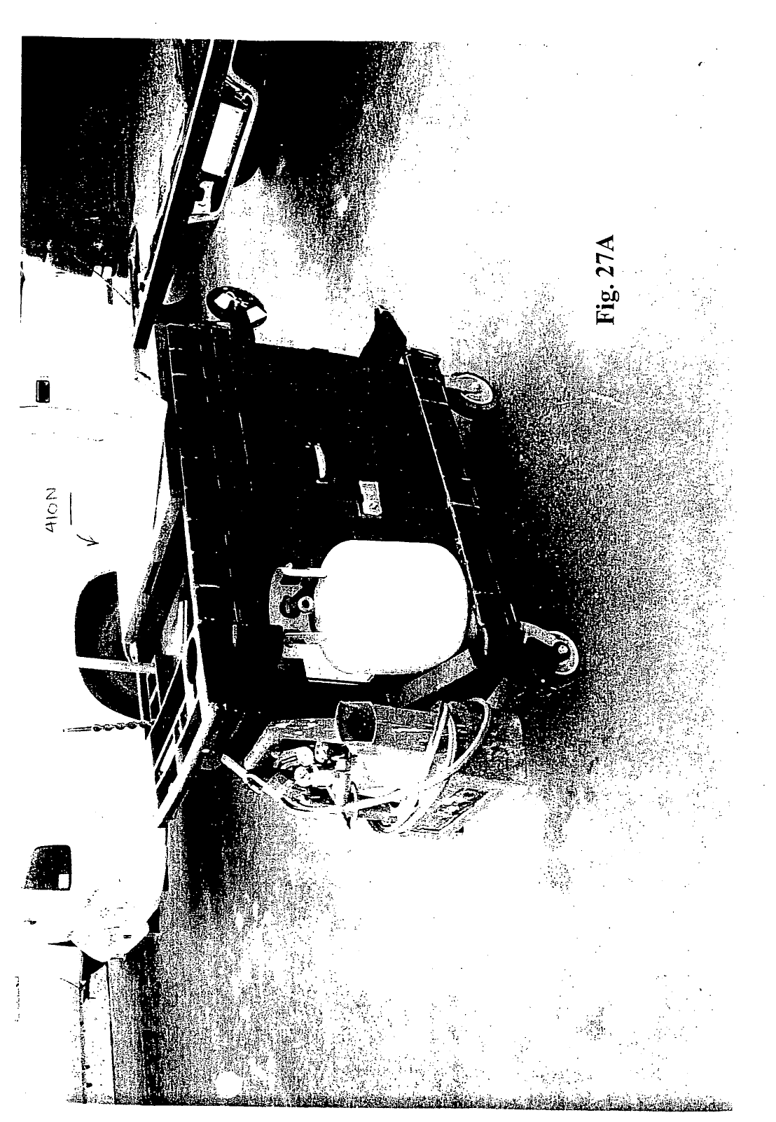

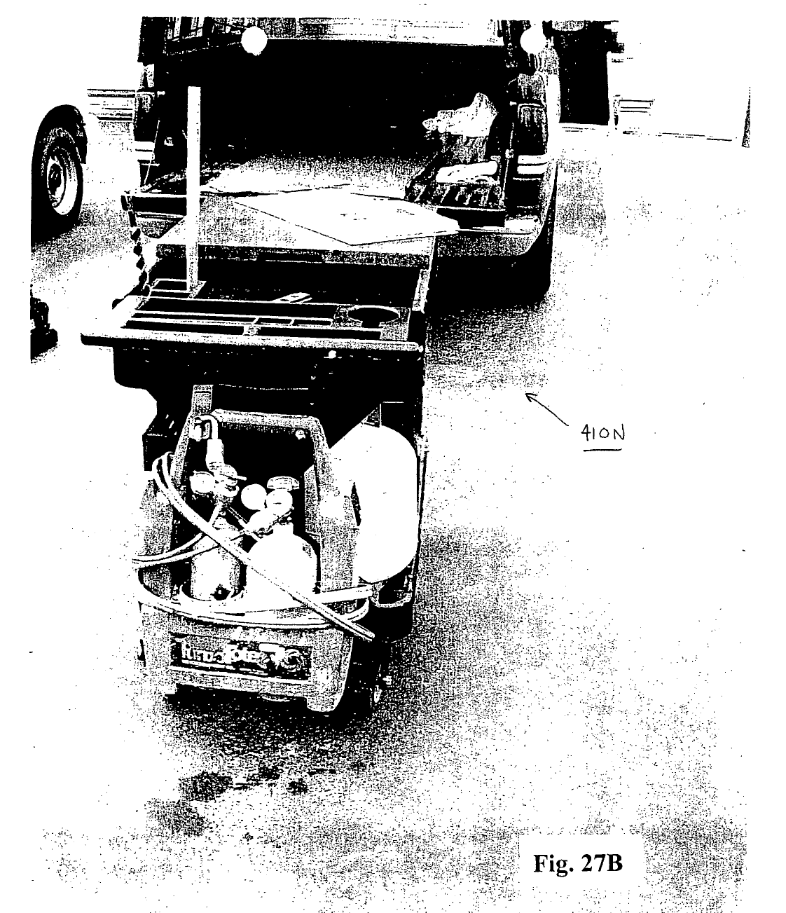

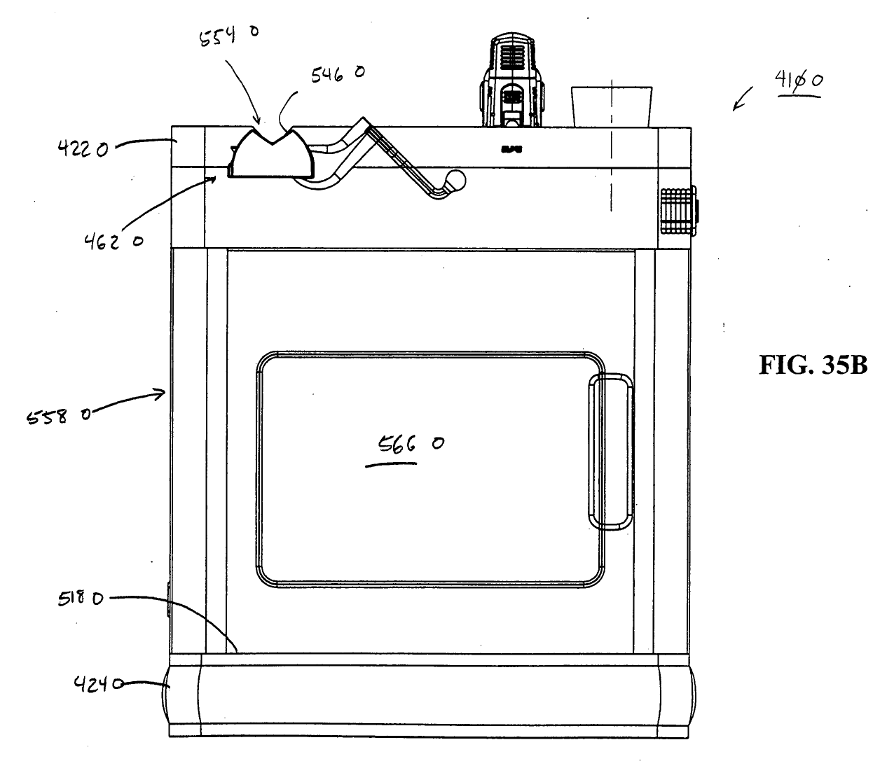

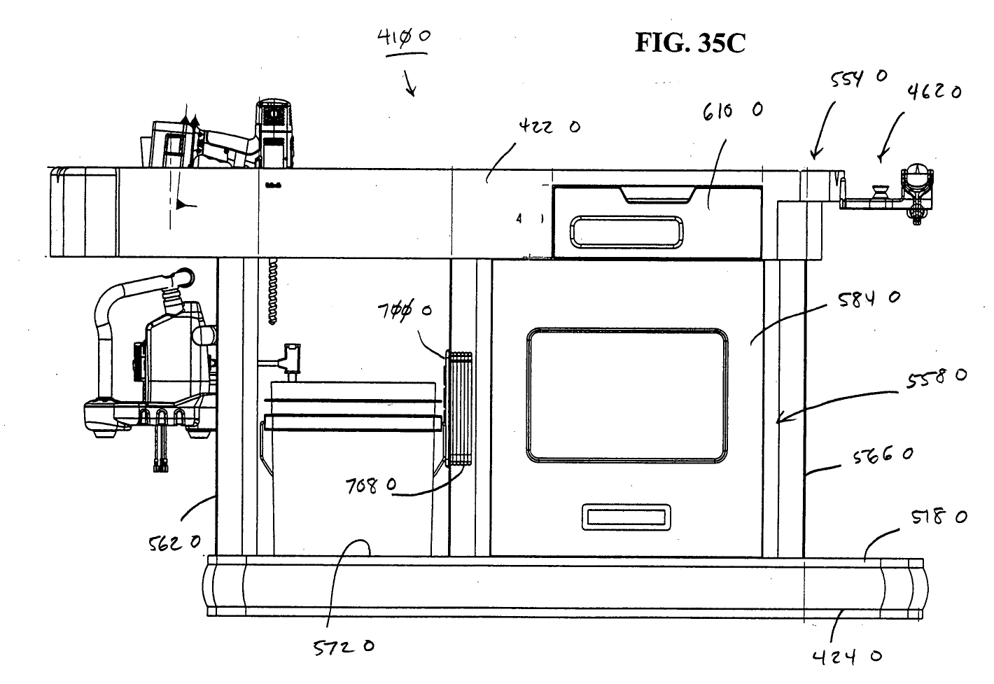

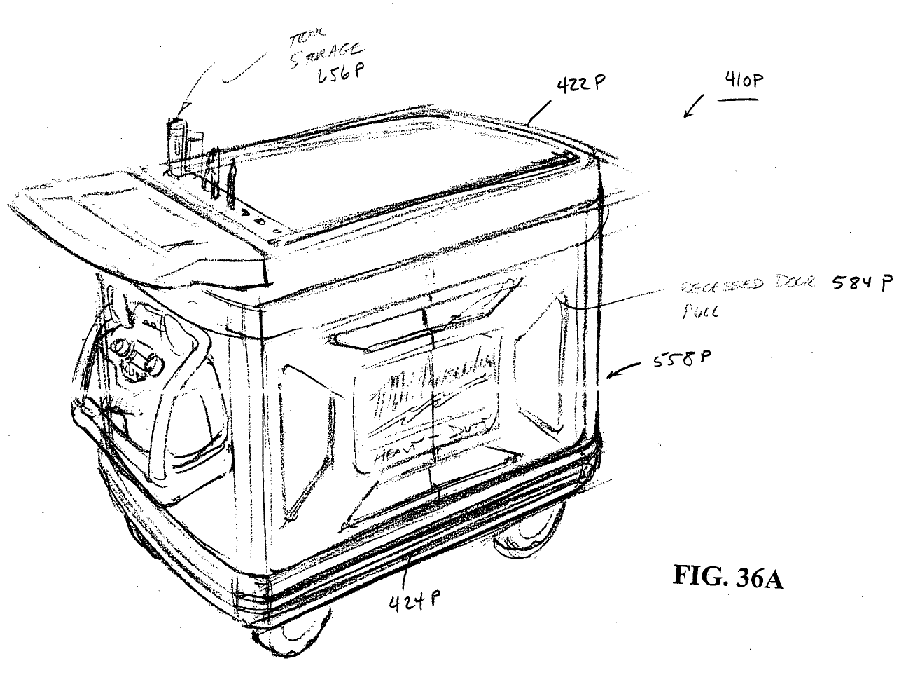

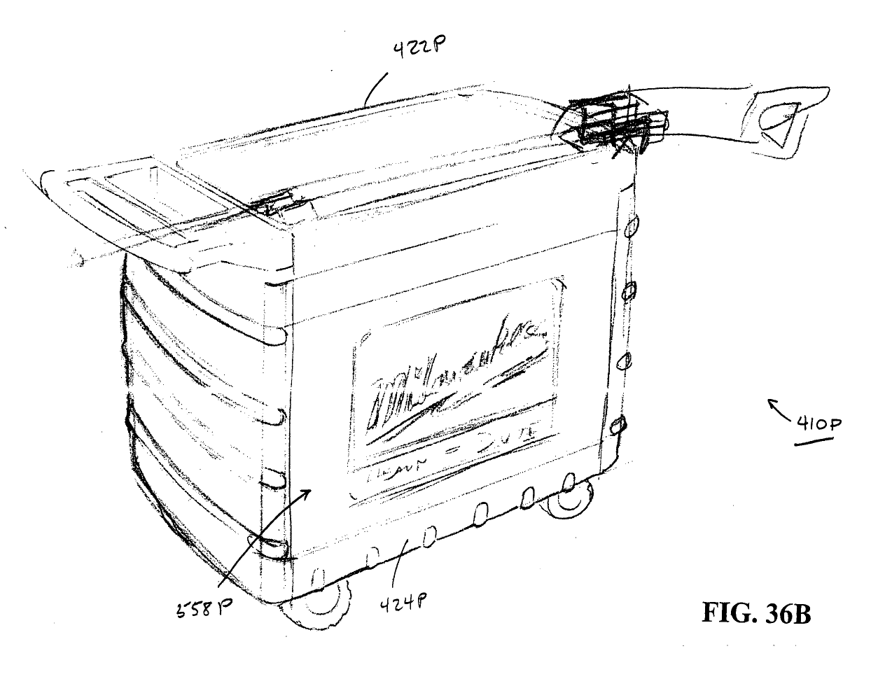

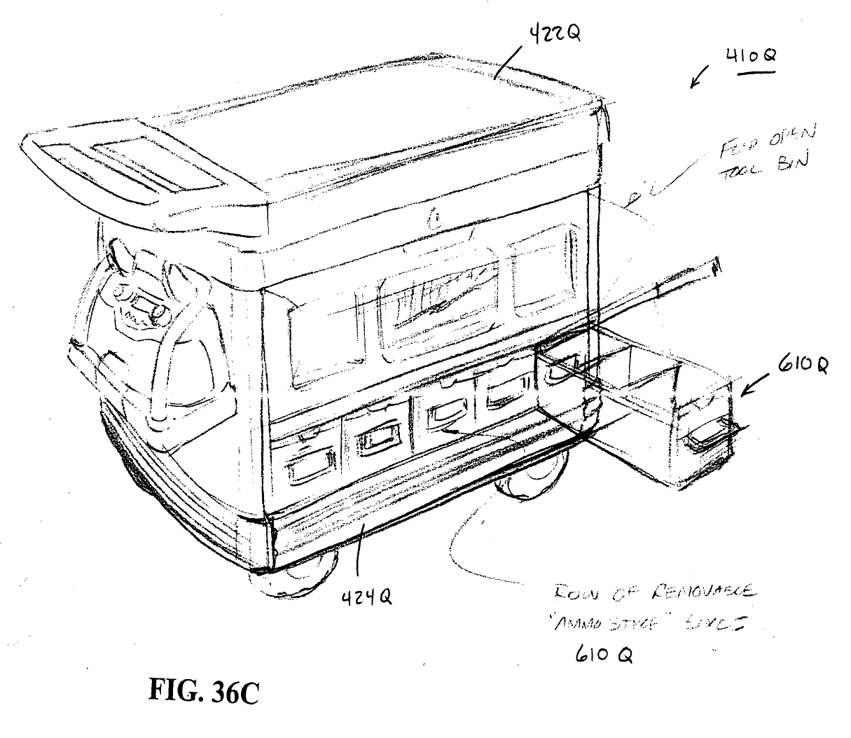

FIGS. 9-27 and 35-36 illustrate additional constructions of an industrial cart 410A-Q. The additional constructions of the industrial cart 410A-Q may include one or more of the features described above with the respect to the industrial carts 10, 110, 210, 310 and/or 410. Also, the carts 10, 110, 210, 310 and/or 410 may include one or more of the features described below. In FIGS. 9-27 and 35-36, common elements have the same reference number modified as follows: in FIGS. 9-11, “A”; in FIGS. 12A-B, “B”; in FIGS. 13-14, “C”; in FIGS. 15A-D, “D”; in FIGS. 16A-C, “E”; in FIGS. 17-18, “F”; in FIGS. 19A-B, “G”; in FIGS. 20A-B, “H”; in FIG. 21, “I”; in FIG. 22, “J”; in FIGS. 23A-C, “K”; in FIGS. 24-25, “L”; in FIG. 26, “M”; in FIGS. 27A-B, “N”; in FIGS. 35A-C, “O”; in FIGS. 36A-B, “P”; and in FIG. 36C, “Q”.

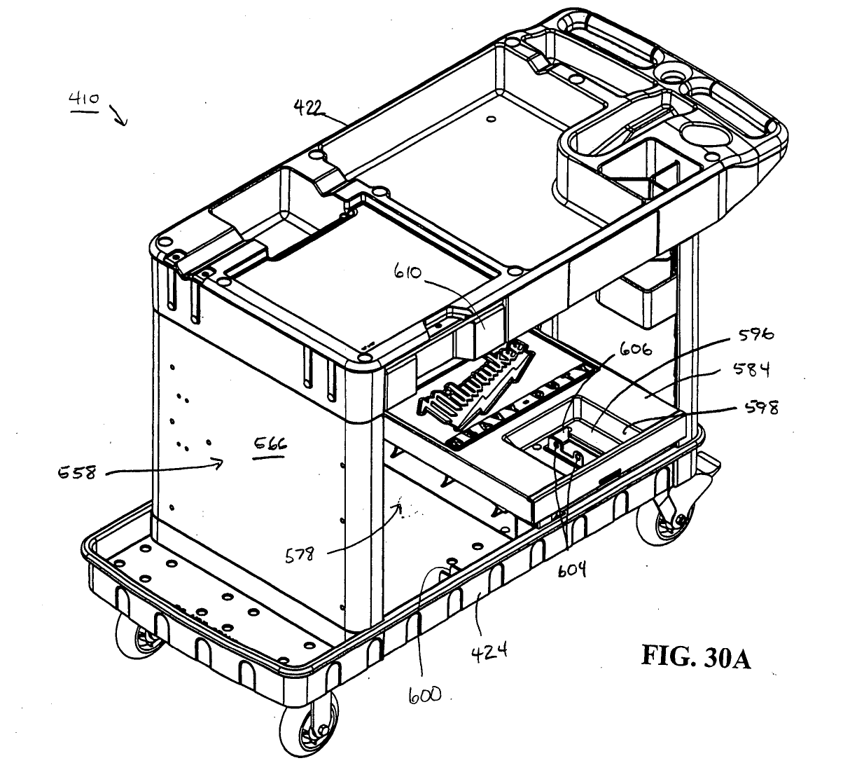

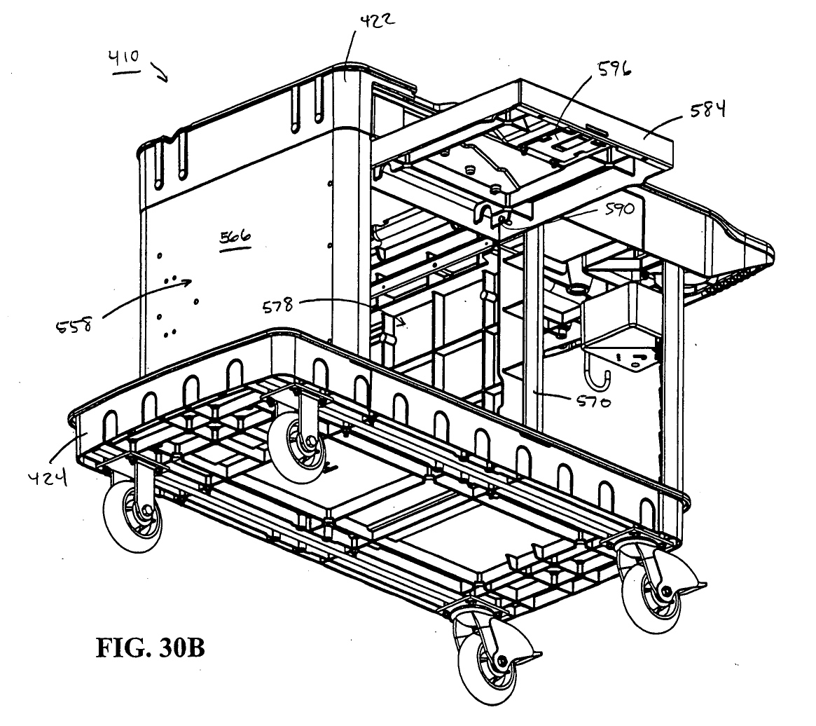

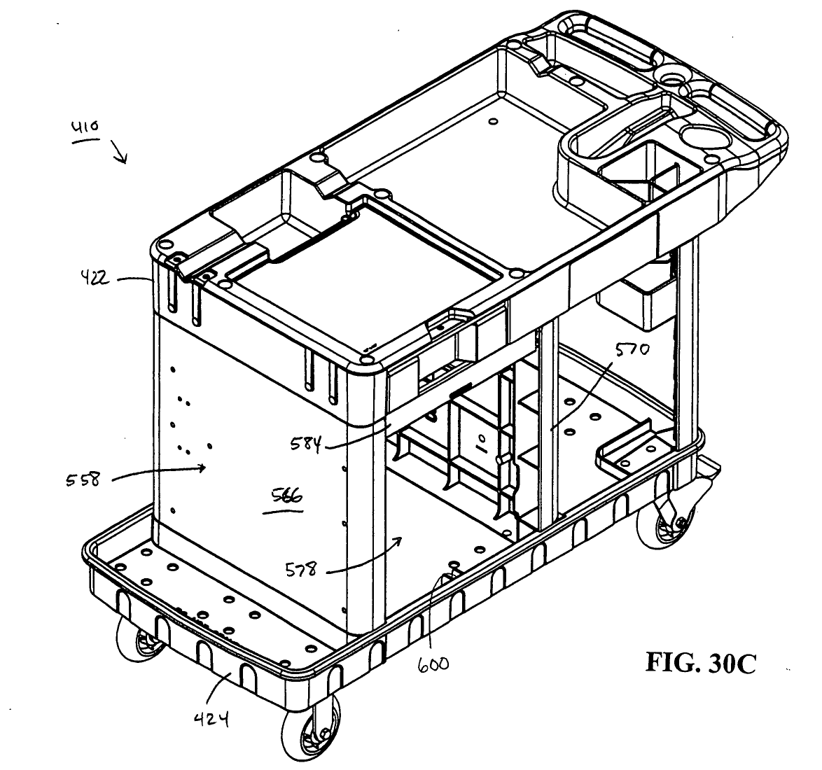

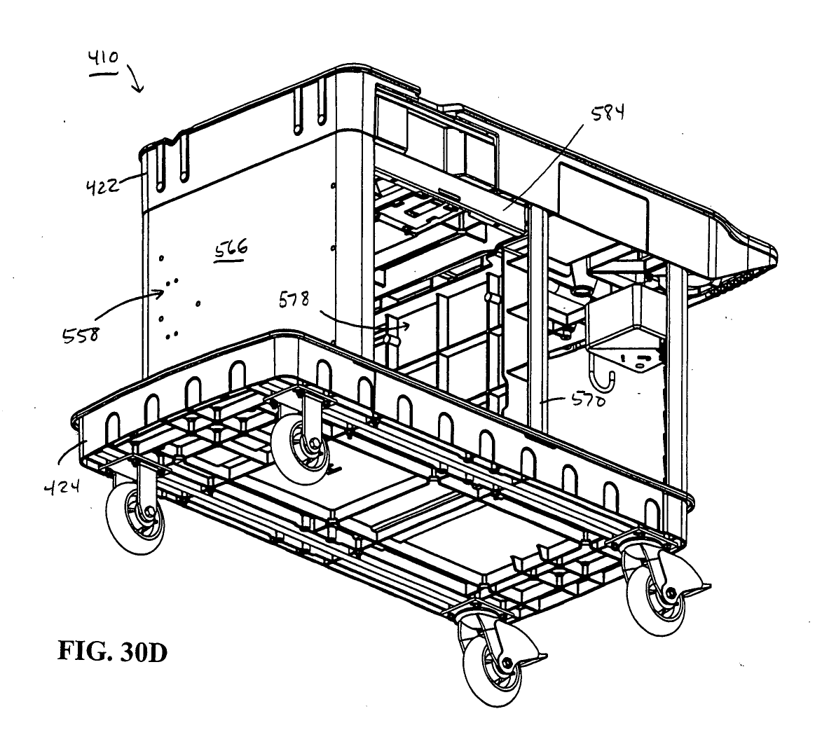

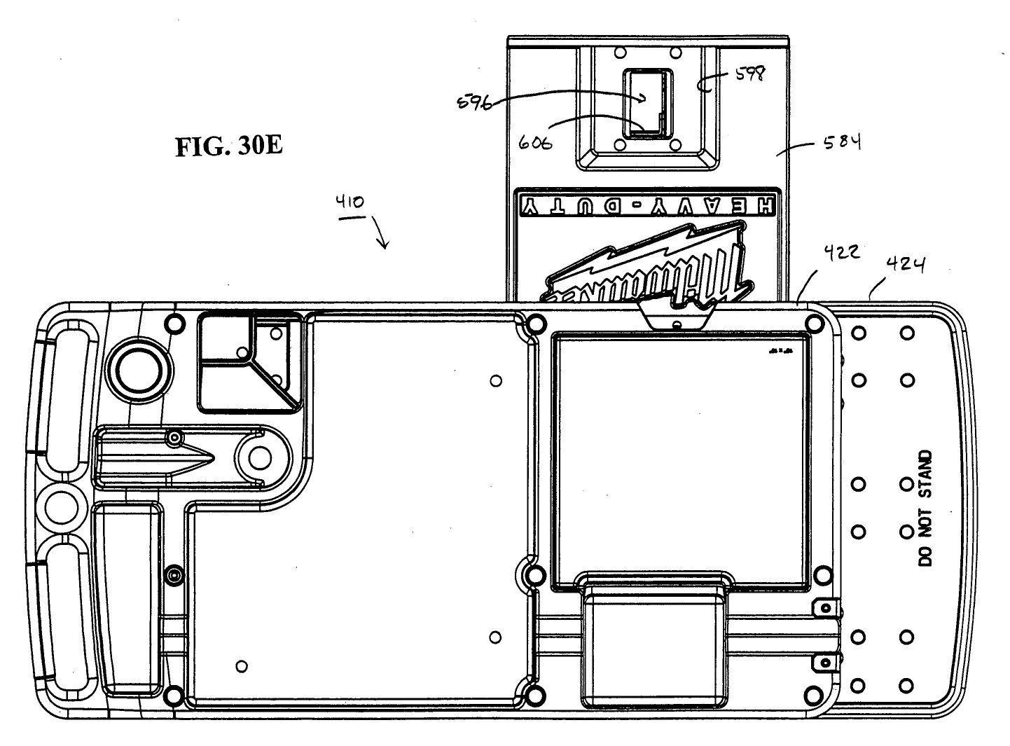

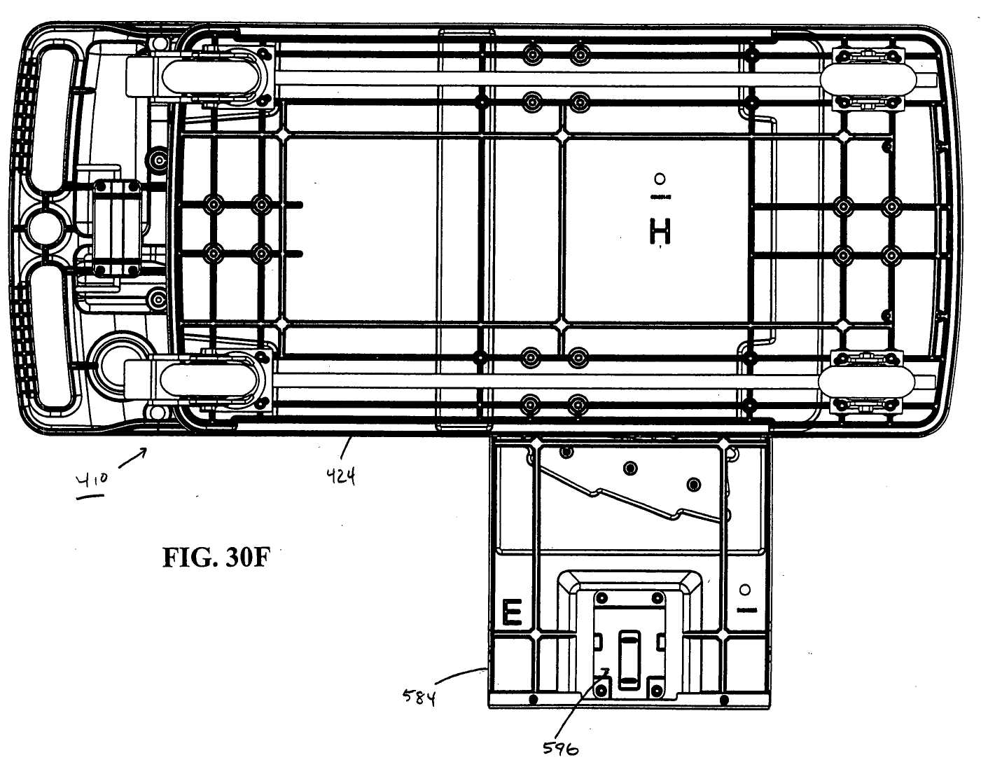

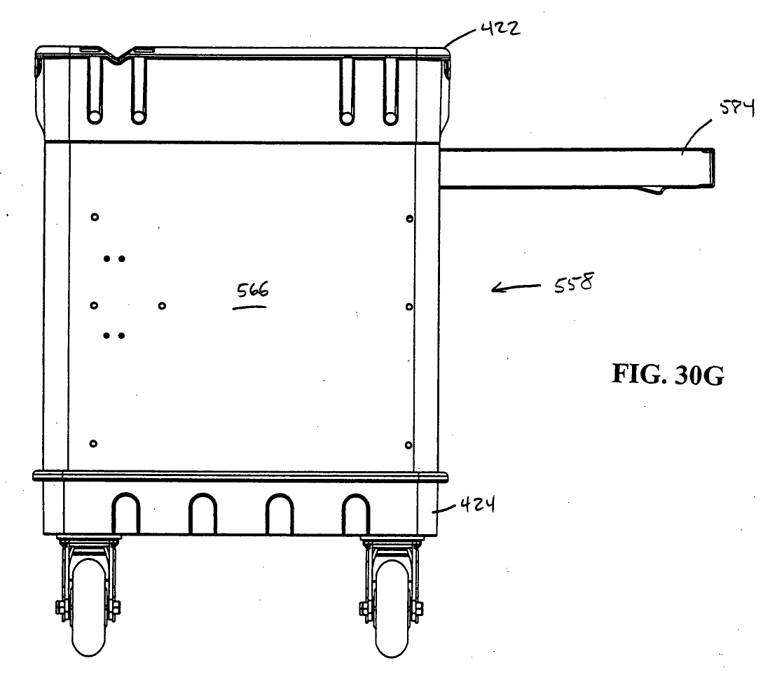

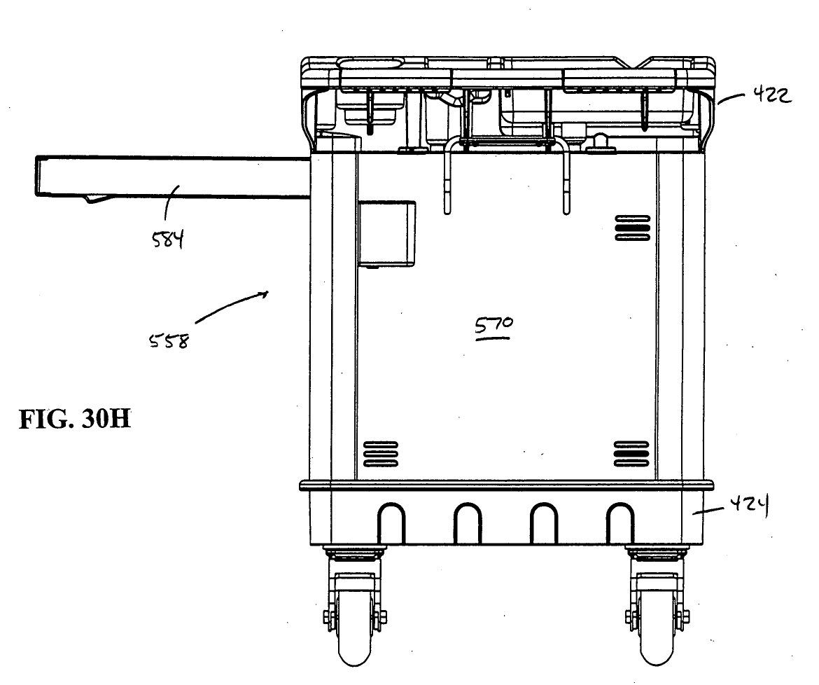

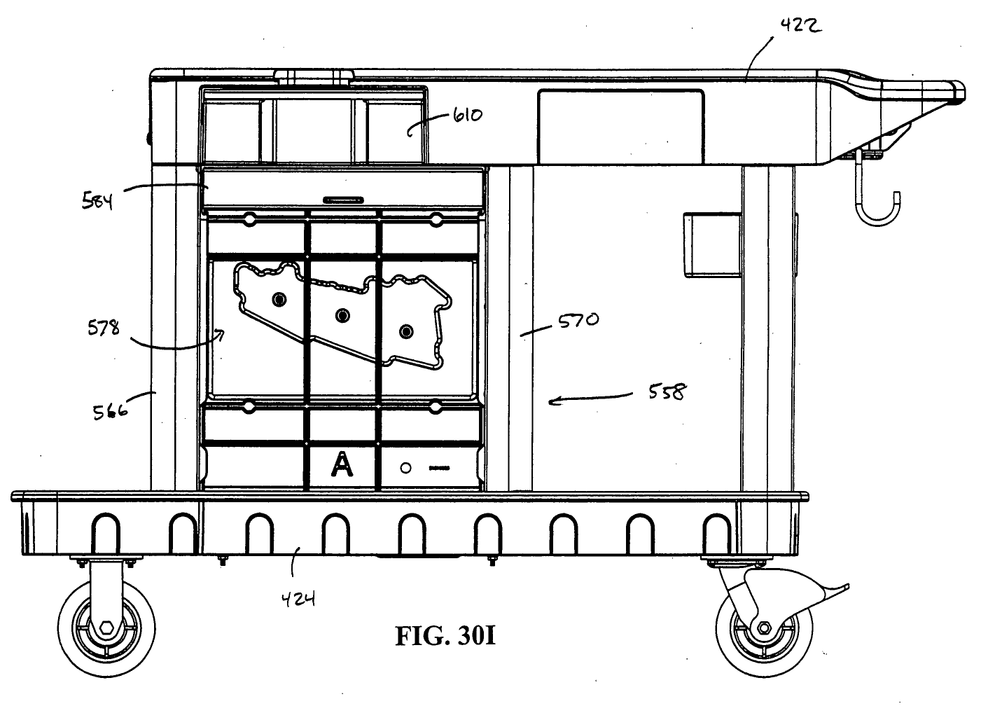

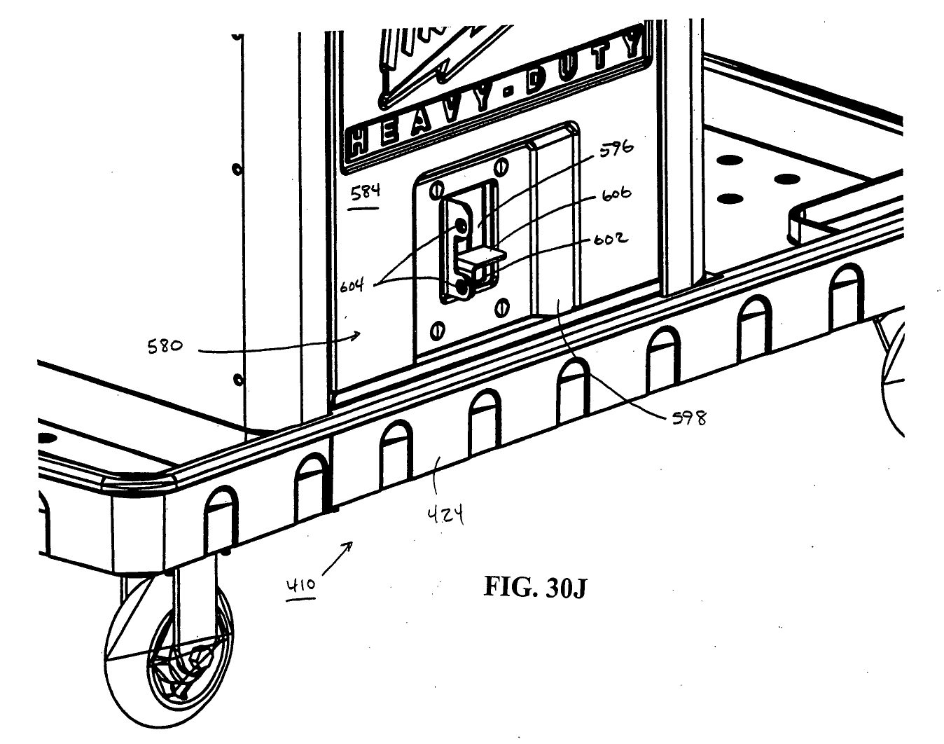

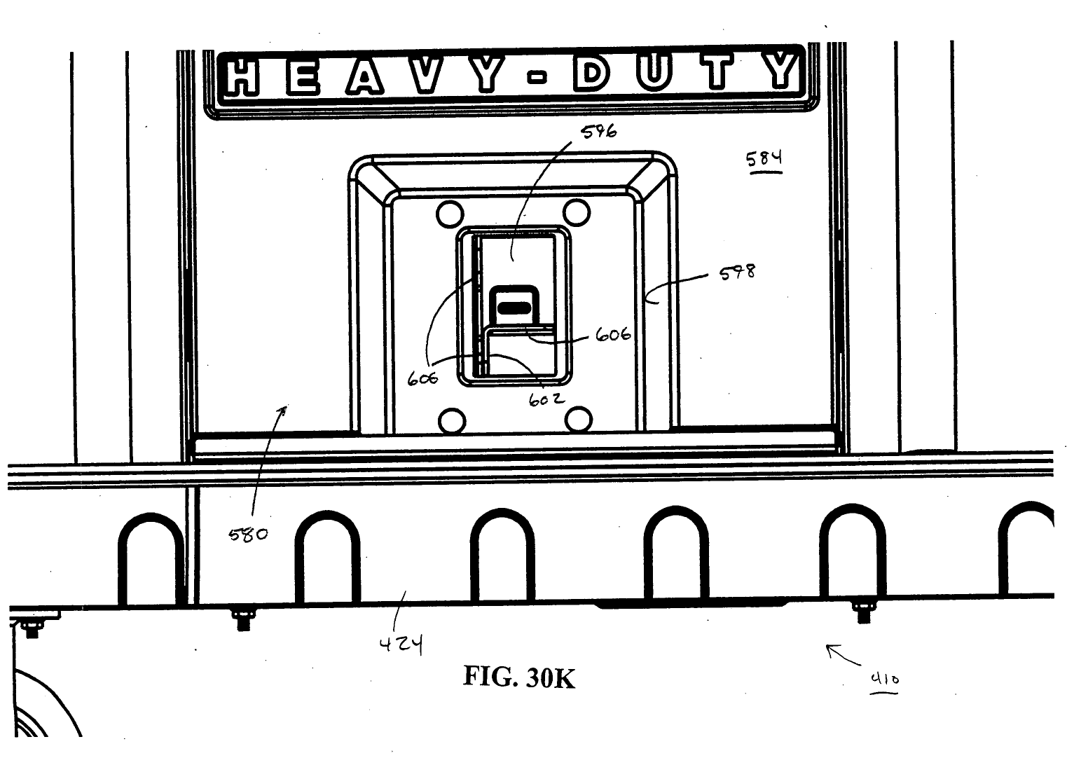

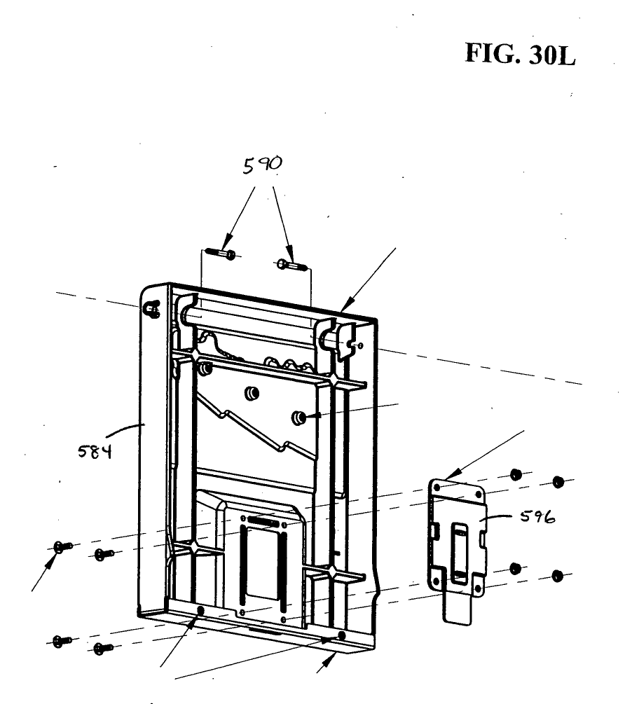

Many of the elements illustrated in FIGS. 29-34 are the same, and the following description will be directed to the elements as shown in the relevant figures of FIGS. 29A-J. It should be understood that, unless otherwise indicated, the elements are shown in the relevant figures of FIGS. 30-34 are the same.

As shown in FIGS. 29A-29J, the cart 410 generally includes a frame 414 and wheels 418 supporting the frame 414 for movement to, from and around a work site. The wheels 418 are connected to a bottom, a lower shelf or a base 424 of the cart 410. The wheels 418 facilitate transport of the cart 410 and may include structure to secure the cart 410 in position (e.g., for transport, storage, etc.). Such structure may include wheel locks 514 which may selectively prevent rotation of the wheels 418 to prevent unwanted movement of the cart 410 and to provide a stable work area for the user.

In some constructions, the cart 410 may include tie down hooks or eyelets (not shown) to aid in securing the cart 410 for transport or overnight on the job site. In some constructions, the cart 410 may include a towing hitch option (not shown) to aid in securing the cart 410 to a powered vehicle for towing to, from and/or around ajob site.

In some constructions and in some aspects (see FIGS. 29A-29G, 33A-33G and 37-40), the industrial cart 410 may include an extended front deck 518 on the lower shelf 424. FIGS. 9, 16-17, 19A, 21, 23-24, 25E, 26 and 35 show a similar front deck 518.

As explained below, in some constructions (see, for example, FIGS. 17B, 17D, 17E, and 37-40), the extended front deck 518 may, for example, allow for storage and attachment of modular accessories. The modular accessories may be quickly attachable, removable, replaceable, etc. For example, a uniform connector may be provided on the front of the cart (e.g., a uniform hole pattern on a surface of the cart 410) allow for the attachment of modular accessories having a complementary connector.

As shown in FIGS. 29A-G and 29I-J, the cart 410 also includes a table, a top shelf or a work surface 422 near the top of the cart 410 opposite the wheels 418. In some constructions and in some aspects, the top shelf 422 is tiered or has varying height shelf portions. FIGS. 4-7, 9, 16-17, 19-24, 26-27 and 35 show a similar top shelf 422.

In the illustrated construction (see FIGS. 29A, 29C-D and 29G), the top shelf includes two tiers to generally provide a storage area 522 and a work area 526. The storage area 522 generally includes a relatively deep recessed open area (having a 3-½″ to 5″ lip) on the handle side of the cart 410 (e.g., for storage of small parts, boxes, tools, etc.). Inner supports or ridges 530 may be provided to allow a cover (e.g., a ¾″ sheet of plywood (not shown)) to cover open area of the storage area 522.

The work area 526 may generally include a shallow depth work surface area (having a ¾″ to 1-½″ lip 534) on front of the cart 410. As shown in FIG. 16C, the shallow lip 534 allows plywood to be used as a sacrificial, replaceable work surface S. Also, the shallow lip 534 allows for sheet steel to be inserted to protect the cart from high temperature work operations. In addition, because the height of the lip 534 on the work area 526 is relatively low, heavy items may be easily placed on the work area 526 for transport on the cart 410, to be worked on, etc. The main handle 498 is generally positioned at the same height as or slightly lower than the work area 526 and storage area 522 so that larger components (e.g., fluorescent light fixtures, pipe systems, etc.) that are longer than the cart 410 can be easily staged and/or assembled on the cart 410.

As shown FIGS. 29A, 29C-D and 29G (and in FIG. 22), in some constructions and in some aspects, the top shelf 422 may have multiple (e.g., 6-9) flat-bottomed holes 538 positioned at the corners and/or mid-points of the cart 410. These holes 538 accept posts (not shown) and may be sized to accept either ¾″ conduit (EMT) or PVC pipe to create stakes or posts that help to, for example, secure both loose and bundled building materials (e.g., pipe, threaded rod, studs, etc.) so that the material(s) can be easily moved around the job site while on top of the cart 410 without falling off. In the illustrated construction, several (e.g., 3) holes 538 that run down the middle of the cart are offset and are positioned about 6″ inside of the complementary (e.g., 3) holes 538 that run down one side of the cart to create a storage zone 542 that fits common material bundles while leaving the remaining portions of the top shelf 422 open for work and assembly activity.

In some constructions, a user could also use a pipe bender to bend conduit to create a removable second handle (not shown) at the front of the cart 410 above the front deck 518. A user could also use a pipe bender to bend conduit to create removable long handles/material supports (not shown) that run the length of the cart 410 to which supplies and equipment could be hung along the sides of the cart 410. In addition, a user could use a pipe bender to bend conduit to create a removable means (not shown) of securing cases of fluorescent bulbs vertically on the front deck 518 of the cart 410.

As shown in FIGS. 29A, 29C-D, 29G and 291-J, in some constructions and in some aspects, the industrial cart 410 may include one or more material cutting aids. FIGS. 3, 8-9, 16-17, 19-22, 26 and 35 show similar material cutting aids.

For example, as shown in FIGS. 29A, 29C-D, 29G and 291-J, the cart may include a groove 546 molded into the upper shelf 422. Material (not shown), such as, for example, lengths of pipe, conduit, wood, etc., may be positioned in the groove 546 and retained in position by engagement with the side walls of the groove 546. The groove 546 may have a generally V-shape and may be positioned on the top shelf 422 extending along the length (the longest side) of the cart 410 to allow for use in relatively narrow work areas (e.g., in a hallway).

In the illustrated construction, the groove 546 is provided by one or more groove portions 546a-c extending along the axis of the groove 546. The groove portions 546a-c are formed in portions of the upper shelf 422 adjacent the top surface of the upper shelf 422. In other constructions (not shown), a single groove portion may provide the groove 546.

As shown in FIGS. 29A, 29C-D and 29G, a lateral opening or pocket 550 may be formed under the groove 546 near the cutting location to allow a user to grip around the material that is being cut for improved control of the material. This pocket 550 may act as both a location to grip the material and as a storage location for building supplies, equipment, etc.

In some constructions (see FIGS. 9 and 16), the cart may include uprights 552 providing the groove 546. The uprights 552 may be pivotable (e.g., to change the orientation of the axis of the groove 546, to move the upright 552 to a stored, non-upright position, etc.) and may be movable (e.g., slidable) along the length and/or width of the cart 410. Further, the height of the uprights 552 may be adjustable. In the illustrated construction, the uprights 552 are positioned lengthwise (front to back) on the cart 410.

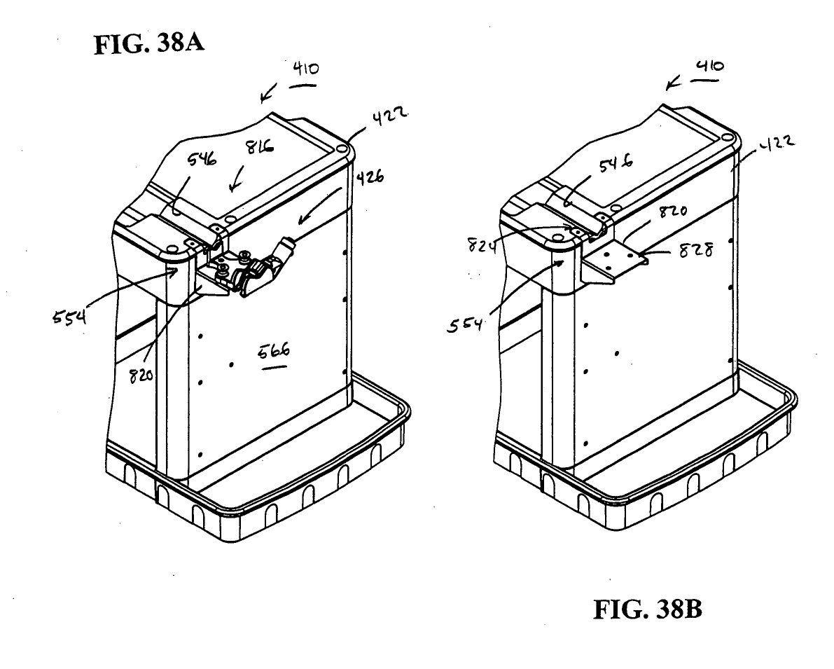

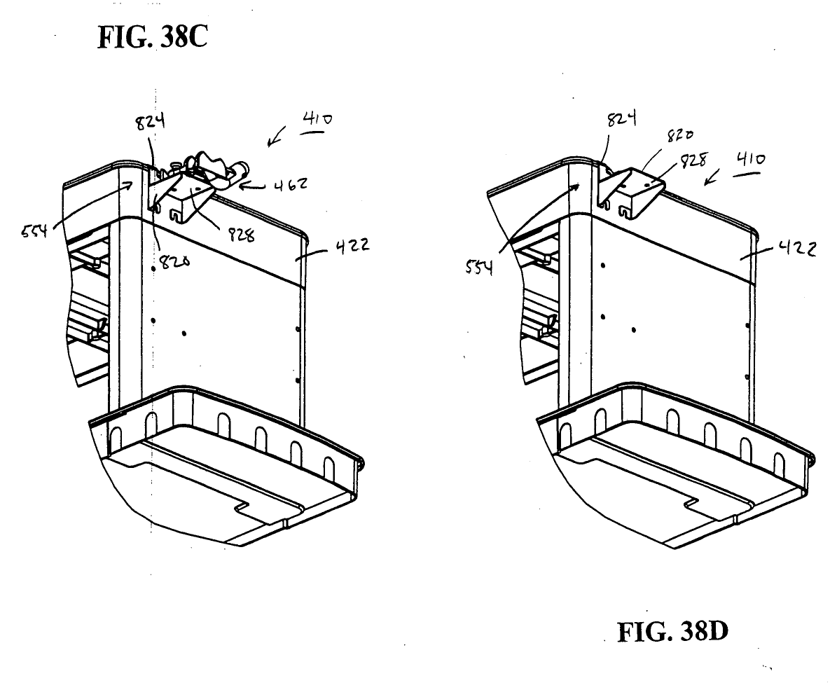

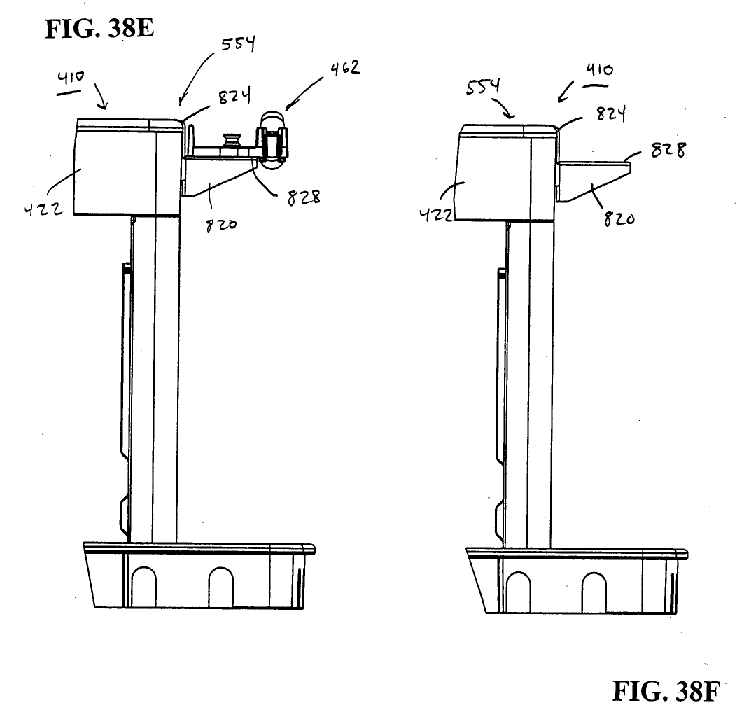

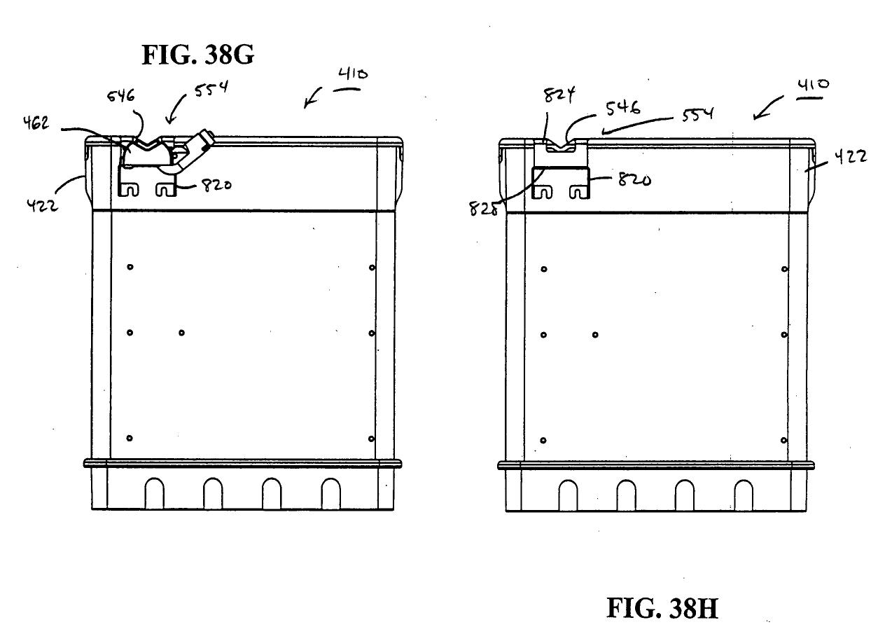

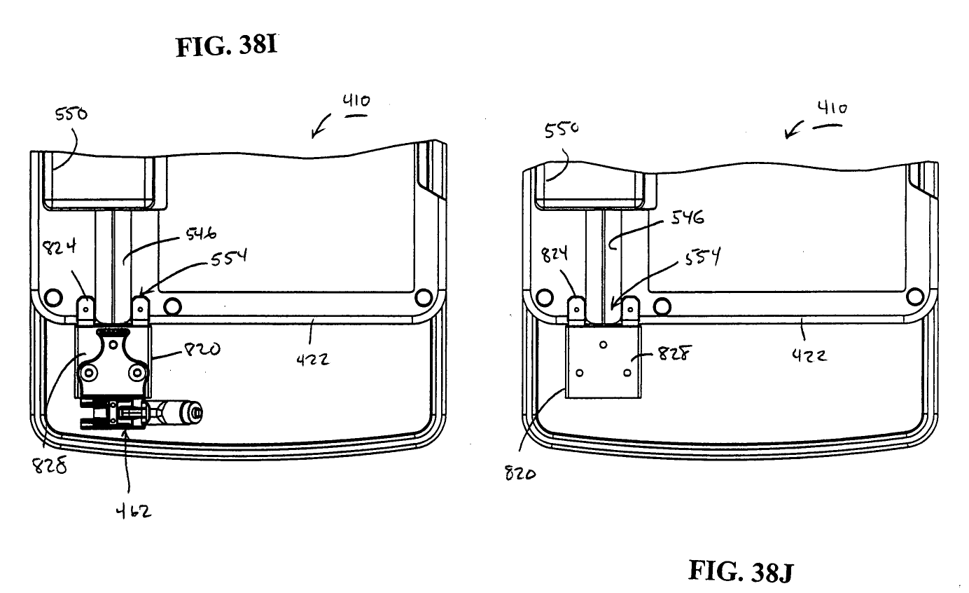

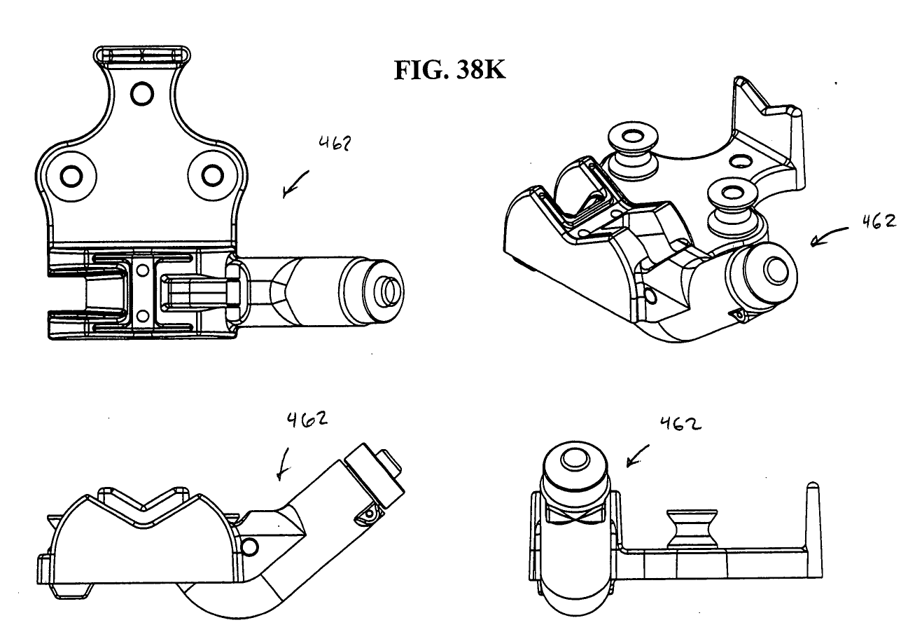

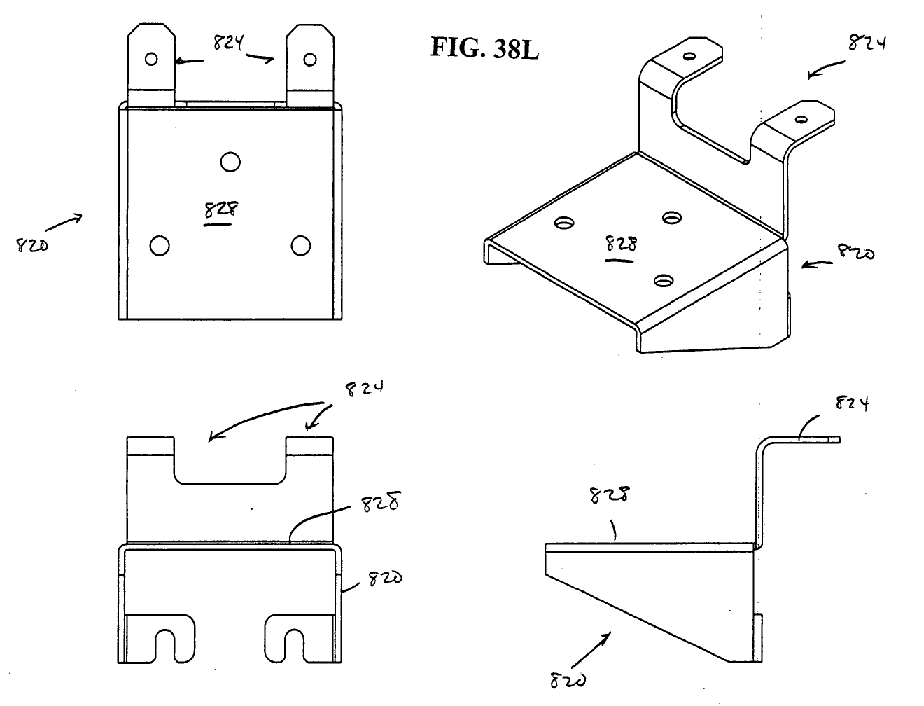

In some constructions (as shown in FIGS. 29A, 29C-D and 29G; see also FIGS. 8, 9, 16-17, 20-21, 26, 35 and 38), the cart 410 may include a location 554, as explained below with respect to FIGS. 38A-L, for mounting a vise 462 (e.g., a chain vise, other material vise, etc.), a clamp or other device for securing a work piece, a tool, or other device or material to the cart 410 and/or relative to a component (e.g., the work surface 422, a tool, etc.) of the cart 410. The location 554 may be positioned to align the clamp or vise with the groove 546 or uprights 552, if provided.

In some constructions and in some aspects, the industrial cart 410 may include a hanging storage location (not shown) for a power tool (e.g., a corded or cordless band saw a grinder, a drill, a reciprocating saw, etc.). Using a support on the power tool (e.g., the front “T” handle on a band saw), the cart 410 may provide a location (e.g., on or adjacent a vise mounting plate (see FIGS. 38A-L) or location 554) to quickly hang the power tool for out-of-the-way secure storage both between cutting operations and when transporting (rolling) the cart and for quick retrieval of the power tool once the material to be cut is secured in position.

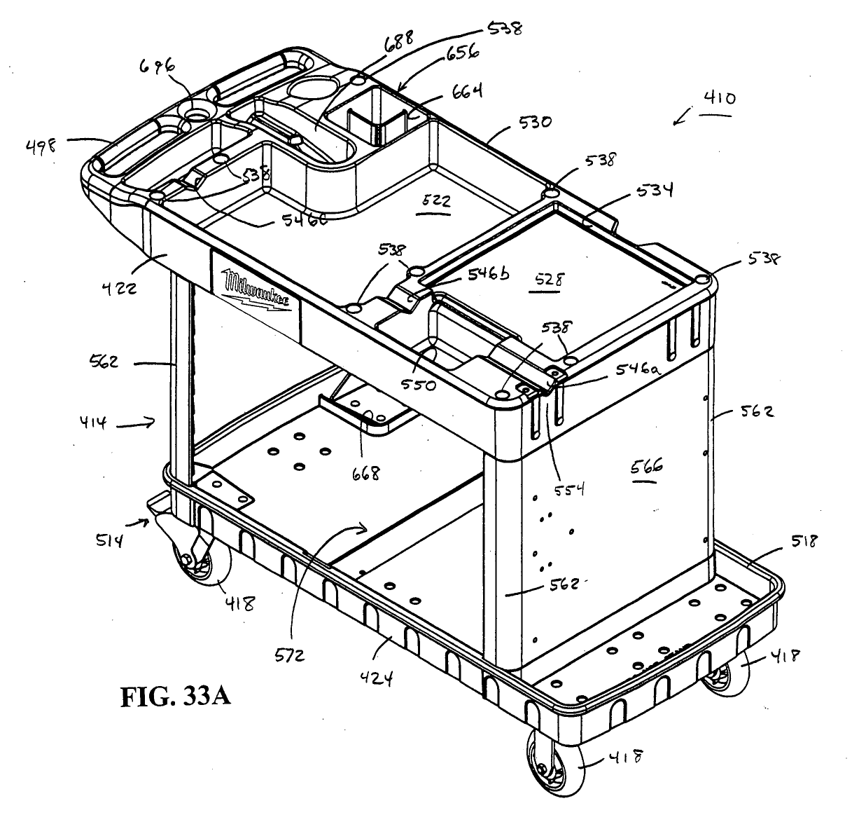

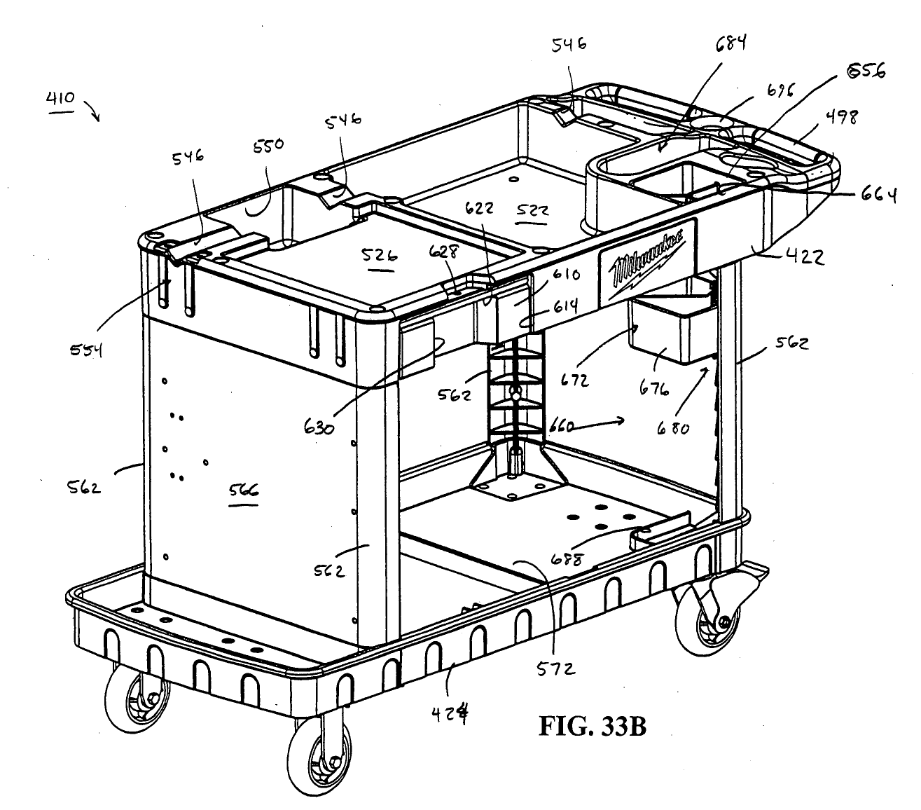

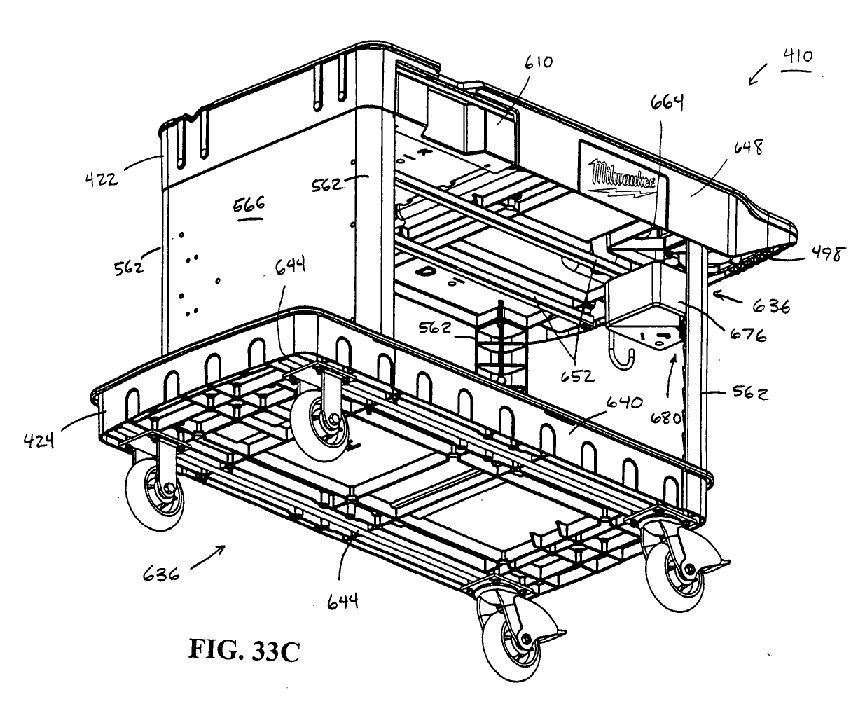

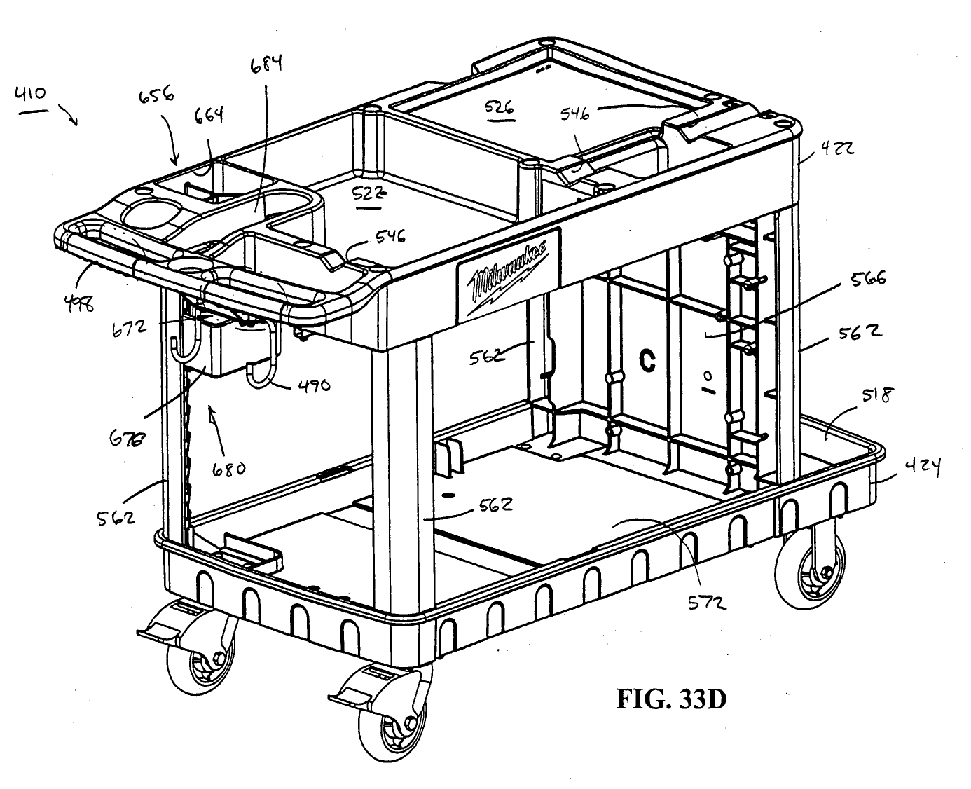

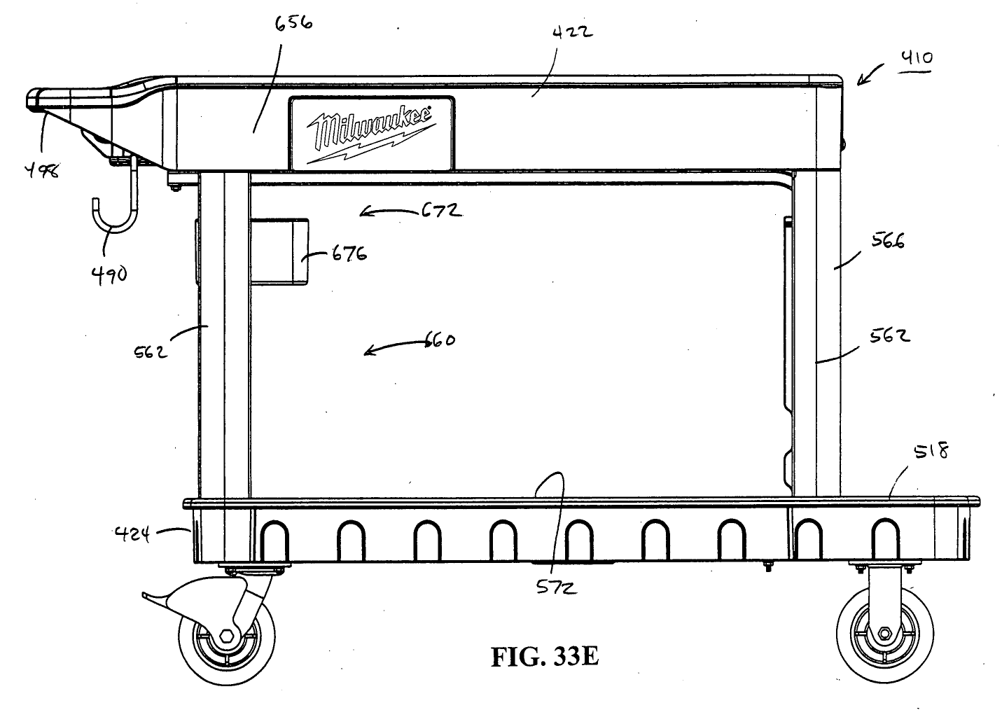

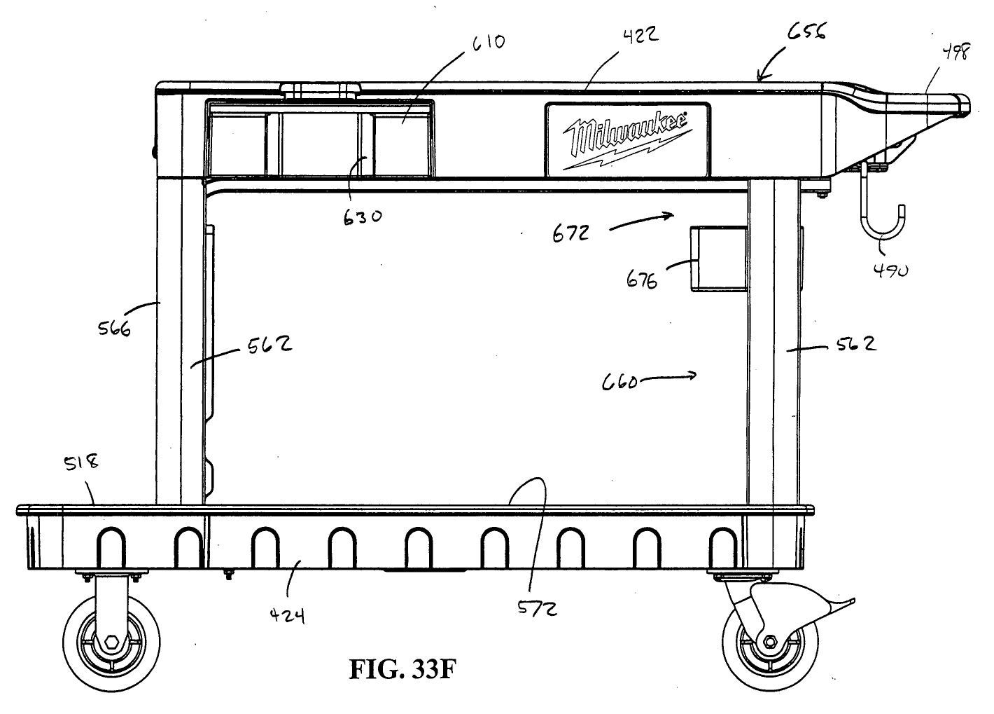

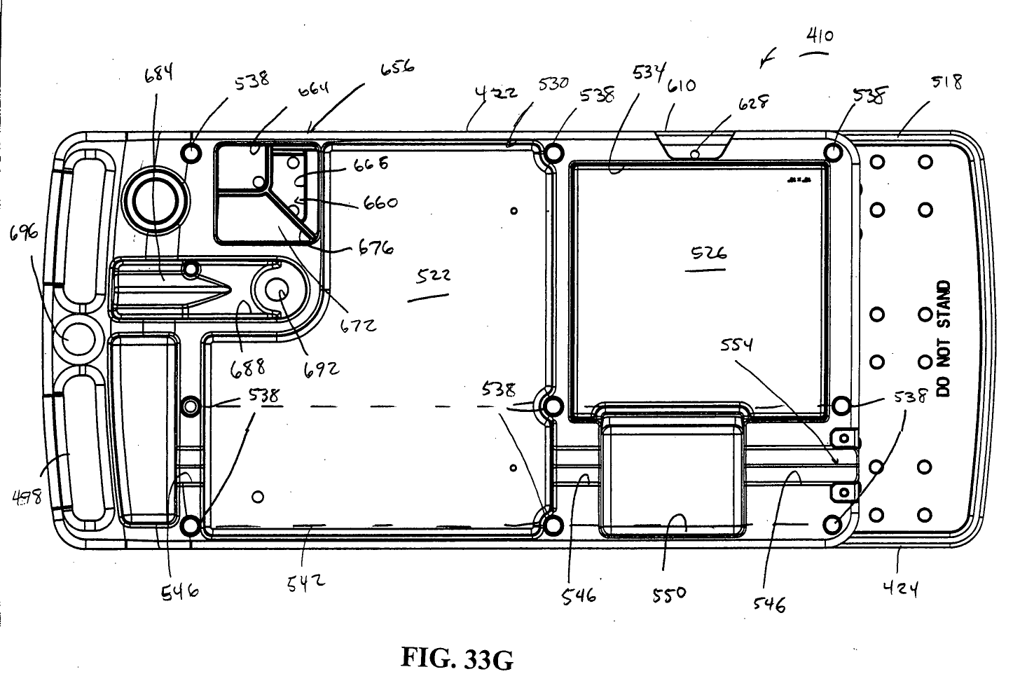

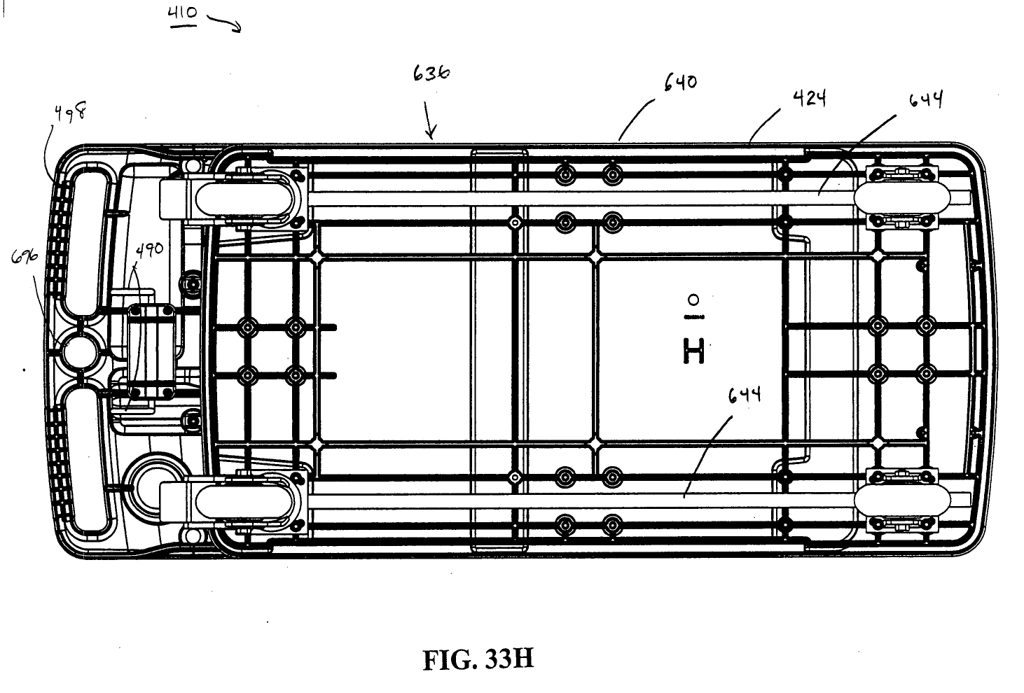

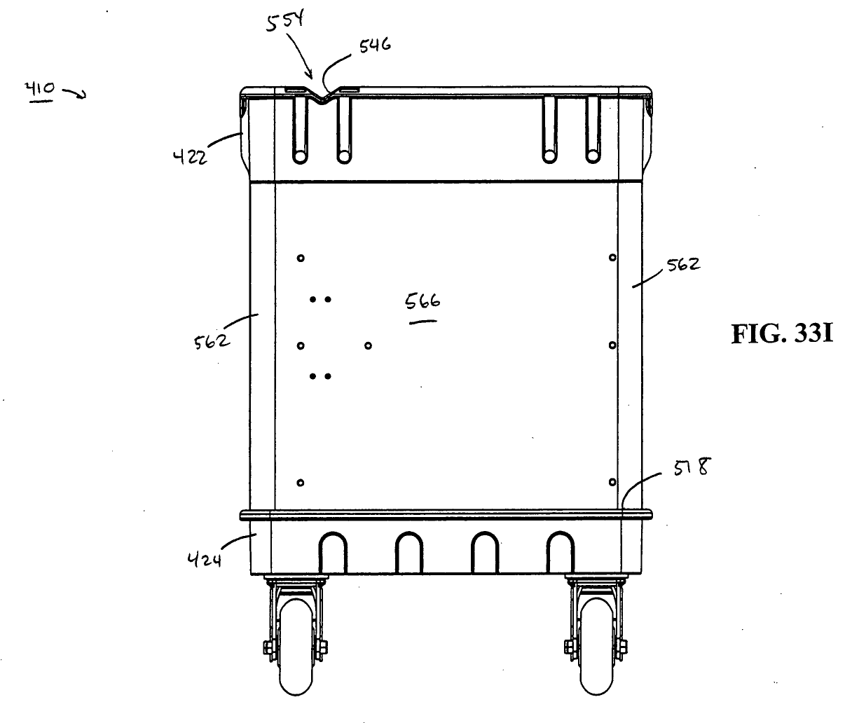

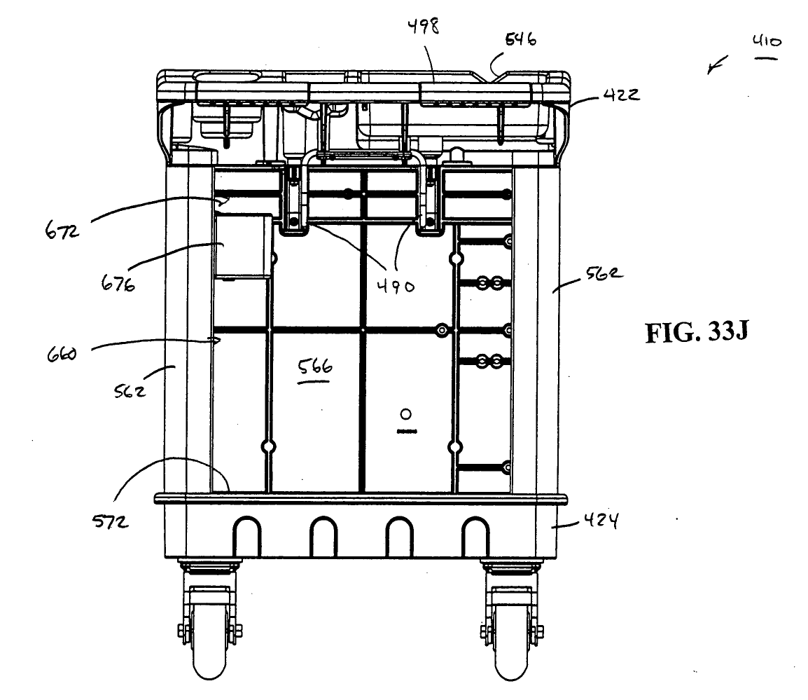

The industrial cart 410 has multiple configurations. In one configuration (see FIGS. 29A-J), the cart 410 includes a cabinet 558 to provide a “cabinet” cart configuration. In another configuration (see FIGS. 33A-J), the cart 410 does not include the cabinet 558 and provides a generally “open” cart configuration. As discussed below, the “cabinet” cart and the “open” cart include many common components. Accordingly, at least the two illustrated configurations are easily provided with a minimum of extra not-common components and with a minimum of modification.

Uprights 562 are provided between the base 424 and the table 422. In the illustrated construction, a front wall 566 provides the front upright(s) 562. As discussed below, the front wall 562 includes structure to support and/or connect with other components to form an enclosed cabinet 558, if provided.

With respect to the “cabinet” cart configuration (see FIGS. 29A-J), the cart 410 also includes a cabinet rear wall 570. In the illustrated construction, the rear wall 570 is spaced forwardly of the rear of the cart 410 such that an open or storage area 572 is provided. In contrast, in the “open” cart configuration (see FIGS. 33A-J), the storage area 572 is larger and includes the area between the base 424 and the table 422 almost the full length of the cart 410 (e.g., at least from the front wall 566 to the rear uprights 562).

Side walls 574 and 576 are connected between the walls 566 and 570 to provide (see FIGS. 30A-D and 301) an enclosed storage area 578 for storing additional tools, accessories, other similar implements, supplies, etc. In the illustrated construction (see FIGS. 29-30), at least one wall (e.g., the side wall 576) is provided by an openable door assembly 580 to allow access to the storage area 578. The door assembly 580 includes a door member 584 movably supported by the frame of the cabinet 558 (e.g., the walls 566 and 570).

In the illustrated construction, the door member 584 is pivotable between a closed position (shown in FIGS. 29B-C, 29F and 30J-K) and an open position (shown in FIGS. 30A-B, and 30E-I). The door member 584 is also supported for movement to a stored position (shown in FIGS. 30C-D). In the stored position, the door member 584 is stored in the cabinet 558 and does not extend outside of the periphery of the cart 410 so that the door member 584, when open, does not increase the overall dimension (e.g., width, length, etc.) of the cart 410. Such an arrangement allows the door member 584 to remain open so that the cabinet 558 is accessible even in relatively-small work areas (e.g., a hallway).

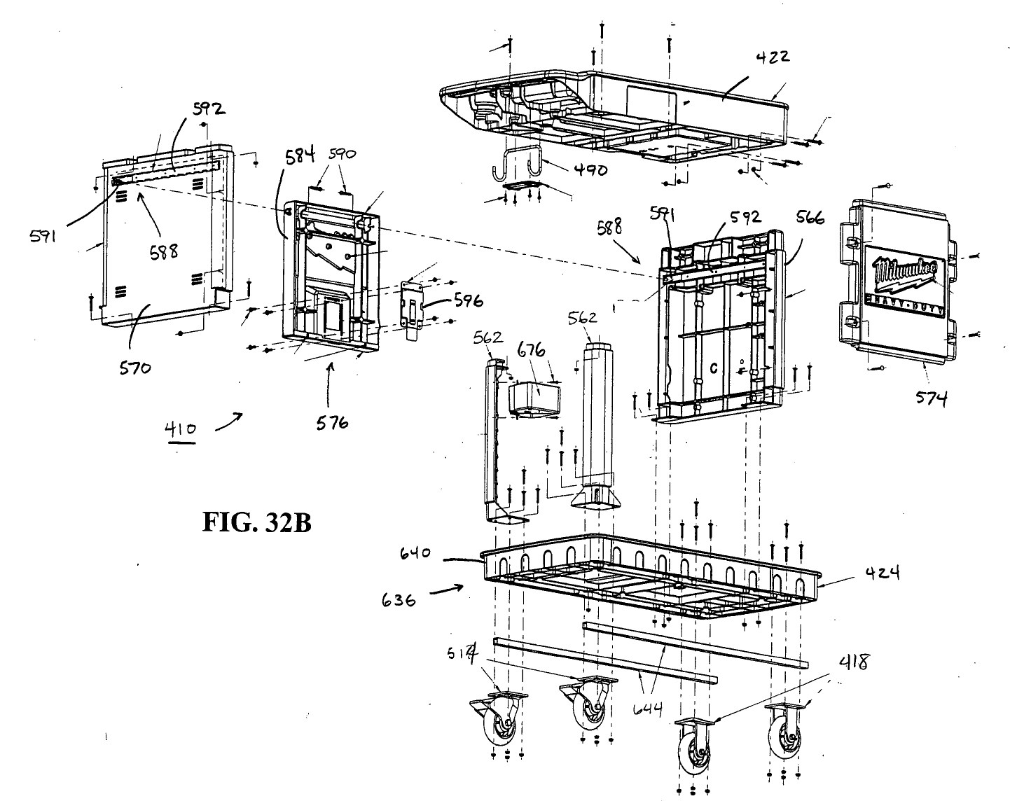

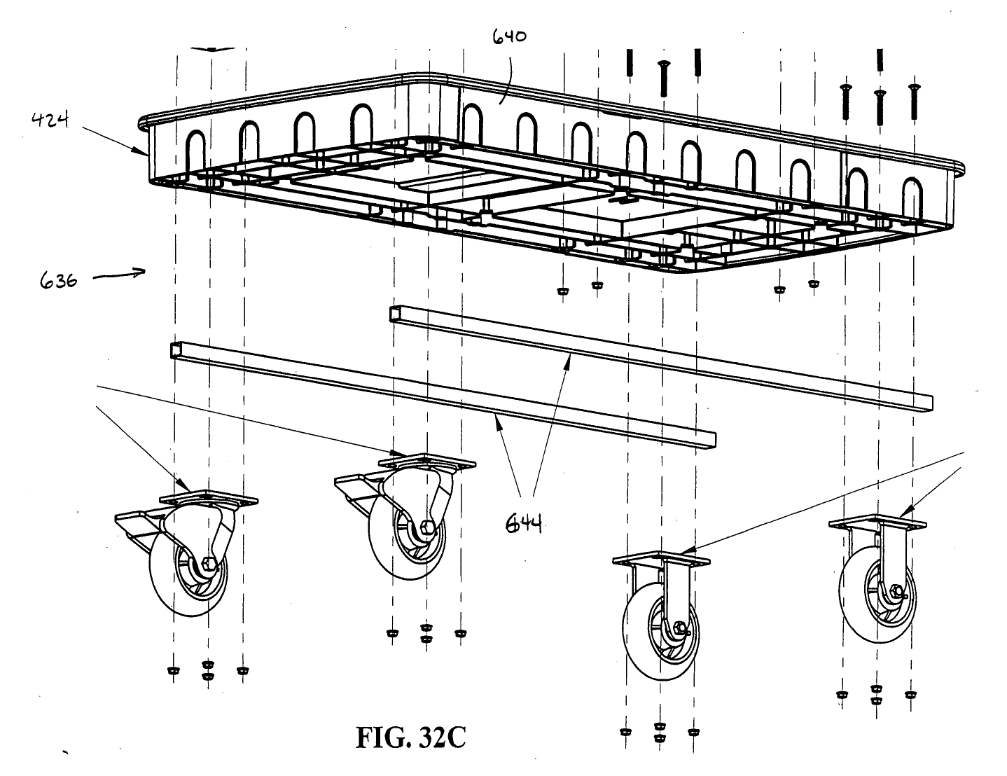

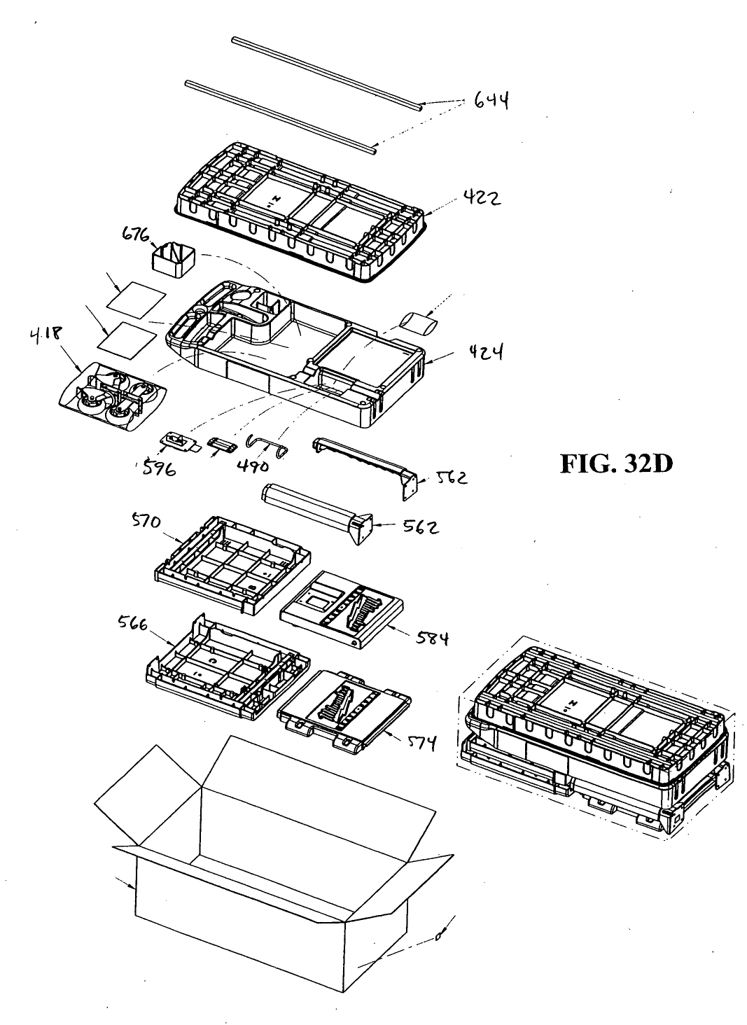

As shown in FIG. 32B, hinge assemblies 588 support the door member 584 for pivoting movement. Each hinge assembly 588 includes a hinge pin 590 defining the pivoting axis of the door member 584 and a hinge housing 591 supported by a wall 566 or 570. The hinge assemblies 588 are supported for sliding movement in respective tracks 592 defined in the walls 566 and 570 to enable movement of the door member 584 from the open position (shown in FIGS. 30A-B, and 30E-I) to the stored position (shown in FIGS. 30C-D).

A locking arrangement is provided to selectively lock the door member 584 in the closed position and to secure the storage area 578. In the illustrated construction, the locking arrangement includes a latch member 596 slidably supported on the door member 584. The latch member 596 is supported in a recessed area 598 or the door member 584. Cooperating locking structure is provided on a fixed portion of the cabinet 558. In the illustrated construction, the base 424 provides (see FIGS. 30A and 30C) a locking surface 600 engageable by the latch member 596 when the door member 584 is in the closed position.

The latch member 596 is movable between a locked position, in which the latch member 596 engages the locking surface 600 to lock the door member in the closed position, and an unlocked position, in which the latch member 596 is disengaged from the locking surface 600 so that the door member 584 may be opened. As shown in FIGS. 30J-K, the latch member 596 has an opening 602 alignable (in the locked position) with fixed openings 604 on the door member 584 for receiving a separate lock (e.g., a padlock) to secure the latch member 596 in a position (e.g., the locked position) or for maintaining the latch member 596 in a position (e.g., the unlocked position).

A handle 606 is provided to move the latch member 596 between the locked and unlocked positions. Among other things, the recessed area 598 of the door member 584 ensures that the latch member 596, the handle 606 and any separate lock do not extend beyond the periphery of the cart 410. A biasing member (not shown) may bias the latch member toward a position (e.g., the locked position).

A biasing member (not shown) may be provided to bias the door member 584 toward a position (e.g., toward the open position). In such constructions, the biasing member may maintain the door member 584 in the open position so that an operator can use both hands to access the storage area 578. The biasing member may be an over-center member which applies a biasing force after the door member 584 has moved close to the biased position (e.g., close to the open position).

A support arrangement (not shown) may be provided to selectively hold the door member 584 in the open position. In a manner similar to many folding shelf arrangements, such a support arrangement may include a support surface formed on the door member 584 which is selectively engageable with a fixed support surface formed, for example, formed on a wall 566 or 570, when the door member 584 is in the open position. For example, in the open position, the door member 584 may be laterally shifted so that the support surfaces are engageable to hold the door member 584 in the open position. The door member 584 is laterally shifted in the opposite direction to move the support surfaces out the range of engagement so that the door member 584 is freely pivotable between the open position and the closed position.

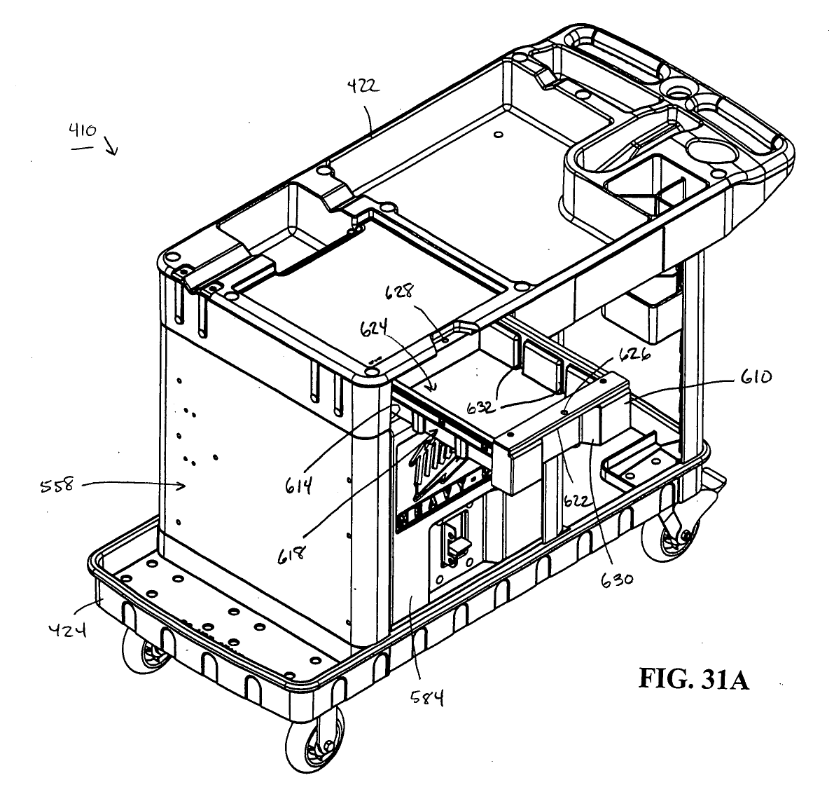

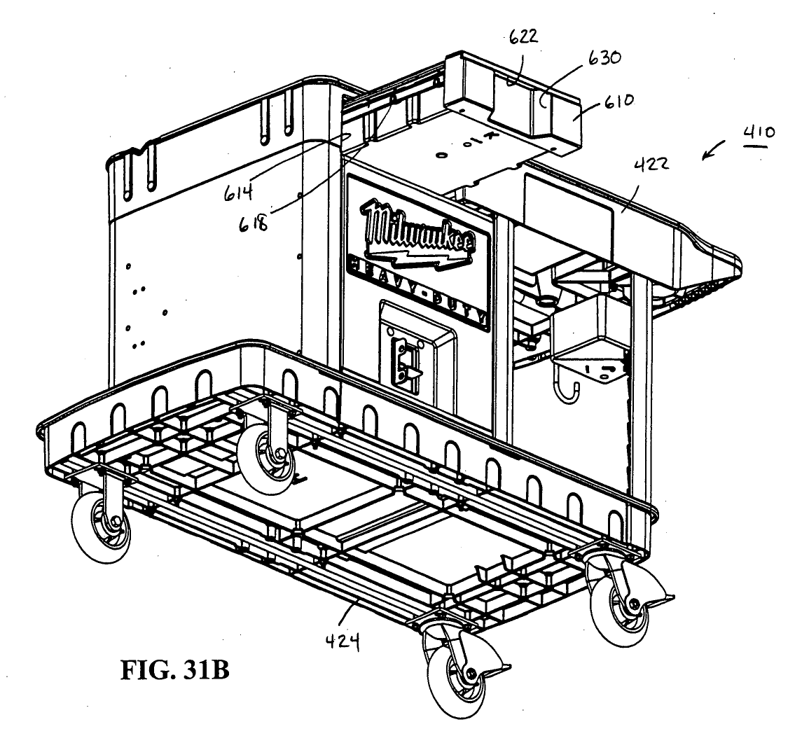

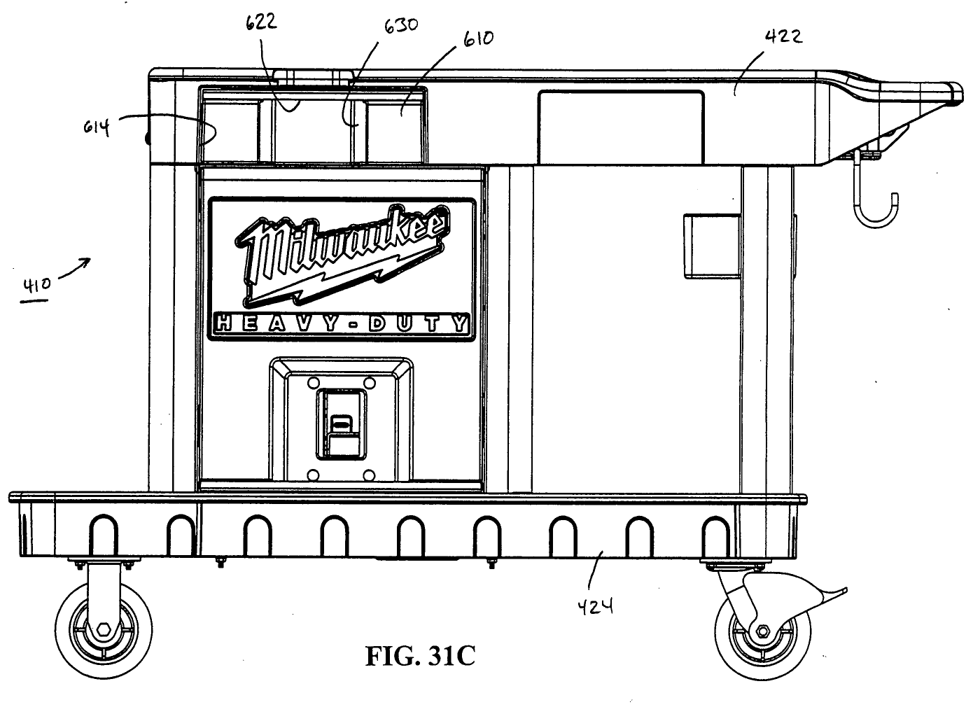

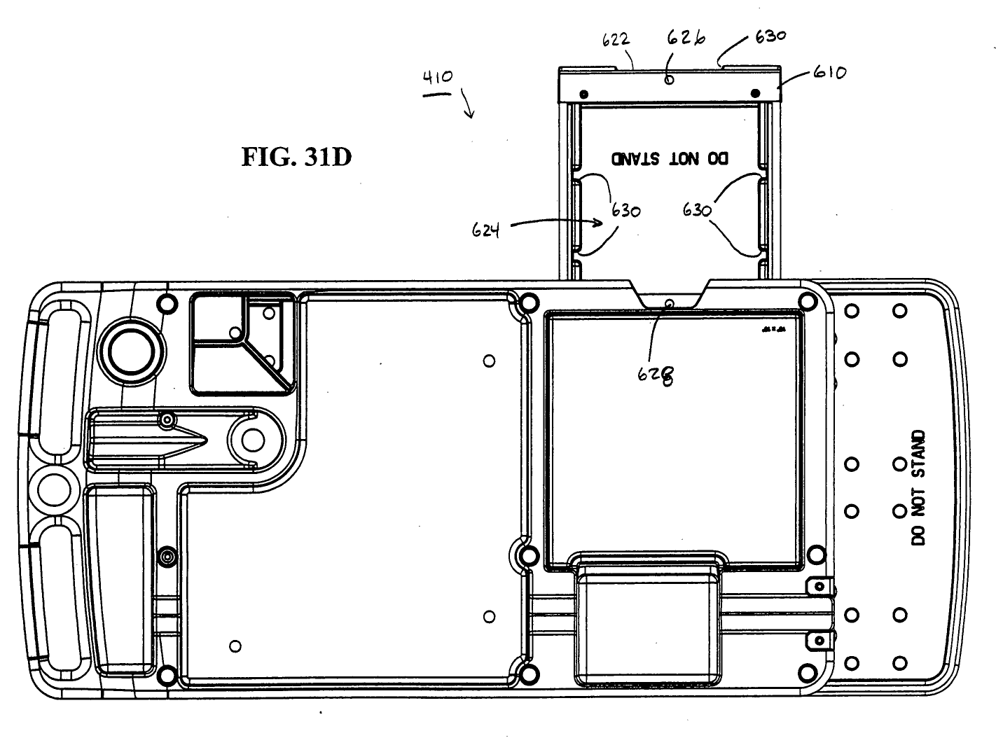

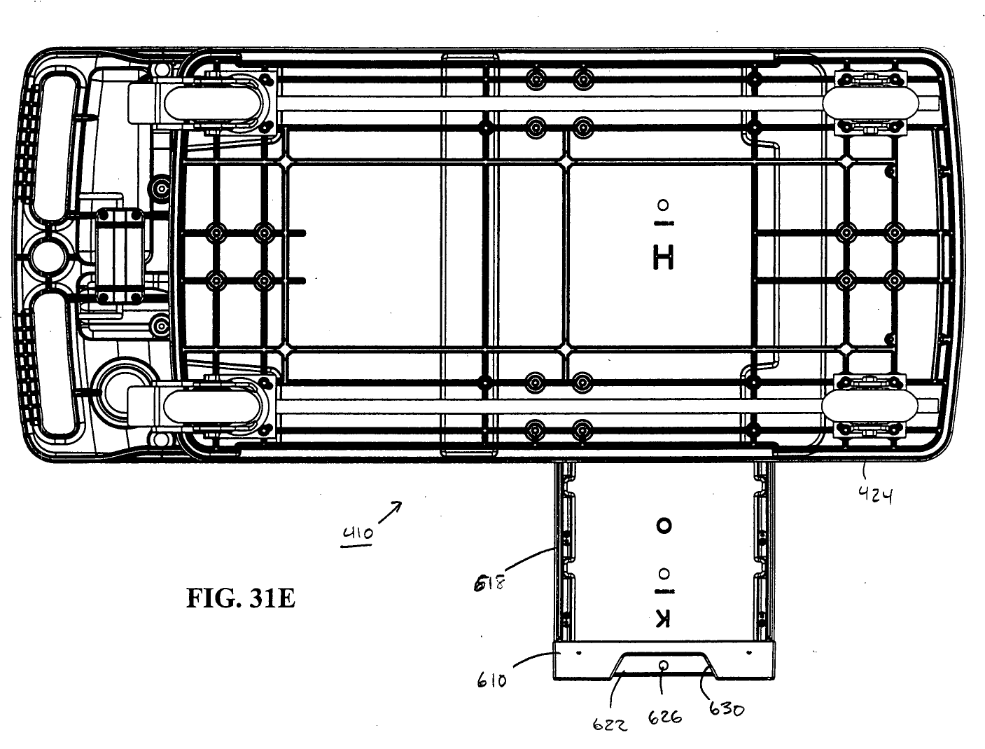

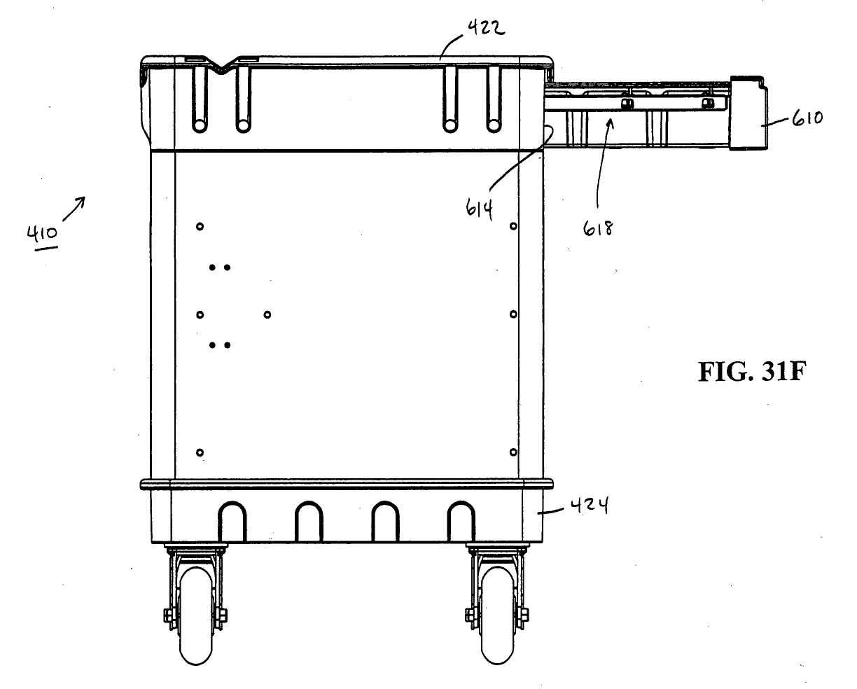

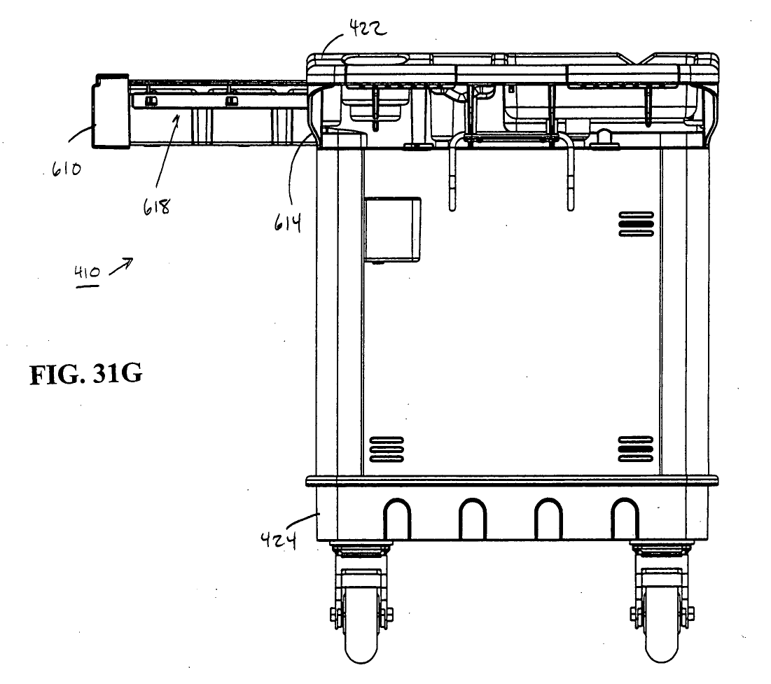

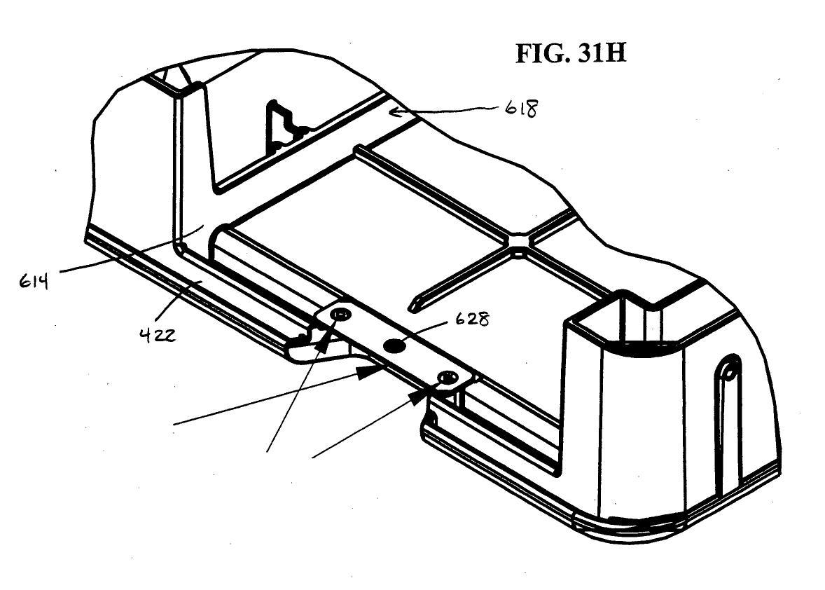

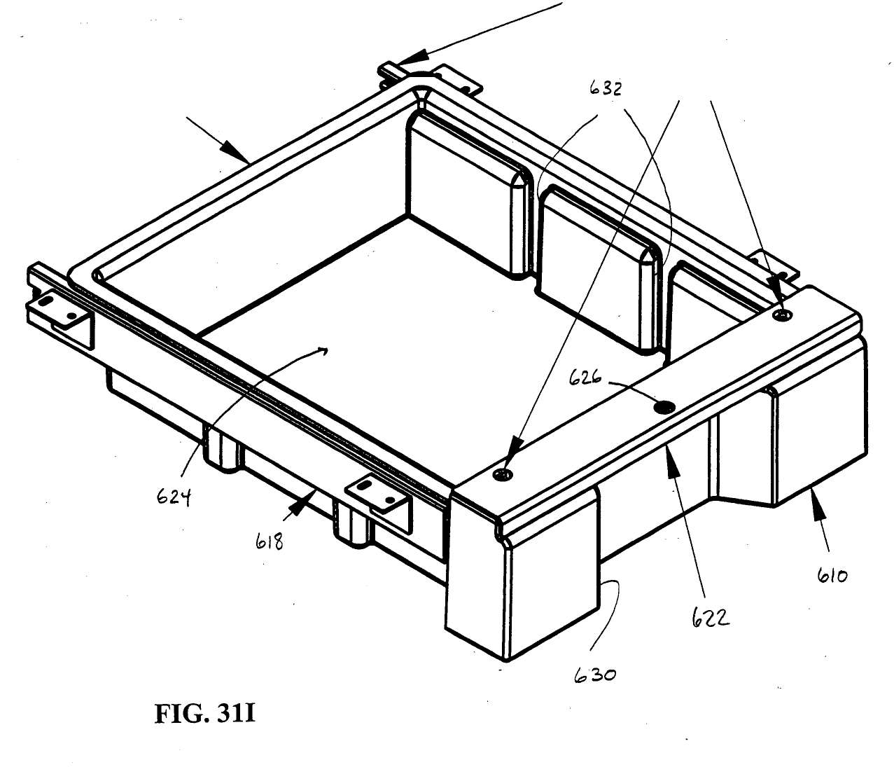

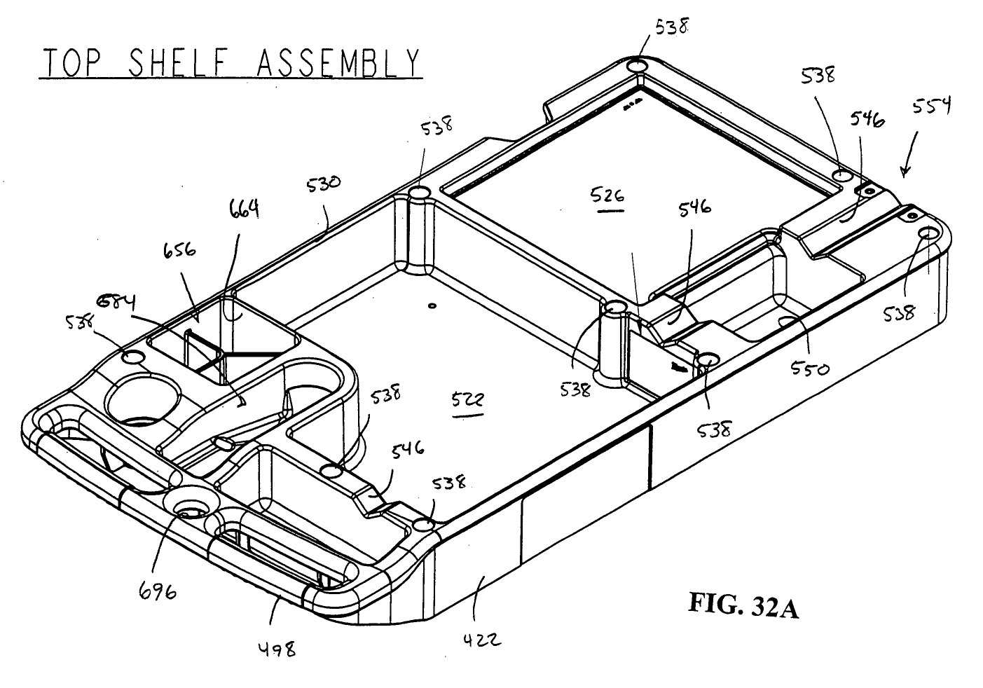

As shown in FIGS. 29 and 31, in some constructions and in some aspects, the industrial cart 410 may include a drawer 610. FIGS. 9A-9B, 9D-9E, 16-17, 21, 23-24, 25E and 35C show a similar drawer arrangement.

In the construction in FIGS. 29 and 31, the upper shelf 422 has a location 614 for an integral drawer 610. In the illustrated construction, the drawer 610 is positioned within the vertical and lateral periphery of the upper shelf 422 (e.g., does not beyond the outer surfaces of the upper shelf 422). When the drawer 410 is in the closed position, the drawer 610 does not extend beyond the width of the cart 410. In the illustrated construction, the location 614 for the drawer in the upper shelf 422 may be under the work area 526 and adjacent to the open storage area 522.

A sliding mechanism 618 is provided between the location 614 and the drawer 610 to allow the drawer to slide between a closed position (shown in FIG. 29) and an open position (shown FIG. 31). A handle 622 is engageable by an operator to move the drawer 610 between the open and closed positions.

A locking arrangement is provided to selectively lock the drawer 610 in the closed position and to secure the storage area 624 in the drawer 610. The drawer 610 has an opening 626 alignable (in the locked position) with a fixed opening 628 on the upper shelf 422 for receiving a separate lock (e.g., a padlock) to secure the drawer 610 in the locked position. A recessed area 630 in the drawer 610 ensures that any separate lock do not extend beyond the periphery of the cart 410.

Slots 632 in the interior of the drawer 610 may receive dividers (not shown) to divide the storage area 624. A releasable latch arrangement (not shown) may be provided to maintain drawer in a position (e.g., in the closed position), for example, during transport. A biasing member (not shown) may be provided to bias the drawer 610 toward a position (e.g., the closed position).

FIGS. 1, 3-4, 6, 8-9, 16-17, 19A, 20B, 21, 23, 24A-24D, 25D, 26-27 and 35-36 illustrate similar closeable and/or lockable storage for the cart 410. As shown in FIGS. 24A-24D and 25E, the cart 410L includes a lockable drawer and cabinet system, and the system generally allows both the drawer and the cabinet to be quickly locked and unlocked with one lock.

In some constructions, the cart 410 may include an electronic or remotely-operated security system. In such constructions, the locking arrangement may be electronically operated. For example, movement of the latch member 596 may be controlled by an electronic component or components in a manner similar to a vehicle door lock. In some constructions, the electronically-operated lock may replace the illustrated padlock for the lockable storage. Also, in such constructions, an electronically-operated lock may replace the foot-operated locks on the lockable wheels 418. A remote operation device (e.g., a key fob for an automobile/vehicle security system) may be provided to remotely operate the lock to selectively lock and unlock the storage, the lockable wheels, etc.

In some constructions, the cart 410 may be provided with an alarm system to provide an alert if the cart 410 is moved and/or if unwanted access is gained to the storage. The alert may be an audible, visual or other alert. In some constructions, the alert may be transmitted remotely (e.g., a signal provided to a distant monitor (a computer, a cell phone, etc.)).

The alarm system may be remotely-operated by the key fob. The alarm system may provide an alert if the storage is opened when the alarm is set. The alarm may also provide an alert if the cart 410 is moved or moves when the alarm is set. In such constructions, a motion detector may be provided on the cart 410. The motion detector may sense motion of the cart 410, motion of one or more wheels 418, etc.

In some aspects and in some constructions, the cart 410 is constructed to be durable and to carry tools, equipment, materials, etc. required on a typical job site while maintaining a reasonable unloaded weight (e.g., less than 150 lbs.) so that the cart 410 may be carried by, for example, two people. In such aspects and in such constructions, the cart 410 may include a frame assembly 636 including relatively lightweight material portions 640 (e.g., plastic, foam, etc.) providing large portions of many components (e.g., the base 424, the table 422, the cabinet 558, etc.) reinforced by stronger but heavy reinforcing members 644 (e.g., steel bars 648 supporting and/or reinforcing the base 424, the table 422, etc.).

In the construction illustrated in FIGS. 29, 32-34 (see FIGS. 29C, 29H, 32B-C, 33C, 33H and 34A), the base 424 is formed as a base assembly including a base body 640, providing the majority of the structural dimension of the base 424, and one or more reinforcing members 644, providing additional structural strength to the base 424. In the illustrated construction, the body 640 is formed of structural foam, and the reinforcing members 644 are formed of metal, such as 1020 steel. In the illustrated construction, the reinforcing members 644 extend along the length of the base 424. In other constructions (not shown), lateral reinforcing members may also be provided.

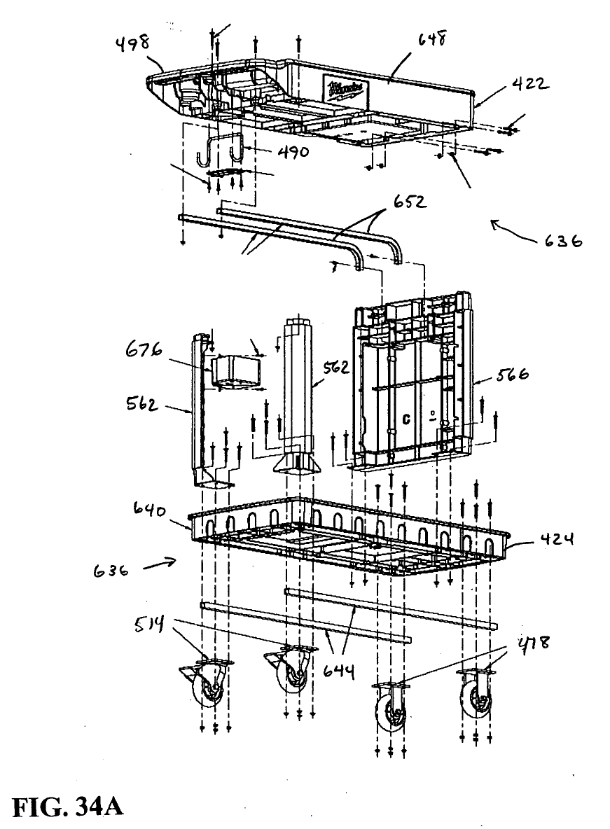

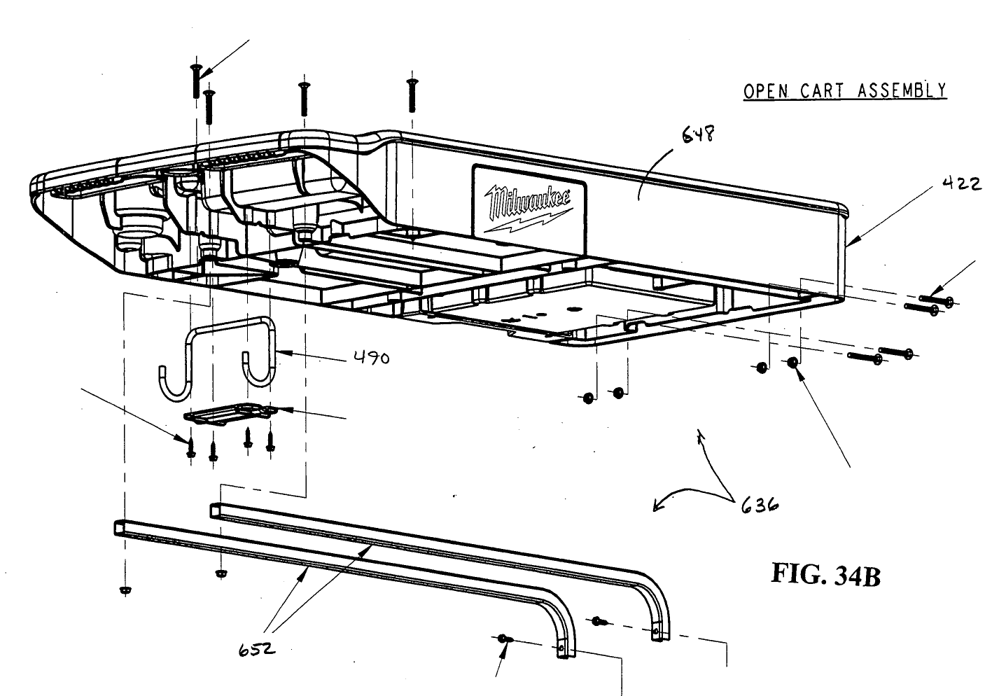

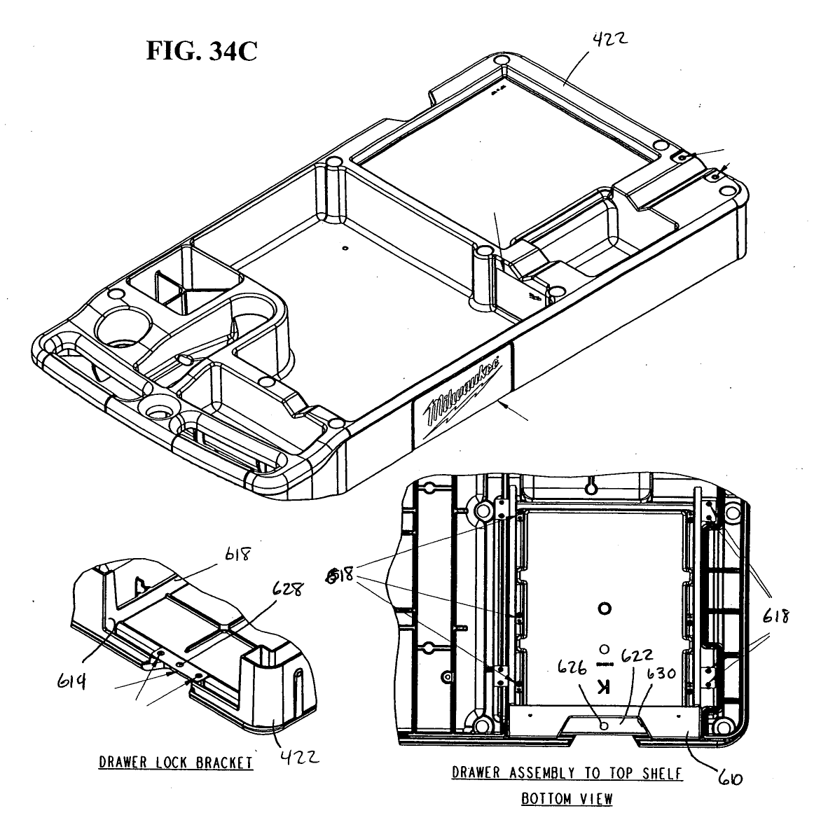

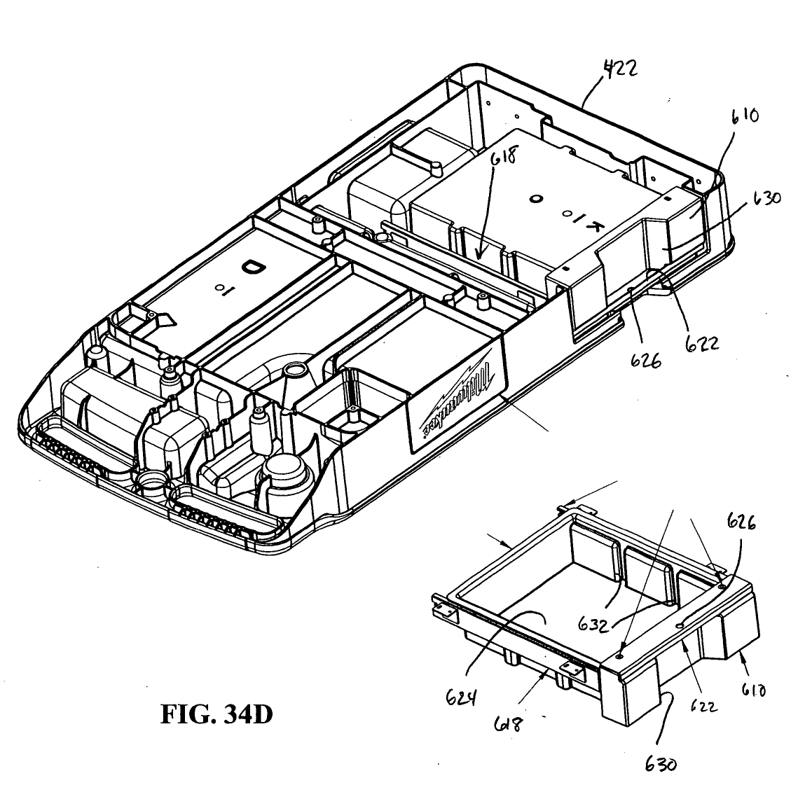

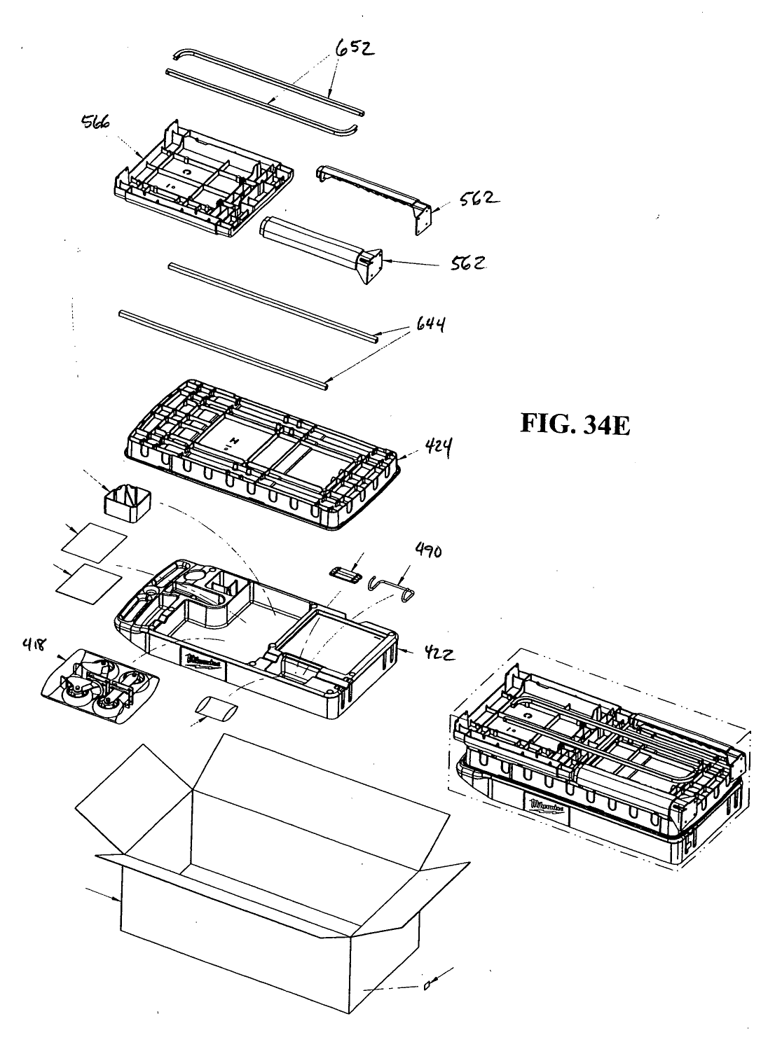

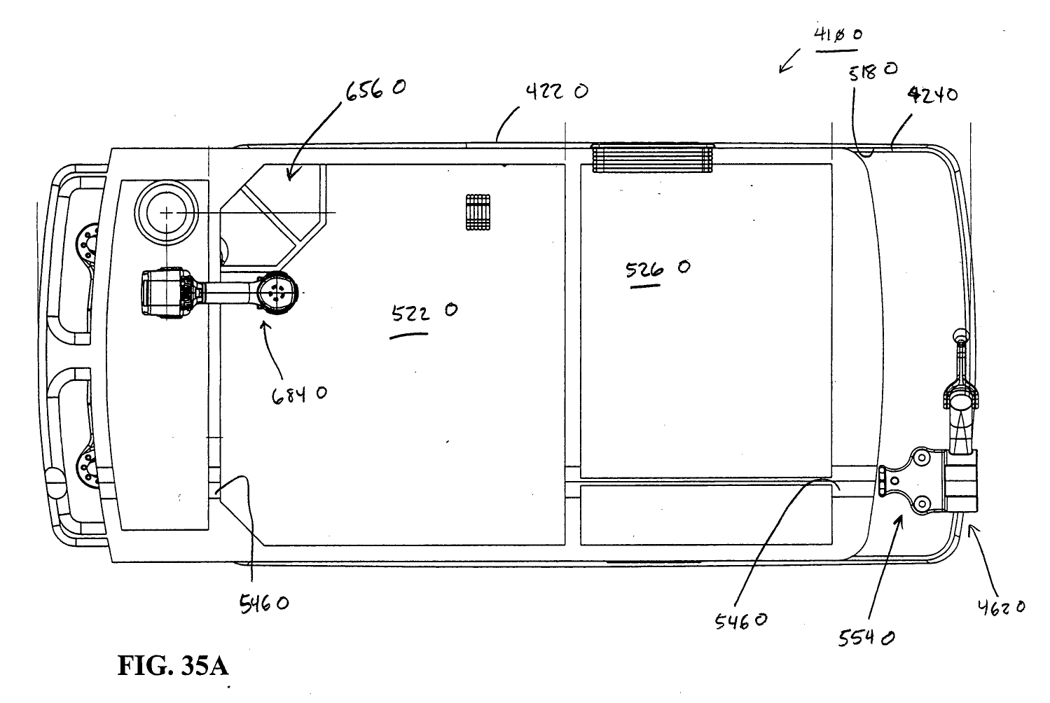

In the “open” cart configuration illustrated in FIGS. 33-34 (see FIGS. 33C and 34A-B), the table 422 is formed as a table assembly including a table body 648, providing the majority of the structural dimension of the table 422, and one or more reinforcing members 652, providing additional structural strength to the table 422. In the illustrated construction, the body 648 is formed of structural foam, and the reinforcing members 652 are formed of metal, such as 1020 steel. In the illustrated construction, the reinforcing members 652 extend along the length of the table 422. In other constructions (not shown), lateral reinforcing members may also be provided.

In the “cabinet” cart configuration, a similar reinforced table assembly may be provided. However, in the configuration illustrated in FIGS. 29 and 32, the components of the cabinet 558 provide additional structural support/reinforcement to the table 422 such that additional reinforcing members 652 are not typically necessary.

In the constructions illustrated in FIGS. 29 and 32-34, the reinforcing members 644 and 652, if provided, are formed separately from and are connectable to the body 640 and 648, respectively. As such, the reinforcing members 644 and 652 are replaceable, for example, if worn or damaged.

The reinforcing members 644 and 652 may also be substitutable to provide a different capacity cart 410. For example, stronger reinforcing members 644 and 652 (which may also be heavier) may be provided so that the cart 410 more durable or is capable of carrying greater loads (but which may be heavier). As described above, for metal working operations, the cart 110 may be required to be stronger and have a greater load capacity than the cart 10, 210, 310 for other operations, such as, for example, woodworking, electrical, general contractor, etc. The adaptable and/or modifiable frame assembly 636 forming the base 424 and/or the table 422 including the substitutable reinforcing members 644 and/or 652 allow easy manufacture of each type of cart 10, 110, 210, 310, 410, etc. and each different capacity cart with minimum modification and a minimum of additional non-common components.

In other constructions (not shown), the reinforcing members 644 and 652 may be formed integrally with (e.g., molded with) the body 640 and 648, respectively.

Lift or carry handles may be formed on the cart 410. For example, the handle 498 may provide a rear carry handle, and handles or surfaces (not shown) may be formed on the front of the base so that two people can lift and/or carry the cart 410 (e.g., around an obstacle, into and out of a transport vehicle, etc.).

The handle 498 and any front carry or lift handle(s)/surface(s) may include elastomeric material to, for example, improve the comfort of the user, provide improved gripping, reduce vibration transmitted to the user, etc. The handle 498 and/or the carrying handle(s)/surface(s) and/or the elastomeric material may also be contoured to fit a user's hand.

Elastomeric material may cover a portion of the periphery of the cart 410 (e.g., lateral surfaces and/or corner surfaces, etc.). The elastomeric material may inhibit damage to other objects during movement of the cart 410 (e.g., inhibit damage if the cart 410 impacts a wall, etc.), improve comfort to a user during movement of the cart 410 (e.g., cover points which may engage against a user during transport), etc.

Elastomeric material may cover a portion of a work surface (e.g., the upper surface of the table 422, the surface of the groove 546, etc.) to provide one or more of, among other things, protection (e.g., to prevent damage of the work surface, materials on the work surface), friction between the work surface and an items supported on the work surface (e.g., a power tool, material to be worked on, etc.), etc.

The elastomeric material may be a material such as, for example, rubber, Santoprene, etc. The elastomeric material may be formed as a separate member which is attachable to the cart 410 (e.g., to the handle 498, to any front carry or lift handle(s)/surface(s), lateral surfaces and/or corner surfaces, etc.). Alternatively, the elastomeric material may be provided as an overmold (e.g., on the handle 498 and any front carry or lift handle(s)/surface(s), lateral surfaces and/or corner surfaces, etc.).

Elastomeric material may be provided on portions of the cart 410 which may be engageable by an operator (e.g., gripping or handling surfaces, such as, for example, the handle 498, auxiliary carrying surface(s) or handle(s), the door member 584, the handle 606 of the latch member 596, the drawer 610, the handle 622 of the drawer 610, etc.) and on surfaces engageable with another object to provide one or more of, among other things, protection (e.g., to improve comfort, to prevent damage of the work surface, of an item on the work surface or other objects), friction between the work surface and an item on the work surface, etc.

As shown in FIGS. 29A-G and 29J, in some constructions and in some aspects, the industrial cart may include storage 656 for relatively long items (e.g., long-handled tools, bits, material, pipes, conduit, etc.) configured to maintain the items generally within the periphery of the cart 410 (e.g., oriented vertically). FIGS. 3-7, 9-10, 15-16, 18-19, 21-26 and 35-36 illustrate similar storage 656.

As illustrated, the vertical storage 656 may be within the width of the cart 410 and may extend through the upper shelf 422. The vertical storage 656 may include full-length storage 660 (extending from the base 424 through the upper shelf 422) provided by openings or holes 664 in the upper shelf 422 and a lip or ridge 668 formed on the lower shelf 424. The raised lip or ridge 668 matches or is aligned with the opening(s) of the vertical storage hole(s) 664 to keep long items (e.g., long-handled tools, bits, material, pipes, conduit, etc.) properly positioned/oriented vertically.

The vertical storage 656 may also include less than full-length storage 672 (e.g., half-length storage) and may include an intermediate or mid-height support 676 to keep mid-length items (e.g., auger bits, extensions, relatively shorter material, etc.) accessible from the top of the cart 410. In the illustrated construction, the position of the support 676 is adjustable to change the height of the support 676 (and the length of the storage 672). A connecting arrangement 680 is provided between the support 676 and the upright 562.

As shown in FIG. 29, in some constructions and in some aspects, the industrial cart 410 may include a support or holder 684 for a power tool. FIGS. 4-7, 9-15, 17-18, 22-25, 27, 35 and 36A illustrate a similar support or holder 684.

In the illustrated constructions, the holder 684 includes a holster 688 for a power tool, such as, for example, a drill D, a screwdriver, an impact wrench, etc. In some constructions, the orientation of the holster 688 (e.g., a 90° location) relative to the handle 498 allows for quick access by either right or left hand or a user. A hole 692 may be provided in the bottom of the holster 688 in the chuck area to allow the bit B to remain in the drill D when stored in the holster 688. In some constructions, the relatively-deep holster 688 keeps the drill D secure even when the cart 410 is moved over rough terrain. Other compartments 694 (e.g., storage compartments, beverage holders, etc.) may be formed adjacent the handle 498 for quick access by the operator of the cart 410.

As shown in FIG. 29 (and in FIGS. 9, 10D, 16, 21, 36A and 36C), in some constructions and in some aspects, the industrial cart 410 may include one or more storage hooks 490 molded with or assembled onto the top shelf 422. The industrial cart 410 may also or, in the alternative, include storage hooks 490 molded with or assembled onto other structural members of the cart (e.g., below the handle (as shown in FIGS. 4-8, 17, 23-24, 25C and 26-27) and/or within the outer periphery of the cart). The storage hooks 490 may be used to store extension cords, hoses, radios, battery chargers (e.g., a multi-bay charger), other equipment, etc., on the cart 410. As shown in FIGS. 6-7 and 27, a locking assembly may be provided to lock the stored items to the cart 410.

In some constructions and in some aspects (see FIGS. 29A, 29D and 29G), the main handle 498 has a hole 696 in the middle to allow for the storage of a tool (e.g., a hammer), for the hanging of “S” hooks (e.g., to hang buckets and cords from the cart handle), etc.

As shown in FIGS. 9, 25C-25D and 26, in some constructions and in some aspects, the industrial cart 410 may include a power strip 700 for providing power to electrical devices (e.g., power tools, a radio, a battery charger, etc.) which may be operated in the vicinity of the cart 410. In some constructions, power may be supplied to the power strip 700 by a power source supported on the cart 410, as described above.

In the illustrated construction, power is supplied to the power strip 700 by a power source (not shown) not supported on the cart 410. In the illustrated construction, the cart 410 may include a recessed GFCI power strip 700 with a 12″ to 18″ pigtail cord 704 for connection to the off-board power source. The power strip 700 may be provided in a recessed pocket 708 in the upper shelf 422 to maintain the cart width. The relatively short length of the pigtail cord 704 may prevent damage to the cord 704 from the cart wheels 418 and/or prevent the cord 704 from interfering with movement of the cart 410.

The cart 410 may include a cabinet 558 that has a pocket (not shownO to accept an industry standard 2-outlet or 4-outlet portable GFCI power strip. The pocket may allow for industry standard portable GFCI's to be stored on the cart 410 while still being easily removed for use away from the cart 410. The pocket may be located on a cabinet wall to allow for easy access to the outlets and may have a small cord wrap area to keep the cord off the floor.

A closeable and/or lockable storage cabinet 558 may be provided with a hole (not shown but, for example, about 1″ in diameter) near the power strip to provide access for a power cord into the cabinet 558. This arrangement would, for example, allow for the secure overnight charging of cordless power tool batteries from within the locked cabinet 558.

In some constructions and in some aspects (not shown), the cart may include a dust collection system. In some constructions, the cart may include an on-board dust collection system. The on-board system may include a fan or vacuum for generating an air flow from a work area and a storage container for collecting and storing dust/debris removed from the work area.

In other constructions, the cart may include a portion of a dust collection system. The portion of the system on the cart (e.g., hoses, vent passages, an air-flow producing device) may be connected to an off-board portion of the dust collection system (e.g., hoses, vent passages, an air-flow producing device, a dust/debris receptacle).

FIG. 17A illustrates a construction of a “base” cart 410F which may be modified by adding one or more modular accessory units 712. The front deck 518F may allow for the attachment of accessories 712 to modify the cart for use by an electrician, a plumber, a maintenance worker, etc.

FIG. 17B illustrates the attachment of a modular wire spool assembly 716 to the “base” cart 410F, for example, for a cart 410Fa modified for an electrician. FIG. 17C illustrates a fully-enclosed or “cabinet” cart 410Fb built from the “base” cart 410F with drawers 720 added. FIGS. 17D-E illustrate the attachment of a modular drawer system 724 (e.g., for small parts, tools, etc.) to the “base” cart 410F, for example, for a cart 410Fc modified for a maintenance worker. FIG. 17F illustrates an open cart 410Fd built from the “base” cart 410F without a cabinet. FIGS. 17G-H illustrate the attachment of a tank accessory system 728 (e.g., to hold one or more tanks T, such as an acetylene tank, an oxygen tank, a propane tank, a fire extinguisher, etc.) to the “base” cart 410F, for example, for a cart 410Fe modified for a plumber. FIG. 17I illustrates the attachment of a tank accessory system 732 (e.g., to hold one or more tanks T, such as an acetylene tank, an oxygen tank, a propane tank, a fire extinguisher, etc.) to the “base” cart 410F, for example, for a cart 410Ff modified for an electrician.

In some constructions (see FIGS. 9, 16, 17A, 17C, 17F-I, 19A, 23-24, 25E and 26), the extended front deck 518F may, for example, provide for storage of common trade supplies, accessories, etc. (e.g., ladders, levels, material, accessories, wire spools, voice and data cable boxes, etc.). FIGS. 17G-1 and 21 illustrate the cart 410F and 410I supporting gas cylinders, a fire extinguisher, torch and hoses, etc. The cart 410F may include additional supports/brackets (not shown) to support the cylinders, fire extinguisher, torch, hoses, etc. Such additional supports/brackets may be quickly attachable, removable, replaceable, etc., in a manner similar to the modular accessories 712.

As shown in FIGS. 17A-I, an extended work surface 740 (e.g., an extended steel work surface, a clamp/vise mount or mounting plate) may be provided on the front of the cart 410F. Such an extended work surface 740 may be quickly attachable, removable, replaceable, etc., in a manner similar to the modular accessories 712.

As described above, the cart 410 (and the carts 10, 110, 210, and 310, described above) provides a modular structure that may support various sub-assemblies, apparatus, equipment, supplies, etc. The sub-assemblies may be selectively added on or removed from the cart 410 to customize the cart 410 for a particular purpose. The modular frame and sub-assemblies permit a user to have a single cart 410 capable of being configured for a wide variety of tasks.

The cart 410 may be configured by the manufacturer, seller or user for a particular purpose. Alternatively, the manufacturer and/or seller may initially provide a base cart 410 generally configured for a particular purpose, and the seller and/or user may specifically configure the cart 410 for the particular purpose.

To connect of accessories to the cart 410, connecting structure 742 is provided on the cart 410. The connecting structure 742 may allow different modular accessories to be connected to the cart 410 using the same connecting structure 742. For example, the connecting structure 742 may include projections (e.g., bosses), and each modular accessory may include receptacles for receiving the projections as the modular accessory is supported on the cart 410. In other constructions, the connecting structure 742 may include receptacles, and each modular accessory may include projections (e.g., bosses) to be received in the receptacles as the modular accessory is supported on the cart 410. In the illustrated construction, the connecting structure 742 is provided by the front wall 566.

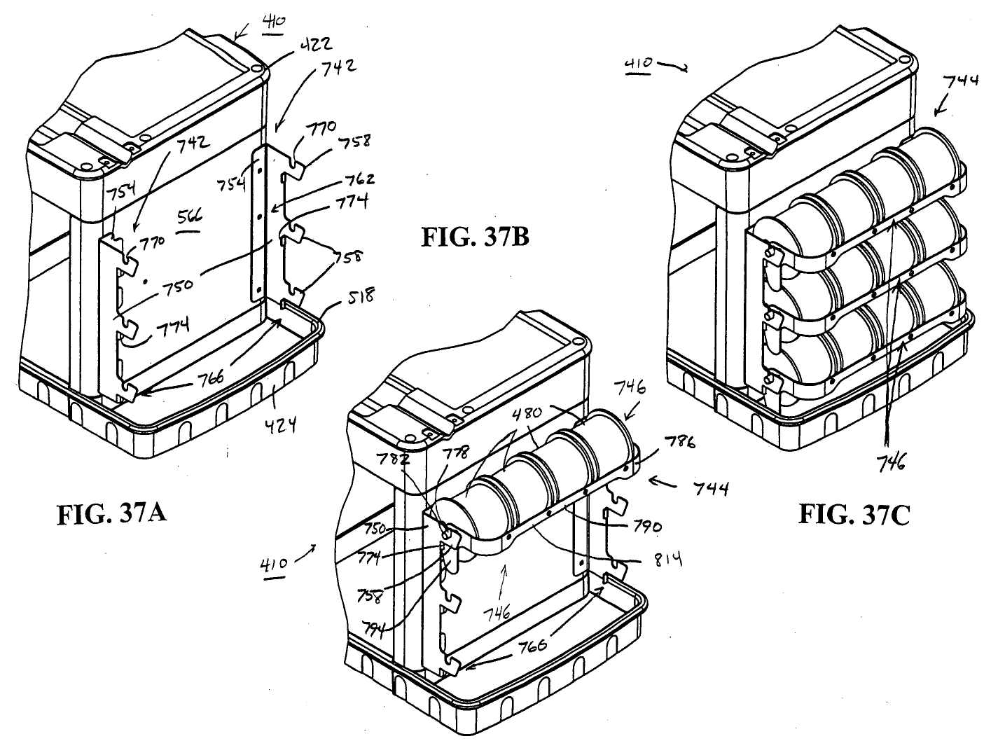

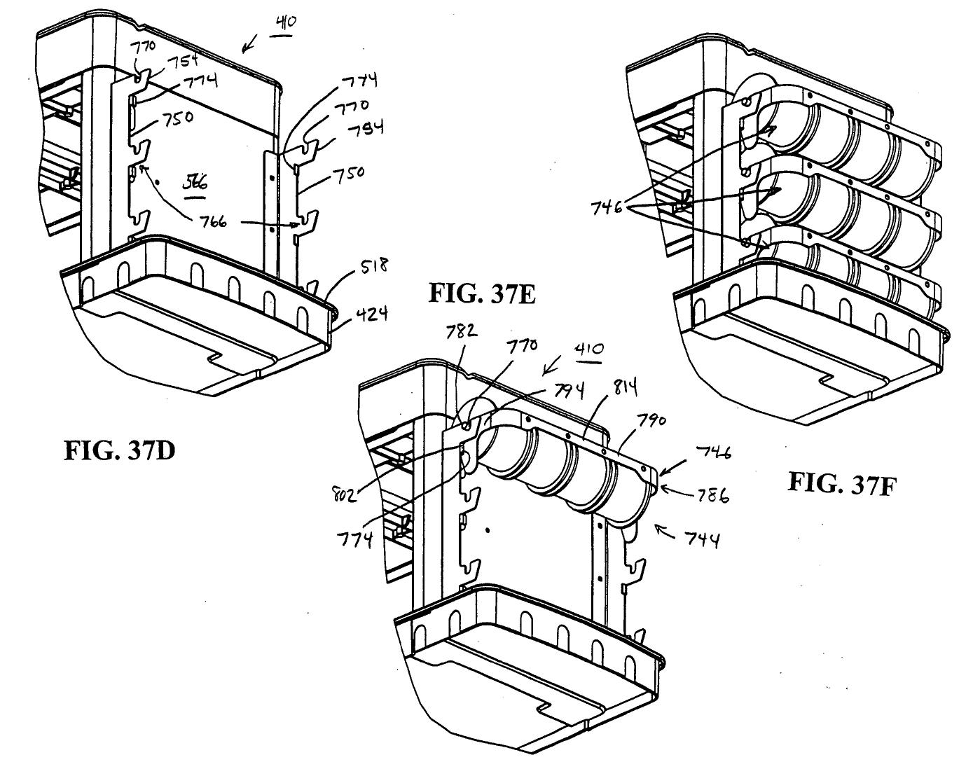

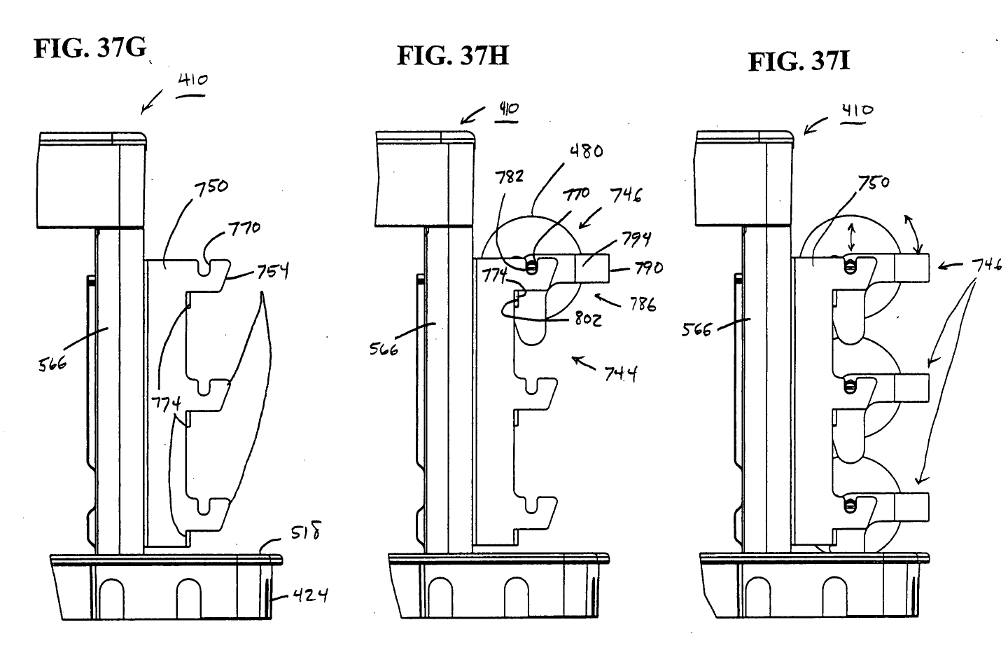

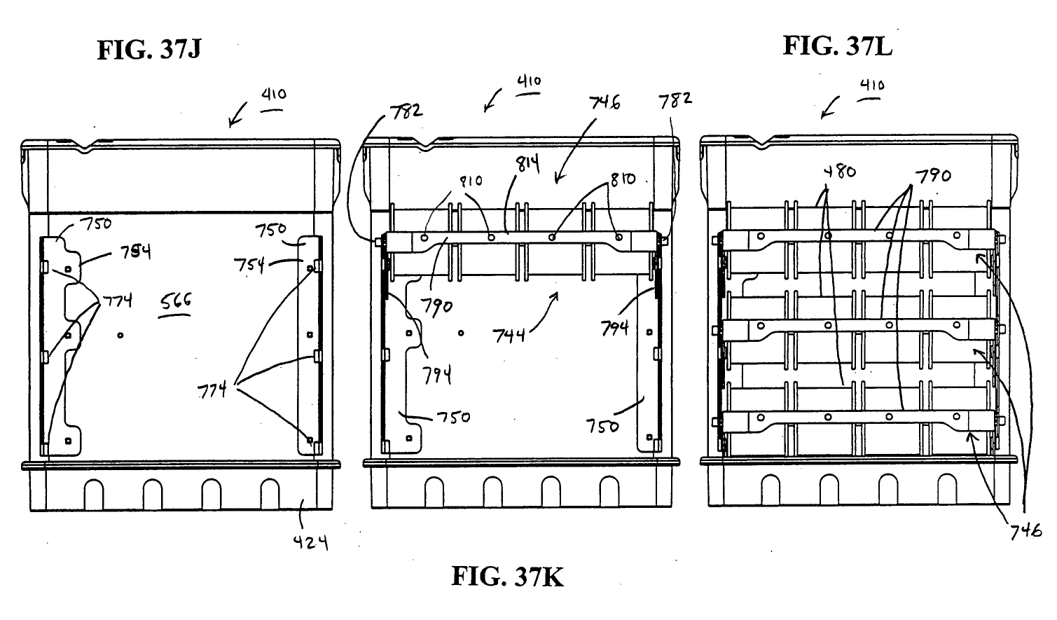

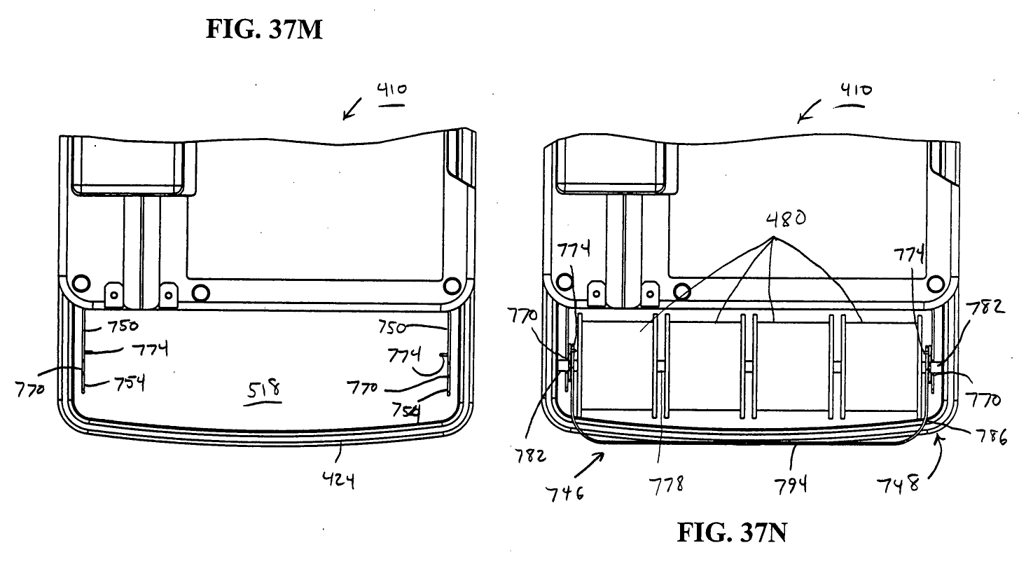

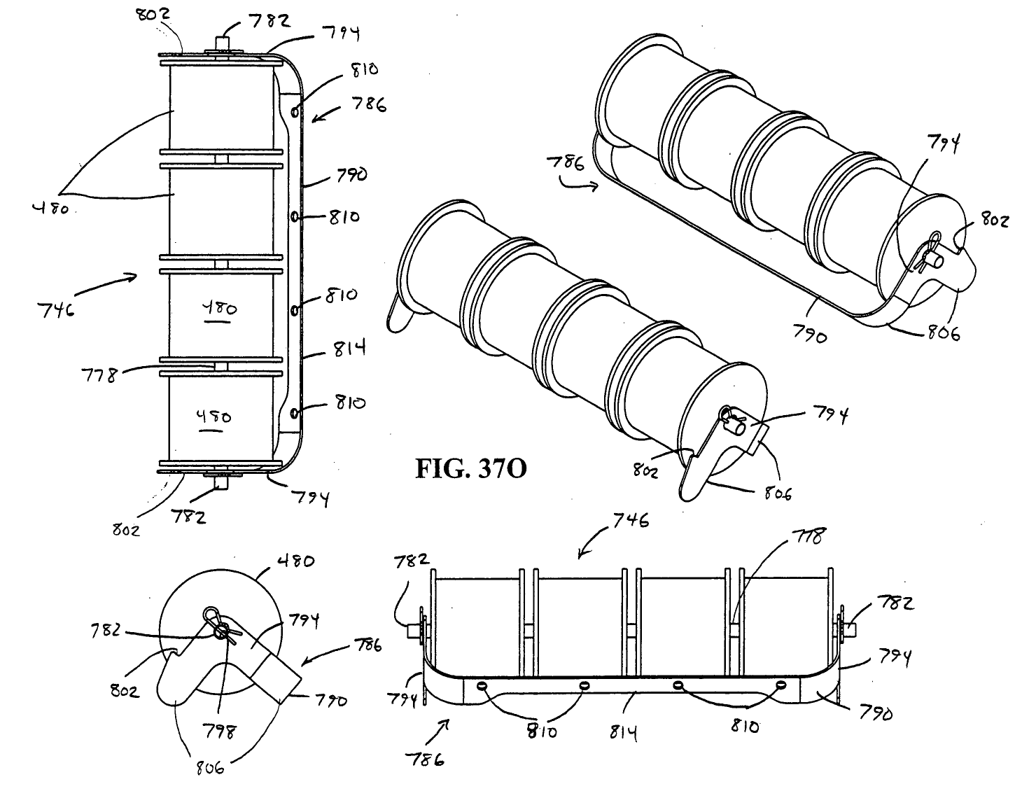

FIGS. 37A-0 illustrate the industrial cart 410 modified to include an assembly 744 or supporting a reel 480. In the illustrated construction, the assembly 744 is capable of supporting multiple reels 480 and multiple sets 746 of reels 480 (as units of reels 480).

As shown in FIG. 370, the assembly 744 includes brackets or supports 750 having a base 754 and one or more support arms 758 extending from the base 754. The base 754 includes connecting structure 762 (e.g., fasteners) connectable to the connecting structure 742 on the front wall 566. The supports 750 are positioned to provide pairs 766 of arms 758. A slot 770 is defined in each arm 758. A stop 774 is provided below each arm 758.

As shown in FIG. 370, the assembly 744 also includes a shaft 778 having opposite ends 782. One or more reels 480 are rotatably supported on the shaft 778. Each end 782 of the shaft 778 is receivable in a corresponding slot 770 in a corresponding arm 758 to support the shaft 778 (and any supported reel(s) 480) on the associated pair 766 of arms 758.

The assembly 744 also includes a frame 786 having a main or central frame member 790 and spaced apart end frame members 794. Each end member 794 defines a hole 798 for receiving an end 782 of the shaft 778 to connect the frame 786 to the shaft 778. Connectors (e.g., cotter pins) prevent the shaft 778 from sliding out of the holes 798 and disconnecting from the frame 786. A notch 802 is defined in each end member 794.

To support the reel(s) 480 on the cart 410, the shaft 778 is supported by a pair 766 of arms 758 with the ends 782 being received in the associated slots 770. The frame 786 is pivoted relative to the supports 750 so that each notch 802 engages below a corresponding stop 774 to prevent the shaft 778 from disengaging the arms 758. When supported on the cart 410, the frame member 790 is generally in a horizontal plane including the shaft 778. As such, one frame 786 does not interfere with the reel(s) on another frame 786.

To remove the reel(s) 480 from the cart 410, the operator pivots and lifts the frame member 790, disengaging the stops 774 and notches 802. The operator continues to lift the frame 786 to remove the shaft 778 from the pair 766 of arms 758. The operator may then carry the frame 786 and supported reel(s) 480 to another location (e.g., to dispense wire in that location, to replace an empty reel 480, to substitute or add a reel 480 having different wire, etc.).

In some constructions, one or more arms 754 may be adjustable, replaceable and/or substitutable. For example, the supports 750 may be formed with one or more arms 758 separate from and connectable to the base 754. The arm(s) 758 may be replaced if, for example, damaged or worn. The arm(s) 758 may be substituted with an arm (not shown) having a different structure (e.g., a different size slot 770, a different shape (angled or offset to provide a greater space between the arms 758 in a pair 766), etc.) or dimension (e.g., length from the front wall 566) to accommodate a reel (not shown) having a different dimension (e.g., diameter, length, etc.).

The position of the arm(s) 758 may be adjustable to position the reel(s) in a desired position (e.g., for reels of different dimensions). For example, the base 754 and the arm(s) 758 may be relatively adjustable to change the orientation, the position, etc., of the arm(s) relative to the cart 410 (e.g., relative to the table 422, to the front wall 566, to the front deck 518, etc.).

In such constructions, structure may be provided between the base 754 and the arm(s) 758 to hold the arm(s) 758 in a selected orientation, position, etc. Such structure may allow quick connection, disconnection, adjustment, etc.

As shown in FIG. 370, the end members 794 generally have a V-shape providing legs 806. The legs 806 enable the frame 786 to be supported on a surface (e.g., on the ground, on a work table, etc., as shown in FIG. 370) with the reel(s) 480 supported above the surface so that wire can be dispensed from the reel(s) in this orientation. The legs 806 are arranged so that the legs 806 do not interfere with dispensing or wire from the reel(s) 480 connected to the frame 786 or from the reel(s) connected to other frames 786 supported on the cart 410.

One or more holes or openings 810 are defined through the frame member 790. Wire from an associated reel 480 may be guided through an opening 810 when the reel 480 is supported on the cart 410 (as shown in FIGS. 37K-L) or when the frame 786 is supported on a surface (e.g., on the ground, on a work table, etc., as shown in FIG. 370).

The frame member 790 provides a grip portion 814 for engagement by an operator to carry the frame 786 and supported reel(s) 480. The grip portion 814 is narrowed to allow comfortable engagement by an operator's hand(s). The grip portion 814 may include suitable material (e.g., elastomeric material) to provide additional comfort to, control by the operator. Also, the grip portion 814 may include contours to fit the contours of the operator's hand(s).

The assembly 744 may be similar to the arrangement described above with respect to FIGS. 3, 3A and 4-7. The assembly 744 may be similar to the modular wire spool assembly 716, as described above with respect to FIG. 17B.

FIGS. 38A-L illustrate the industrial cart 410 modified to include a work piece holder or vise assembly 816. The assembly 816 is supported at the location 554 provided on the cart 410.

In the illustrated construction, the assembly 816 includes a support or bracket 820 having a connecting portion 824 and a support portion 828. The connecting portion 824 is connected to the connecting structure 742 on the cart 410 to support the bracket 820 on the cart 410.

A work piece holder, such as, for example, a clamp, a vise, a chain vise 462, is supported on the support portion 828. The bracket 820 is configured such that the material receiving portion of the vise 462 is aligned with the material cutting aids (e.g., the groove 546) on the table 422. Material to be worked on may thus be supported in the groove 546 and held by the vise 462.

The bracket 820 may accept existing bench-top work piece holders and may, in some constructions, be adjustable to position such holders in the appropriate position. For example, the connecting portion 824 and the support portion 828 may be relatively adjustable to change the orientation, the position, etc., of the support portion 828 relative to the cart 410 (e.g., relative to the table 422, to the groove 546, etc.). In such constructions, structure may be provided between the connecting portion 824 and the support portion 828 to hold the support portion 828 in a selected orientation, position, etc. Such structure may allow quick connection, disconnection, adjustment, etc.

As discussed above, a hanging storage location (not shown) for a power tool (e.g., a corded or cordless band saw, a grinder, a drill, a reciprocating saw, etc.) may be provided in proximity to the assembly 816. The storage location may be provided by a portion of the bracket 820 (e.g., below the support portion 828) or may be provided on the cart 410 in proximity to the bracket 820. The storage location may thus provide a location to quickly hang the power tool for out-of-the-way secure storage both between cutting operations and when transporting (rolling) the cart 410 and for quick retrieval of the power tool once the material to be cut is secured in position (e.g., in the vise 462).

The work piece holder or vise assembly 816 may be supported in a manner similar to the extended work surface 740, as described above with respect to FIGS. 17A-I.

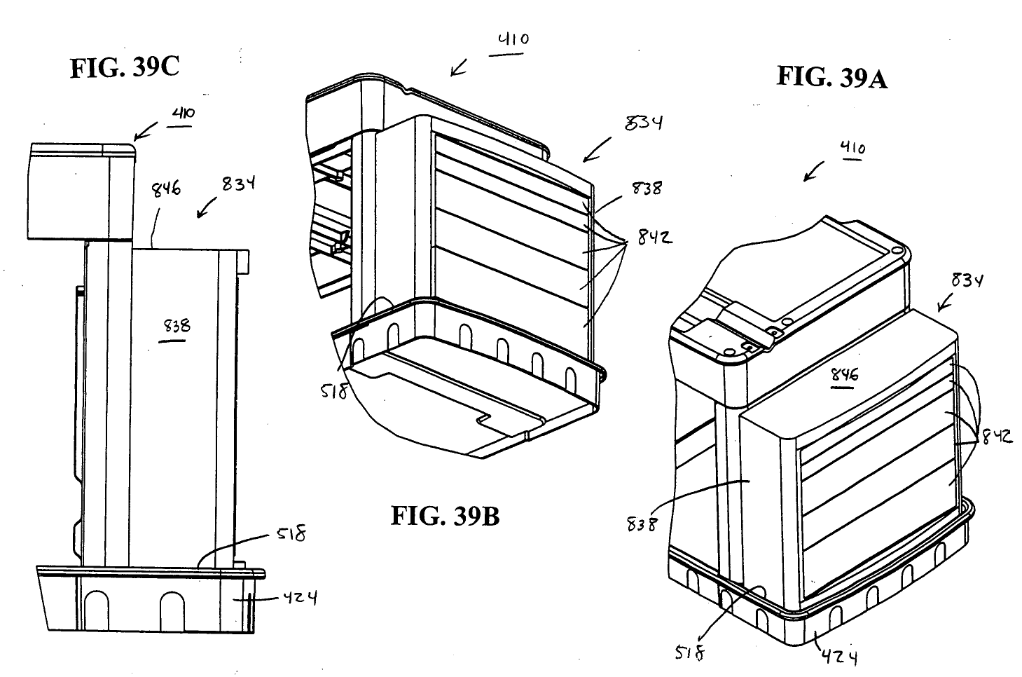

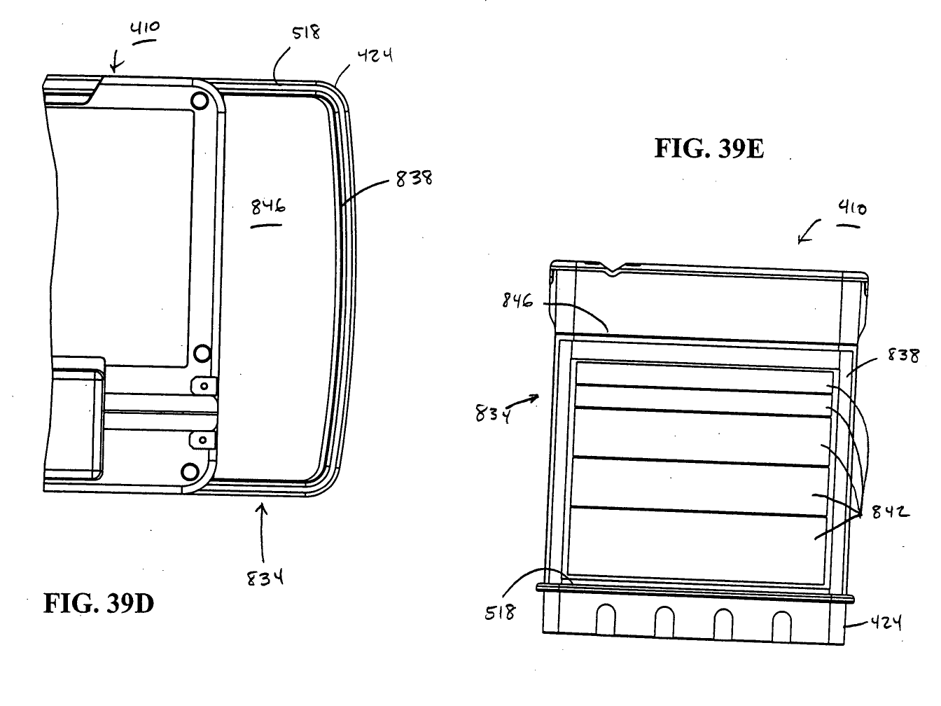

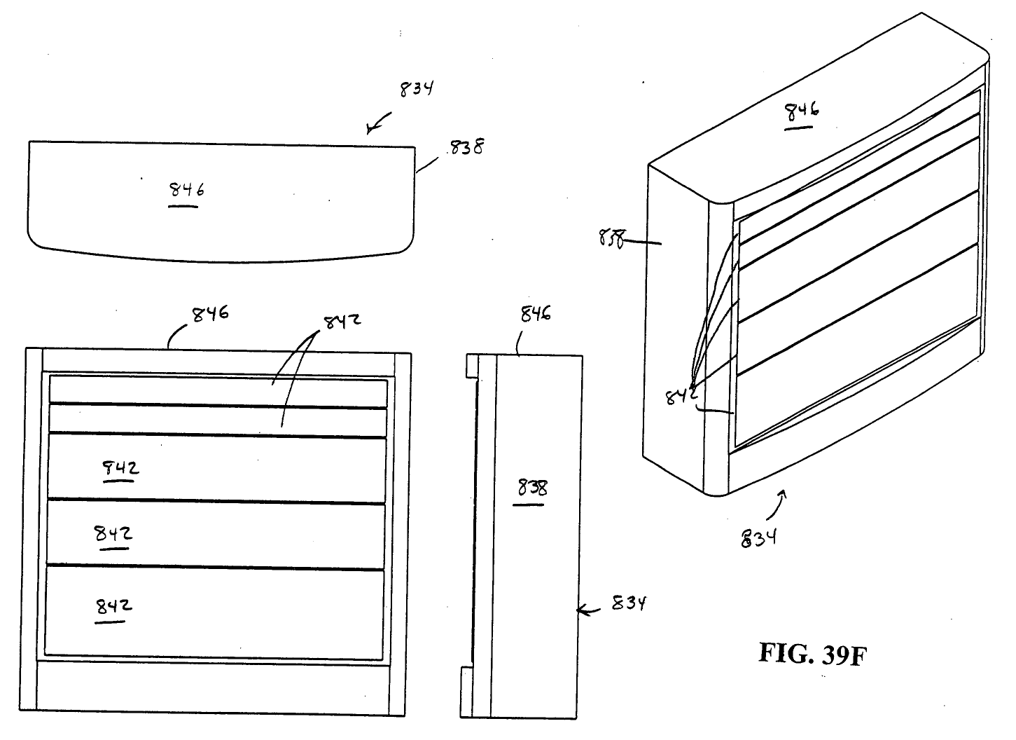

FIGS. 39A-F illustrate the industrial cart 410 modified to include a storage assembly 834. The assembly 834 provides additional storage for/organization of tools, equipment, materials, consumables, etc.

The storage assembly 834 includes a housing 838 defining one or more storage locations (e.g., supporting one or more trays, bins, shelves 842, etc.). In the illustrated construction, the housing 838 is received in the well or opening provided on the extended front deck 518. Such engagement may be sufficient to retain the assembly 834 on the cart 410. Additional connectors (not shown) may be provided to connect the housing 838 to the front wall 566 (through the connecting structure 742).

The housing 838 has a top surface 846 which may provide additional storage, an additional work surface, etc. The top surface 846 may be aligned with the top surface of the table 422. The top surface 846 may have an outer or peripheral raised lip or rim to retain small items (parts, bits, etc.) on the top surface 846.

The storage assembly 834 may be similar to the modular drawer system 724, as described above with respect to FIGS. 17D-E.

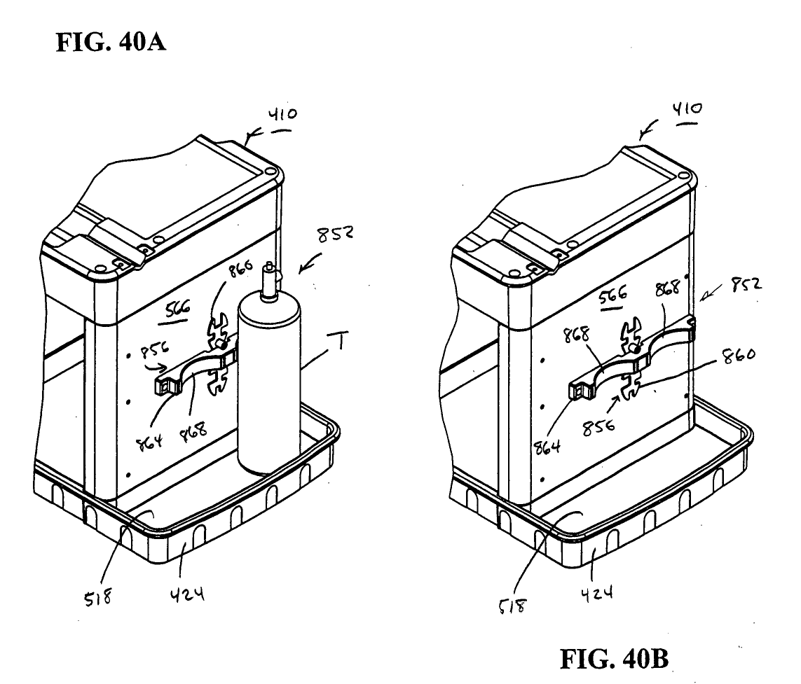

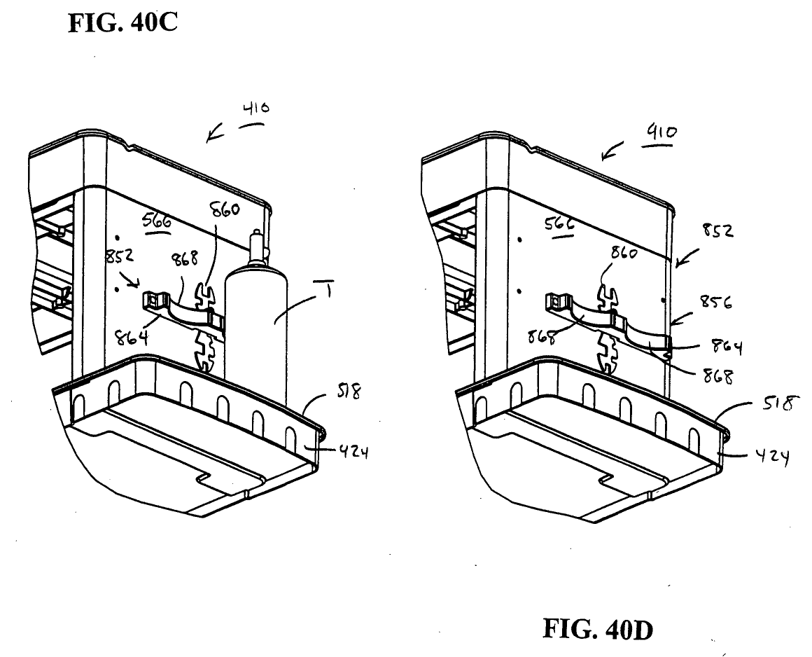

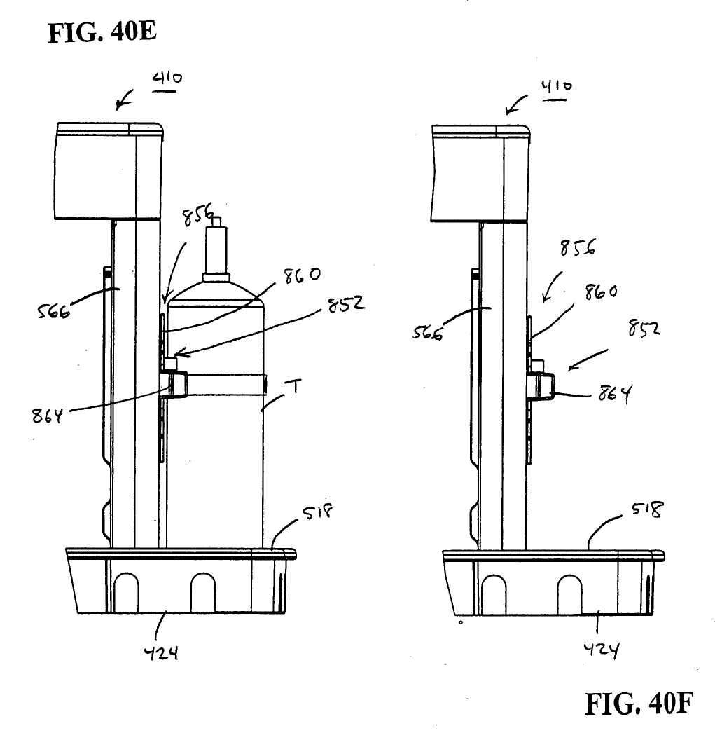

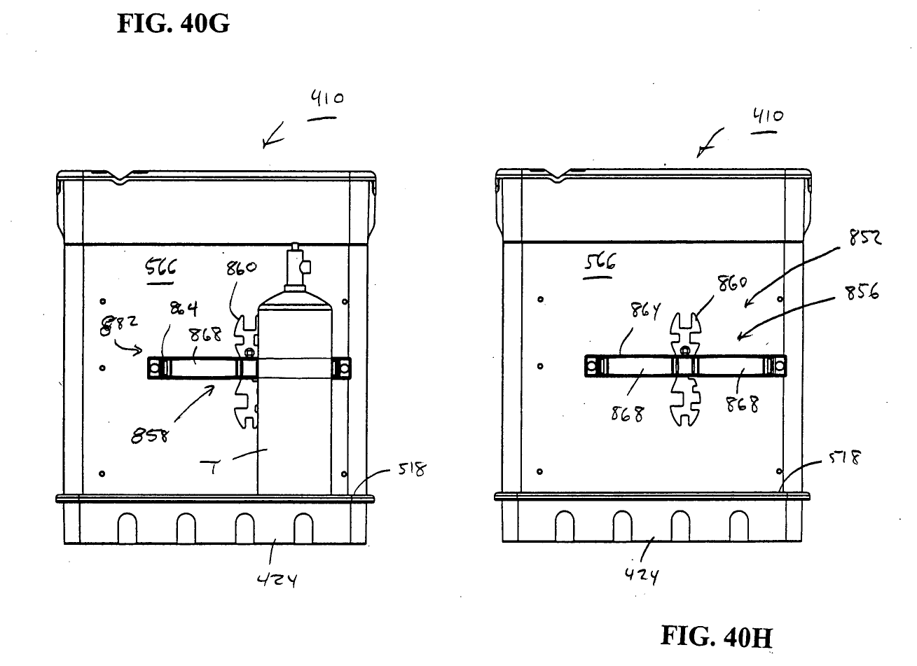

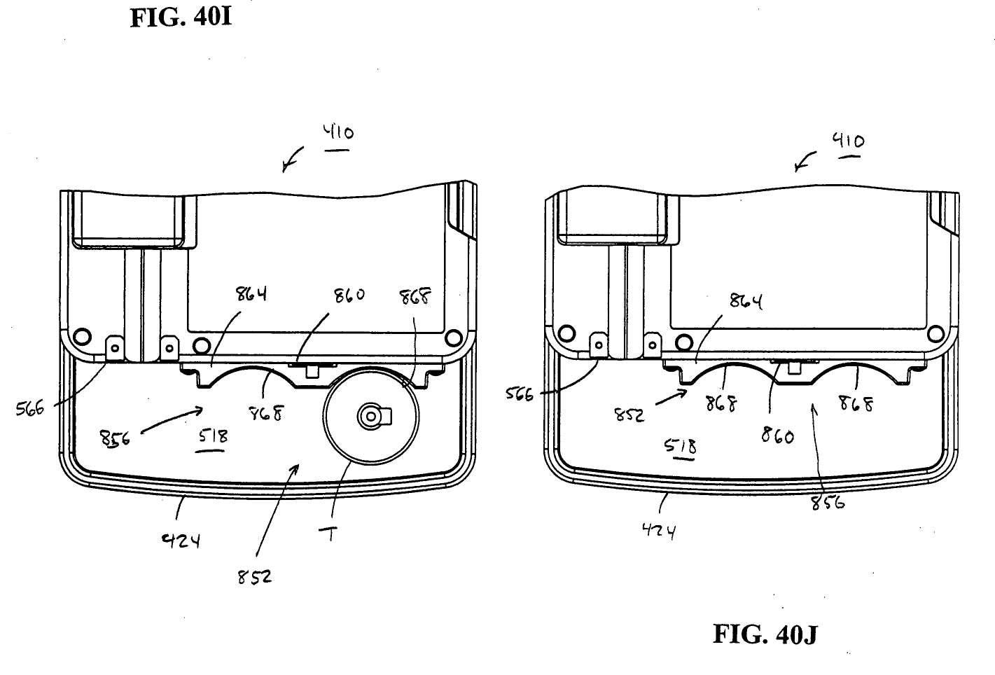

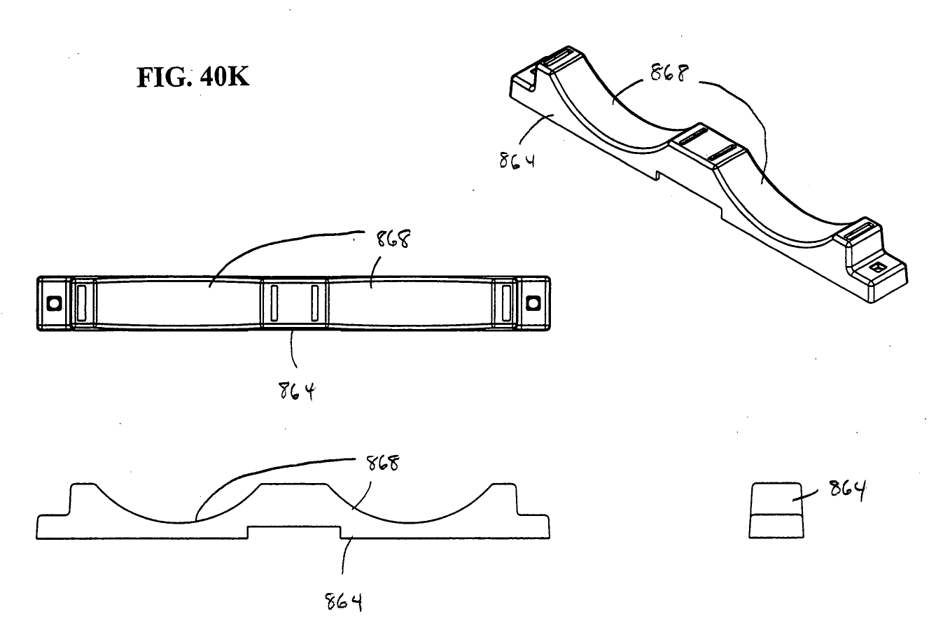

FIGS. 40A-K illustrate the industrial cart 410 modified to include an assembly 852 for supporting and/or storing tanks T. In the illustrated construction, the assembly 852 cooperates with the extended front deck 518 to support and/or retain the tank(s) T on the cart 410.

The assembly 852 includes a bracket member 856 having a connecting portion 860 and a body portion 864. The connecting portion 860 is connectable to the cart 410 through the connecting structure 742 on the front wall 566. The body portion 864 defines contours 868 complementary to the outer surface of the tank(s) T to be supported by the assembly 852. Retainers (not shown), such as, for example, straps, are connected to the body 864 and are engageable with (e.g., extending around) the tank(s) T to support and/or retain the tank(s) T.

In the illustrated construction, the body portion 864 defines locations or contours 868 for two tanks T. In other constructions (not shown), the body portion 864 may be provided by body sections (not shown) each defining a contour 868 for a tank T. The body sections may be connectable together and/or independently to the cart 410 to support the associated tanks T on the cart 410.

Each body section may have a different dimension and/or shape contour to accommodate a tank T having a different dimension and/or shape. Accordingly, a user can select the appropriate body section(s) for the selected tank(s) T to be supported on the cart 410. The body sections may be connectable at different heights relative to one another to accommodate different size (e.g. different height) tanks T.

The assembly 852 may be similar to the tank accessory system 728 or 732 include supports/brackets similar to the supports/brackets (not shown), as described above with respect to FIGS. 17G-H and 17I.

Other modular accessories or assemblies (e.g., tool racks, dust collection systems, work supports, table mounted power tools, etc.) may be supportable on the cart 410 in a manner similar to those described above. Connection may be provided through the modular connecting structure 742 and/or the well or opening provided in the extended front deck 518.

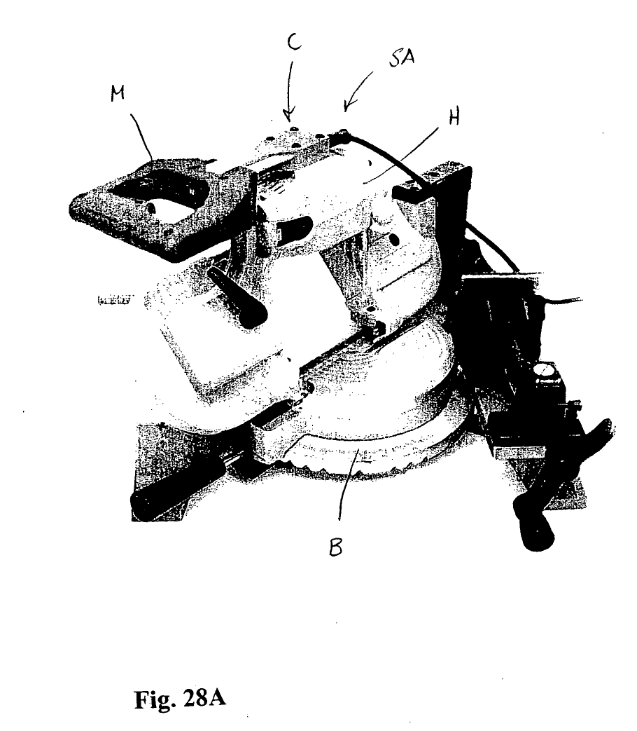

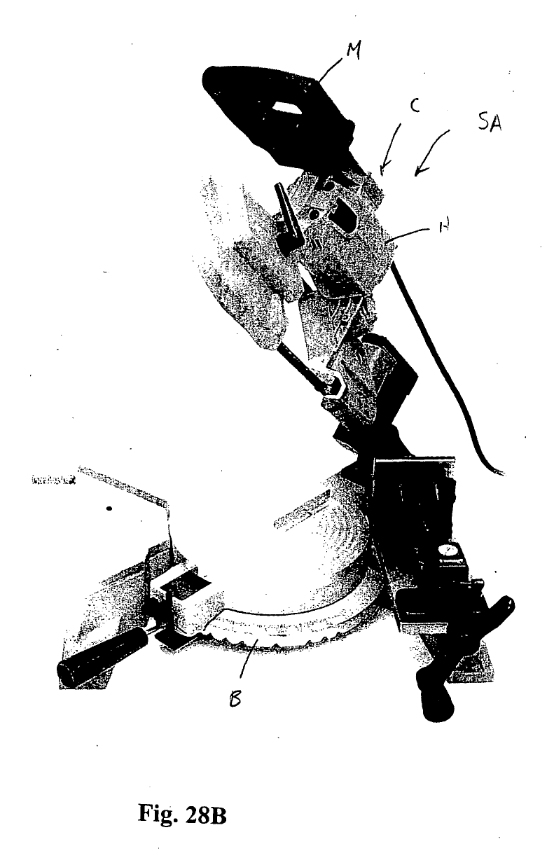

In some constructions (see FIG. 2), the cart (e.g., the cart 110) may be useable with a table-mounted band saw SA (shown in FIGS. 28A-28B). The table B supports the band saw SA for movement between a lowered cutting position (shown in FIG. 28A) and a raised non-cutting position (shown in FIG. 28B). As illustrated, the table B may allow the band saw SA to be operated for miter cutting.

In the illustrated construction, the band saw SA is removable from the table B and is operable as a hand-held band saw. The main handle M is connected to the housing H of the band saw SA for movement between the illustrated position for operation on the table B to a position (not shown) for operation as a hand-held band saw SA. The main handle M may be swivelable about the connection point C (in the vicinity of the four fasteners) from the illustrated table-operation position to a generally opposite hand-held operation position. In other constructions, the main handle M may be removed from the housing H and connected in either the illustrated table-operation position or the opposite hand-held operation position.

In the illustrated construction, the band saw SA is a corded band saw. In other constructions, the band saw SA may be a cordless band saw similar to that shown and described in U.S. Provisional Patent Application Ser. Nos. 60/546,489, filed Feb. 20, 2004; and 60/623,422, filed Oct. 28, 2004, and in U.S. patent application Ser. No. 11/061,057, filed Feb. 18, 2005, the entire contents of all of which are hereby incorporated by reference.

In some aspects and in some constructions, the cart 10, 110, 210, 310 or 410 may provide one or more of durability and survivability on a job site (for the cart and/or for tools, equipment, materials, etc., supported on the cart), mobility (to, from and around a job site including movement through standard door openings), storage (e.g., organization, material handling, including relatively large open areas for large items (e.g., tools, tool bags and kits, equipment, coolers, packaged materials, etc.), versatility and adaptability (of the cart), security (of the cart and/or of tools, equipment, materials, etc., supported on the cart), etc. In some aspects and in some constructions, the cart 10, 110, 210, 310 or 410 may provide improved working surfaces and working areas for working on and/or assembly of materials, for working with tools, equipment, materials, etc.

In some aspects and in some constructions, the cart 10, 110, 210, 310 or 410 is sized to fit easily through standard door openings (having a maximum width of about 26″ to fit through a standard door opening of about 32″).

In some aspects and in some constructions, the cart 10, 110, 210, 310 or 410 is constructed to be durable and to carry tools, equipment, materials, etc. required on a typical job site while maintaining a reasonable unloaded weight (e.g., less than 150 lbs.) so that the cart may be carried by two people. In such aspects and in such constructions, the cart 10, 110, 210, 310 or 410 may include a frame assembly including relatively lightweight plastic materials providing large portions of many components (e.g., the base, the table, the cabinet, etc.) reinforced by stronger but heavy reinforcing members (e.g., steel bars supporting and/or reinforcing the base, the table, etc.).

One or more independent features or independent advantages of the present invention may be set forth in the following claims:

1. An industrial cart comprising:
a base assembly having a base support surface for supporting an item;
a wheel connected to the base assembly and operable to support the cart for movement over ground; and
a table assembly having a table support surface for supporting an item, the table assembly being supported in vertical spaced relation from and being at least partially above the base assembly;
wherein at least one of the base assembly and the table assembly is provided by a frame assembly, the frame assembly including
a body member providing the support surface, the body member having a length extending along an axis, the body member being formed of a non-metallic material, and
a reinforcing member connectable to the body member, the reinforcing member extending along the axis, the reinforcing member being at least partially formed of a metal material.

2. The cart of claim 1, wherein the frame assembly further includes a second reinforcing member connectable to the body member, the second reinforcing member extending along the axis, the second reinforcing member being at least partially formed of a metal material.

3. The cart of claim 1, wherein the base assembly is provided by the frame assembly.

4. The cart of claim 3, wherein the table assembly is provided by a second frame assembly, the second frame assembly including
a table body member providing the table support surface, the second body member extending along the axis, the second body member being formed of a non-metallic material, and
a table reinforcing member connectable to the body member, the table reinforcing member extending along the axis, the table reinforcing member being at least partially formed of a metal material.

5. The cart of claim 4, wherein the table assembly includes a second table reinforcing member connectable to the body member, the second table reinforcing member extending along the axis, the second table reinforcing member being at least partially formed of a metal material.

6. The cart of claim 3, and further comprising:
a rear upright; and
a front upright, the rear upright and the front upright cooperating to support the table assembly in spaced relation from the base assembly.

7. The cart of claim 5, wherein the front upright is provided by a front wall, and wherein the cart further comprises a cabinet defining an enclosable storage area, the cabinet including
the front wall,
a rear wall positioned rearwardly of the front wall,
a first side wall connected between the front wall and the rear wall,
a second side wall connected between the front wall and the rear wall,
wherein the front wall, the rear wall, the first side wall, and the second side wall cooperate to provide the cabinet, and wherein the cabinet is connectable to at least one of the base assembly and the table assembly.

8. The cart of claim 7, wherein the table assembly is not provided by a second frame assembly, the table assembly including a table body, and wherein the rear upright, the front wall and the rear wall are connected between the table body and the base assembly and cooperate to support the table body in spaced relation from the base assembly.

9. The cart of claim 7, wherein at least one of the front wall, the rear wall, the first side wall, and the second side wall is provided by a door assembly, the door assembly being openable to allow access to the storage area and being closeable to enclose the storage area.

10. The cart of claim 1, wherein the body member is formed of structural foam, and wherein the reinforcing member is formed of steel.

11. The cart of claim 1, wherein the body member has a lower surface and defines a recess, and wherein the reinforcing member is positionable in the recess and does not extend below the lower surface.

12. A method of assembling an industrial cart, the cart including a base assembly having a base support surface for supporting an item, a table assembly having a table support surface for supporting an item, and a wheel connected to the base assembly to support the cart for movement over ground, the method comprising the acts of:
providing, with a frame assembly, at least one of the base assembly and the table assembly, the frame assembly including a body member providing the support surface, the body member extending along an axis and being formed of a non-metallic material, and a reinforcing member having a length and being at least partially formed of a metal material,
connecting the body member and the reinforcing member to form the frame assembly to thereby form the at least one of the base assembly and the table assembly, the reinforcing member being connected to the body member with the length extending along the axis; and
supporting the table assembly in vertical spaced relation from and at least partially above the base assembly.

13. The method of claim 12, wherein the providing act includes the act of providing a second reinforcing member having a length and being at least partially formed of a metal material, and wherein the connecting act includes the act of connecting the body member and the second reinforcing member to form the frame assembly to thereby form the at least one of the base assembly and the table assembly, the second reinforcing member being connected to the body member with the length extending along the axis.

14. The method of claim 12, wherein, in the providing act and the connecting act, the base assembly is formed.

15. The method of claim 14, further comprising the acts of:
providing with a second frame assembly, the table assembly, the second frame assembly including a table body member providing the table support surface, the table body member extending along the axis, the table body member being formed of a non-metallic material, and a table reinforcing member having a length and being at least partially formed of a metal material; and
connecting the table body member and the table reinforcing member to form the second frame assembly to thereby form the table assembly, the table reinforcing member being connected to the table body member with the length extending along the axis.

16. The method of claim 15, wherein the act of providing the second frame includes the act of providing a second table reinforcing member having a length and being at least partially formed of a metal material, and wherein the act of connecting the table body member includes the act of connecting the table body member and the second table reinforcing member to form the second frame assembly to thereby form the table assembly, the second table reinforcing member being connected to the table body member with the length extending along the axis.

17. The method of claim 14, wherein the cart further includes a rear upright and a front upright, and wherein the supporting act includes the act of connecting the rear upright and the front upright between the table assembly and the base assembly to support the table assembly in spaced relation from the base assembly.

18. The method of claim 17, wherein the front upright is provided by a front wall, and wherein the cart further includes a cabinet defining an enclosable storage area, the cabinet including the front wall, a rear wall positioned rearwardly of the front wall, a first side wall connected between the front wall and the rear wall, a second side wall connected between the front wall and the rear wall, and wherein the method further comprises the acts of:
connecting the front wall, the rear wall, the first side wall, and the second side wall to form the cabinet; and
connecting the cabinet to at least one of the base assembly and the table assembly.

19. The method of claim 18, wherein the supporting act includes the acts of
providing a table body, and
connecting the rear upright, the front wall and the rear wall between the table body and the base assembly to support the table body in spaced relation from the base assembly.

20. A method of assembling one of a first industrial cart and a second industrial cart, the method comprising the acts of:
providing a base assembly having a base support surface for supporting an item, the act of providing the base assembly including the act of providing a base frame assembly including a base body member providing the base support surface, the base body member extending along a base axis and being formed of a non-metallic material, and a base reinforcing member, the base reinforcing member being at least partially formed of a metal material;
connecting the base body member to the base reinforcing member to form the base assembly, the length of the base reinforcing member extending along the base axis;
connecting a wheel to the base assembly to support the cart for movement over ground;
providing a table body member having a table support surface for supporting an item, the table body member extending along a table axis and being formed of a non-metallic material;
providing a rear upright and a front wall; and
selecting to assemble one of the first industrial cart and the second industrial cart;
wherein, if the first industrial cart is selected, the method further comprises the acts of:
providing a table frame assembly including the table body member and a table reinforcing member, the table reinforcing member being at least partially formed of a metal material;
connecting the table body member to the table reinforcing member to form a table assembly, the length of the table reinforcing member extending along the table axis; and
connecting the rear upright and the front wall between the base assembly and the table assembly to support the table assembly in vertical spaced relation from and at least partially above the base assembly;
and wherein, if the second industrial cart is selected, the method further comprises the acts of:
providing a cabinet including the front wall, a rear wall positioned rearwardly of the front wall, a first side wall connected between the front wall and the rear wall, a second side wall connected between the front wall and the rear wall; and
connecting the rear upright, the front wall and the rear wall between the table body member and the base assembly to support the table body member in spaced relation from the base assembly.
